(19) United States
(12) Patent Application Publication
(10) Pub. No.: US 2025/0005125 A1
(43) Pub. Date: Jan. 2, 2025

(54) Method and system for configuring user-selectable controls corresponding to certified user functions

(71) Applicant: Snap-on Incorporated, Kenosha, WI (US)

(72) Inventors: Damien J. Coleman, Cork (IE); Joshua C. Covington, San Juan Bautista, CA (US); Jacob G. Foreman, Hollister, CA (US)

(21) Appl. No.: 18/345,771

(22) Filed: Jun. 30, 2023

(51) Int. Cl. G06F 21/33; G06F 3/0482; G06F 21/32; G06F 21/40

(52) U.S. Cl. CPC G06F 21/33; G06F 3/0482; G06F 21/32; G06F 21/40

(57) ABSTRACT

A method comprising determining a user interface (e.g., a GUI) selected to be used at a computer includes a user-selectable control (USC) corresponding to a certified user function (CUF). The computer includes program instructions executable to perform the CUF. The method includes determining whether a user identifier, received at the computer, corresponds to a certification credential for the CUF. The method also includes configuring the USC based on whether the user identifier corresponds to the certification credential. Configuring the USC includes enabling the USC if the user identifier corresponds to the certification credential, or deprecating the USC if the user identifier does not correspond to the certification credential. Enabling the USC configures the USC to be usable to trigger execution of the program instructions to perform the CUF. Deprecating the USC configures the USC to be unusable to trigger execution of the program instructions to perform the CUF.

### BACKGROUND

Vehicles (e.g., cars and trucks) include systems and components that require servicing from time to time. Many of those systems and components are serviced via use of a computing system and/or an electronic service tool. For various reasons, some governments or regulating organizations enact laws and regulations pertaining to servicing vehicles, such as laws and regulations regarding vehicle emissions and high voltage systems. In some instances, the laws or regulations require manufacturers or sellers of vehicle service tool to restrict access to scan tool functions executable to service the regulated vehicle systems.

### OVERVIEW

In a first implementation, a method is provided. The method includes determining, by a processor, a user interface selected to be used at a computing system includes a user-selectable control corresponding to a certified user function. The computing system includes program instructions executable to perform the certified user function. The method also includes determining, by the processor, whether a user identifier, received at the computing system, corresponds to a certification credential for the certified user function. Additionally, the method includes configuring the user-selectable control based on whether the user identifier corresponds to the certification credential for the certified user function. Configuring the user-selectable control includes enabling the user-selectable control if the user identifier corresponds to the certification credential, or deprecating the user-selectable control if the user identifier does not correspond to the certification credential. Enabling the user-selectable control configures the user-selectable control to be usable to trigger execution of the program instructions to perform the certified user function. Deprecating the user-selectable control configures the user-selectable control to be unusable to trigger execution of the program instructions to perform the certified user function.

In a second implementation, a computing system is provided. The computing system comprises a processor and a non-transitory computer-readable memory storing executable instructions. Execution of the executable instructions by the processor causes the computing system to perform tasks. The tasks include determining, by the processor, that a user interface, selected to be used at a computing system, includes a user-selectable control corresponding to a certified user function. The computing system includes program instructions executable to perform the certified user function. The tasks also include determining, by the processor, whether a user identifier, received at the computing system, corresponds to a certification credential for the certified user function. Additionally, the tasks include configuring the user-selectable control based on whether the user identifier corresponds to the certification credential for the certified user function. Configuring the user-selectable control includes enabling the user-selectable control if the user identifier corresponds to the certification credential, or deprecating the user-selectable control if the user identifier does not correspond to the certification credential. Enabling the user-selectable control configures the user-selectable control to be usable to trigger execution of the program instructions to perform the certified user function. Deprecating the user-selectable control configures the user-selectable control to be unusable to trigger execution of the program instructions to perform the certified user function.

In a third implementation, a non-transitory computer-readable memory is provided. The non-transitory computer-readable memory has stored therein instructions executable by a processor to cause a computing system to perform tasks. The tasks include determining, by a processor, that a user interface, selected to be used at a computing system, includes a user-selectable control corresponding to a certified user function. The computing system includes program instructions executable to perform the certified user function. The tasks also include determining, by the processor, whether a user identifier, received at the computing system, corresponds to a certification credential for the certified user function. Additionally, the tasks include configuring the user-selectable control based on whether the user identifier corresponds to the certification credential for the certified user function. Configuring the user-selectable control includes enabling the user-selectable control if the user identifier corresponds to the certification credential, or deprecating the user-selectable control if the user identifier does not correspond to the certification credential. Enabling the user-selectable control configures the user-selectable control to be usable to trigger execution of the program instructions to perform the certified user function. Deprecating the user-selectable control configures the user-selectable control to be unusable to trigger execution of the program instructions to perform the certified user function.

In a fourth implementation, a computing system having a processing means and a data storage means is provided. The computing system includes means for determining that a user interface, selected to be used at the computing system, includes a user-selectable control corresponding to a certified user function. The computing system includes program instructions executable to perform the certified user function. The computing system includes means for determining whether a user identifier, received at the computing system, corresponds to a certification credential for the certified user function. The computing system also include means for configuring the user-selectable control based on whether the user identifier corresponds to the certification credential for the certified user function. Configuring the user-selectable control includes enabling the user-selectable control if the user identifier corresponds to the certification credential, or deprecating the user-selectable control if the user identifier does not correspond to the certification credential. Enabling the user-selectable control configures the user-selectable control to be usable to trigger execution of the program instructions to perform the certified user function. Deprecating the user-selectable control configures the user-selectable control to be unusable to trigger execution of the program instructions to perform the certified user function.

Other implementations will become apparent to those of ordinary skill in the art by reading the following detailed description, with reference where appropriate to the accompanying drawings.

### BRIEF DESCRIPTION OF THE DRAWINGS

Example implementations are described herein with reference to the drawings.

FIG. 1 is a block diagram of a system, in accordance with the example embodiments.

FIG. 2 show arrangements for connecting a vehicle service tool to vehicle component(s), in accordance with the example embodiments.

FIG. 3 and FIG. 4 show vehicles, in accordance with the example embodiments.

FIG. 5 is a block diagram of a vehicle service tool, in accordance with the example embodiments.

FIG. 6 shows an arrangement of FIG. 6A and FIG. 6B, which extend across two pages.

FIG. 6A and FIG. 6B show modules, in accordance with the example embodiments.

FIG. 7 shows a vehicle service tool, in accordance with the example embodiments.

FIG. 8, FIG. 9, and FIG. 10 show mapping date, in accordance with the example embodiments.

FIG. 11 shows an arrangement of FIG. 11A and FIG. 11B, which extend across two pages. FIG. 11A and FIG. 11B show mapping date, in accordance with the example embodiments.

FIG. 12 is a block diagram of a server, in accordance with the example embodiments.

FIG. 13 is a block diagram of a companion computing system, in accordance with the example embodiments.

FIG. 14 shows screen displays, in accordance with the example embodiments.

FIG. 15 is a block diagram of a computing system, in accordance with the example embodiments.

FIG. 16 shows a computer program product, in accordance with the example embodiments.

FIG. 17, FIG. 18, FIG. 19, FIG. 20, FIG. 21, FIG. 22, FIG. 23, FIG. 24, FIG. 25, FIG. 26, FIG. 27, FIG. 28, FIG. 29, FIG. 30, FIG. 31, and FIG. 32 show graphical user interfaces (GUIs), in accordance with the example embodiments.

FIG. 33, FIG. 34, FIG. 35, FIG. 36, FIG. 37, FIG. 38, FIG. 39, FIG. 40, FIG. 41, FIG. 42, FIG. 43, FIG. 44, FIG. 45, FIG. 46, FIG. 47, FIG. 48, FIG. 49, FIG. 50, FIG. 51, FIG. 52, and FIG. 53 show functions sets, in accordance with the example embodiments.

All the figures are schematic and not necessarily to scale. Like reference numbers are used in the drawings to identify like elements unless the context or description describes otherwise.

### DETAILED DESCRIPTION

### I. Introduction

This description describes several example implementations, at least some of which pertain to improved methods and systems for servicing a vehicle and/or use of a vehicle service tool. In particular, some of the example implementations include configuring user-selectable controls at the vehicle service tool when the vehicle service tool is selected to be used to service particular vehicles, systems, and or components. As an example, configuring a user-selectable control can include enabling the user-selectable control or deprecating the user-selectable control. In at least some implementations, deprecating the user-selectable control includes showing the user-selectable control on a display, but locking the user-selectable control from being used. In at least some other implementations, deprecating the user-selectable control includes hiding the user-selectable control from being displayed on the display. A benefit of configuring the user-selectable control can include configuring the vehicle service tool so that untrained users cannot use the vehicle service tool on systems and/or components that could lead to some type of damage. Another benefit of configuring the user-selectable control can include configuring the vehicle service tool so that unknown users wishing to steal a vehicle cannot perform particular functions with respect to a vehicle security system that could allow the users to start the vehicle without a current key or key fob needed to start the vehicle.

Moreover, deprecating and/or enabling a user-selectable control of a vehicle service tool can be based on certification credential(s) (or more simply, credential(s)) of a user of the vehicle service tool. As an example, the credential(s) can correspond to a particular vehicle, a particular system, or a particular component in the vehicle. In some embodiments, the vehicle service tool includes data indicative of the user's credentials. In those or other embodiments, a server can include data indicative of the user's credentials and the server can execute or provide to the vehicle service tool instruction(s) to enable or disable a user-selectable control at the vehicle service tool.

The particular vehicle, system or component can be associated with multiple credentials. As an example, multiple credentials associated with the particular vehicle, system, or component can include multiple levels of credentials. This description identifies different levels of credentials numerically, such as levels 0, 1, 2, and 3 to indicate credential levels representing an increasingly amount of skill, knowledge, or access. A person having ordinary skill in the art will understand that the numerical levels listed in this description are examples and need not start with level 0 for a lowest level credential, need not have four levels, and/or need not be defined using sequential integers. For instance, some vehicles, systems, or components may correspond to a single credential and that credential may, for example, be referred to as being a level 1 credential, a level 2 credential, or just a credential. In other words, some vehicles, systems, or components may correspond to one or more advanced levels of certification credentials. Further examples of credentials and levels are discussed below.

### II. Example Systems, Vehicles, and Connectivity

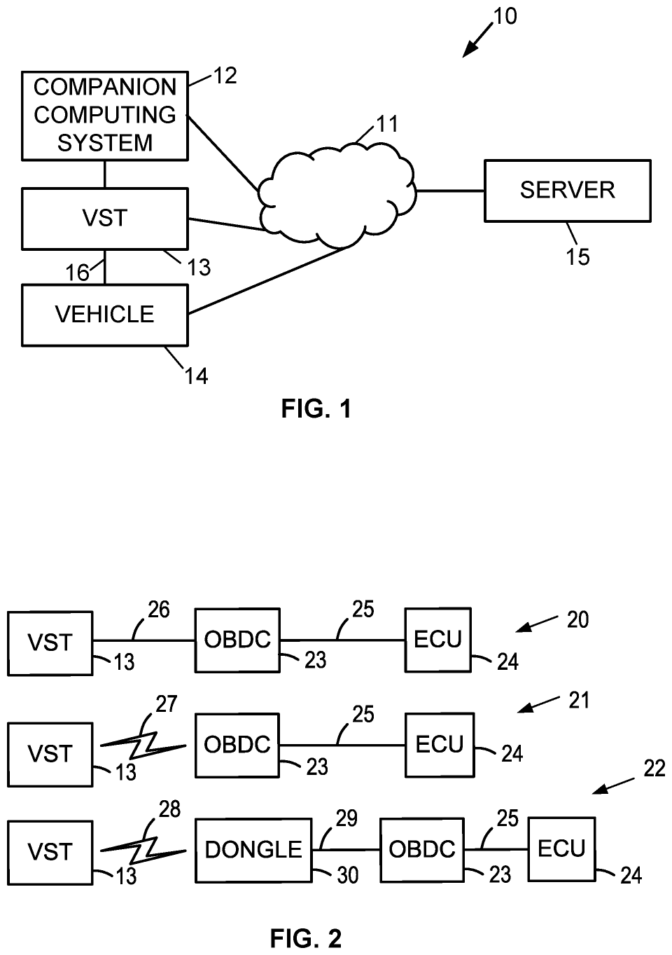

FIG. 1 shows a system 10 in accordance with the example embodiments. In general, the system 10 includes a communication network 11 configured for multiple computing systems to communicate with one another. In particular, the system 10 includes the communication network 11, a companion computing system 12, a vehicle service tool (VST) 13, a vehicle 14, a server 15, and a communication link 16 that operatively connect the VST 13 to the vehicle 14.

The communication network 11 can include one or more wireless networks and/or one or more wired networks. The wireless network(s) can carry communications using a wireless communication standard or protocol, examples of which are discussed below. The wired network(s) can carry communications using a wired communication standard or protocol, examples of which are discussed below. The communication network 11 can include one or more networks within the internet and/or a cloud computing network.

The companion computing system 12 (or more simply, a computing system) can include a computing system configured to operatively connect to the communication network 11, the VST 13, the vehicle 14, and/or the server 15. As an example, the companion computing system 12 can include a desktop computer, a laptop computer, a tablet computer, or a smart phone. The companion computing system 12 can include a browser application to display a webpage served by the server 15. As an example, the webpage can include a webpage for inputting data indicative of a credential corresponding to a user of the VST 13 or data (e.g., membership data) regarding the user of the VST 13. In at least some embodiments, the data regarding the user of the VST 13 can be used by the server 15 to obtain the credential corresponding to the user of the VST 13. In at least some other embodiments, the server 15 can output the data regarding the user of the VST 13 on a display so that an administrator can approve or deny the server 15 from outputting a credential to the VST 13 for the user of the VST 13 and/or outputting a GUI with user-selectable controls configured based on the user's credentials.

The VST 13 includes a computing system operable to service the vehicle 14. The VST 13 can transmit a vehicle data message (VDM) to the vehicle 14 and can receive a VDM from the vehicle 14. The VST 13 can transmit a message to the server 15 to request information for servicing the vehicle 14 and can receive a message from the server including the information for servicing the vehicle 14. The VST 13 can display the information for servicing the vehicle 14. As an example, the service information can include a diagnostic flowchart, a technical service bulletin, an original equipment manufacturer (OEM) position statement, a video, a schematic diagram, a component location diagram, a repair tip, a commonly-replaced parts graph, parameter-identifier (PID) definitions, a PID graph, a diagnostic trouble code (DTC) definition, a safety warning, a repair order, or some other type of service information.

The VST 13 can transmit a message to the server 15 to request data for configuring the VST 13 to service the vehicle 14. The VST 13 can receive a message from the server including the data for configuring the VST 13 to service the vehicle 14. As an example, the data for configuring the VST 13 can include credential information corresponding to a user of the VST. As another example, the data for configuring the VST 13 can include a file, such as an hypertext mark-up language (HTML) file arranged as a GUI.

The vehicle 14 can include any vehicle described in this description. The vehicle 14 can include a vehicle that includes an vehicle system, component or other aspect described in this description as being a part of a vehicle. In at least some embodiments, the vehicle 14 includes the communication link 16.

The server 15 can operate on a computing system. The server 15 can include the computing system on which it operates. The server 15 can include one or more servers. As an example, the server 15 can be configured to provide a web service to another computing system, such as the companion computing system 12, the VST 13, or a computing system within the vehicle 14. As an example, the web service can include a web service to provide the VST 13 with information for servicing the vehicle and/or credential information. As another example, the web service can include a web service for managing a user profile and/or memberships for a user of the VST 13. As yet another example, the web service can include a web service for providing the VST with a GUI having user-selectable controls configured based on credentials of record at the server for the VST user.

The communication link 16 can include a wireless communication link and/or a wired communication link. As an example, the wireless communication link can include a communication link configured to carry communications using a wireless communication standard or protocol, examples of which are discussed below. As another example, the wired communication link can include a communication link configured to carry communications using a wired communication standard or protocol, examples of which are discussed below. The wired communication link 16 can include and/or be arranged as the wired communication link 26, the wireless communication link 27, and/or the wireless communication link 28, each of which is shown in FIG. 2.

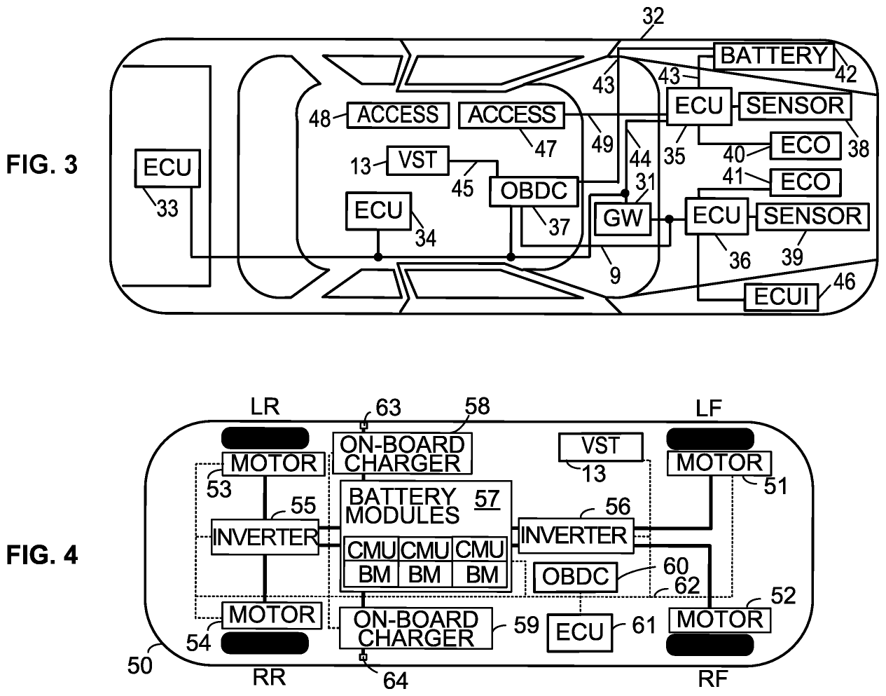

Next, FIG. 2 shows an arrangement 20, 21, 22 for operatively connecting the VST 13 to component(s) in a vehicle (e.g., the vehicle 14 shown in FIG. 1). In the arrangement 20, 21, 22, an on-board diagnostic connector (OBDC) 23 is operatively connected to an electronic control unit (ECU) 24 using a vehicle network 25. The ECU 24 can include one or more ECUs in the vehicle, such as the ECU 33, 34, 35, 36 shown in FIG. 3, the ECU 61 shown in FIG. 4, or any other ECU described in this description.

In the arrangement 20, the VST 13 is connected directly to the OBDC 23 using a wired communication link 26. As an example, the wired communication link 26 can be contained within a harness with multiple wires, at least one of which is configured to carry a VDM between the VST 13 and the OBDC 23. The harness can include a connector removably attachable to the OBDC 23. The wired communication link 26 can include one or more wires.

In the arrangement 21, the VST 13 is connected directly to the OBDC 23 using a wireless communication link 27. The wireless communication link 27 can include an air interface established to carry a VDM between the VST 13 and the OBDC 23. The wireless communication link 27 and the air interface can be configured in accordance with a wireless communication standard or protocol, such as any wireless communication standard or protocol described in this description.

In the arrangement 22, the VST 13 is connected indirectly to the OBDC 23 using a wireless communication link 28 and a dongle 30. The dongle 30 includes a connector 29 removably attachable to the OBDC 23 and a wireless transceiver and a wired transceiver. The wireless communication link 28 can include an air interface established to carry a VDM between the VST 13 and the dongle 30. The wireless communication link 28 and the air interface can be configured in accordance with a wireless communication standard or protocol, such as any wireless communication standard or protocol described in this description. The wired transceiver of the dongle 30 can receive a VDM transmitted to the OBDC 23 over the vehicle network 25 from an ECU and can transmit a VDM onto the vehicle network 25 for transmission to an ECU connected to the OBDC 23.

Next, FIG. 3 shows a vehicle 32 and placement of the VST 13 within the vehicle 32 in accordance with the example embodiments. In at least some embodiments, the vehicle 14 shown in FIG. 1 can be arranged like at least a portion of the vehicle 32. In at least some embodiments, the vehicle 32 can be included within the system 10 in place of or in addition to the vehicle 14.

The vehicle 32 includes a gateway 31, an ECU 33, 34, 35, 36, an OBDC 37, a sensor 38, 39, an ECU controlled output (ECO) 40, 41, a battery 42, and a battery-connected circuit 43. The ECU 33, 34, 35 is operatively connected to the OBDC 37 via the vehicle network 44 to allow transmission of a VDM between the OBDC 37 and the ECU connected to the vehicle network 44. Similarly, the ECU 36 is operatively connected to the OBDC 37 via a vehicle network 9 to allow transmission of a VDM between the OBDC 37 and the ECU 36. The gateway 31 is connected to the OBDC 37 and to the ECU 33, 35, 36. The gateway 31 can include one or more processors and/or transceivers for receiving and transmitting a VDM and converting a first VDM according to a first protocol to a second VDM according to a second protocol. The vehicle network 44 can include a wired and/or wireless network and/or can include or be arranged like the vehicle network 25 shown in FIG. 2. The vehicle 32 also includes an ECU input (ECUI) 46. An ECUI (e.g., the ECUI 46) can include a vehicle component (e.g., a sensor, a key cylinder) operatively connected to an input pin of an ECU.

The vehicle 32 includes an access component 47, an access component 48, and an access component circuit 49 operatively connected to the ECU 35. In at least some embodiments, the access component 47, the access component 48, and/or the ECU 35 can make up or be part of an immobilizer system configured for preventing theft of the vehicle 32. In other words, the access component 47 and the access component 48 can provide a communicative hand shake so that at least one of those access components detects the other access component. As an example, the access component 47 can include a key and the access component 48 can include a key cylinder configured to accept the key to allow a portion of the key cylinder to turn leading to the vehicle starting. In some embodiments, the key includes a resistor to complete or modify an electrical circuit so that the access component 48 can detect a key programmed to start the vehicle 32 is within the key cylinder. As yet another example, the access component 47 can include a key fob and the access component 48 can include a key reader circuit configured to detect presence of the key fob in proximity to the key reader circuit using wireless communications, such as near field communications. As still yet another example, the access component 48 can include an ECU, such as a steering wheel column ECU. That ECU can be configured to detect insertion of a key within a key cylinder or a key fob being in proximity to a key reader circuit and to send a communication or signal to one or more other ECUs in the vehicle 32 to enable functionality (e.g., start the vehicle, enable a diesel fuel pump) via the other ECU(s). In at least some embodiments, the ECU configured to detect insertion of the key can connect to the other ECU(s) via the gateway 31.

In at least some embodiments, the OBDC 37 is located within a passenger compartment of the vehicle 32, within an engine compartment of the vehicle 32, or within a storage compartment within the vehicle 32 in front of or behind the passenger compartment. The VST 13 can be removably attachable to the OBDC 37. The VST 13 can connect to the OBDC 37 via a communication link 45. In at least some embodiments, the VST 13 includes the communication link 45 (e.g., a harness). The VST 13 is typically removed after the vehicle 32 has been serviced. In that way, the VST 13 can be used to diagnose other vehicles. The OBDC 37 can be configured like and/or include the OBDC 23 shown in FIG. 2 and the communication link 45 can be configured like and/or include the wired communication link 26, the wireless communication link 27, and/or the wireless communication link 28 and the dongle 30 (all shown in FIG. 2).

The battery-connected circuit 43 can include one or more electrical circuits (e.g., one or more power circuits). FIG. 3 shows the battery-connected circuit 43 extending between the battery 42 and the ECU 35 and between the battery 42 and the OBDC 37. For clarity of FIG. 3, other examples of the battery-connected circuit 43 that extend between the battery 42 and some other vehicle component of the vehicle, such as the ECU 34, 35, 36, the sensor 38, 39, the ECO 40, 41 and the ECUI 46 are not shown in FIG. 3. The battery-connected circuit 43 between the battery 42 and the OBDC 37 can provide an electrical current to provide operational power for the VST 13.

The sensor 38, 39 is a device that provides a signal to the ECU 35, 36, respectively. The signal represents some characteristic of a vehicle the ECU 35, 36 is configured to monitor. As an example, the sensor 38, 39 can include one from among: an accelerometer, a camshaft position sensor, a crankshaft position sensor, a current sensor, a fluid level sensor, a fluid pressure sensor, a fluid temperature sensor, a hall effect sensor, an infrared sensor, a knock sensor, a mass air flow sensor, an oil pressure sensor, an oxygen sensor, a photo transistor, a piezoelectric sensor, a position sensor, a pressure sensor, a rain sensor, a refrigerant sensor, a temperature sensor, a thermistor, a throttle position sensor, a tire pressure sensor, a vehicle speed sensor, a voltage sensor, a wheel speed sensor, a yaw rate sensor, or some other typo of sensor. The signal provided by the sensor 38, 39 can be a target signal that corresponds to a selected functional test.

The ECO 40, 41 is a device controlled by the ECU 35, 36, respectively. The ECU 35, 36 can control the ECO 40, 41, respectively, using an output signal or an output condition. The output signal from an ECU can be a target signal that corresponds to a selected functional test. As an example, the ECO 40, 41 can include one from among: a fuel injector, a motor, a pump, a relay, solenoid, a transformer, or a valve. In accordance with at least some implementations, an ECU is selectable to perform a functional test and/or provide a DTC in accordance with an industry standard, such as the SAE J1979_201202 and/or ISO 15031-5 standards for E/E diagnostic test modes. As an example, the output condition can include establishing a particular voltage level on an electrical circuit operatively connected or connectable to the ECO 40, 41. For instance, the particular voltage level can be a nominal 5-volt reference signal, a nominal 12-volt reference signal, or an electrical ground level signal (e.g., a nominal 0-volt reference level).

The output signal of the ECU 35, 36 (i.e., the ECU output signal) can be any of a variety of electrical or output signals. As an example, the ECU output signal can include an analog or digital electrical signal. As a more particular example, the ECU output signal can include a pulse-width modulated signal, a triangular waveform signal, a saw tooth waveform signal, a rectangular waveform signal, a square waveform signal, or a sinusoidal waveform signal, among others. As another example, the ECU output signal can include a video signal or an audio signal. As yet another example, the digital electrical signal can include a data transmission. As an example, a data transmission can be communicated using a serial peripheral interface (SPI) interface, an inter-integrated circuit (I²C) interface, or a universal asynchronous receiver transmitter (UART) interface, among others. In response to receiving a functional test command, a processor in the ECU can execute program instructions or logic to cause the ECU output condition or output signal to appear at and/or on the ECO 40, 41.

Next, FIG. 4 shows a vehicle 50 and placement of the VST 13 within the vehicle 50 in accordance with the example embodiment. The vehicle 14 shown in FIG. 1 can be arranged like the vehicle 50. The vehicle 50 is an electrical vehicle. In at least some implementations, the vehicle 50 includes an internal combustion engine (ICE) such that the vehicle 50 is a hybrid vehicle.

As shown in FIG. 4, the vehicle 50 includes a motor 51 at a left front location of the vehicle 50, a motor 52 at a right front location of the vehicle 50, a motor 53 at a left rear location of the vehicle 50, and a motor 54 at a right rear location of the vehicle 50. The vehicle 50 also includes an inverter 55, 56, an on-board charger 58, 59, a charge port 63, 64, an ECU 61, an OBDC 60, and a vehicle network 62. As an example, the charge port 63 can include an AC voltage charge port and the charge port 64 can include a DC voltage charge port. The vehicle 50 can further include battery modules 57 including multiple battery modules (BM) and multiple cell monitoring units (CMU). The CMU can determine parameters regarding the battery modules, such as a battery voltage, a battery temperature, or a battery internal resistance. One or more of the motor 51, 52, 53, 54, the inverter 55, 56, the battery modules 57, the charge port 63, 64 and/or one or more other components (e.g., a conductor or connector connected to the motor 51, 52, 53, 54, the inverter 55, 56, the battery modules 57, the charge port 63, 64) can include a high-voltage component.

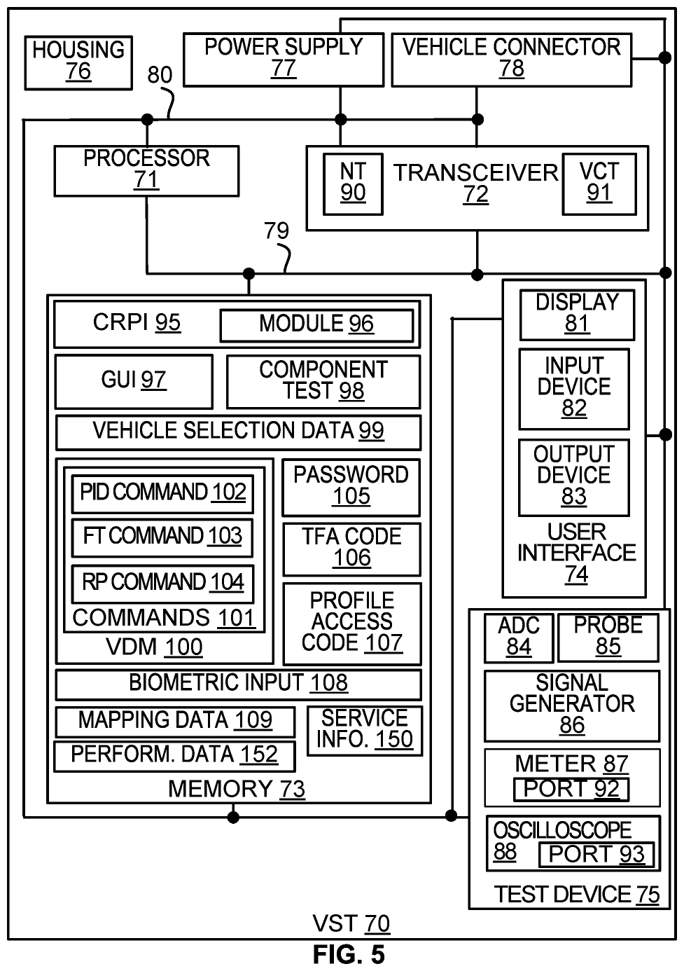

Next, FIG. 5 is a block diagram of a VST 70 in accordance with the example embodiments. The VST 13 shown in FIG. 1 to FIG. 4 can be arranged like the VST 70 and/or include one or more aspects of the VST 70. The VST 70 includes a computing system operable to service a vehicle (e.g., the vehicle 14, 32, 50). The VST 70 can perform any function(s) described in this description as being performed by the VST 13. The VST 13 can perform any function(s) described in this description as being performed by the VST 70.

The VST 70 can include a processor 71, a transceiver 72, a memory 73, a user interface 74, a test device 75, a housing 76, a power supply 77, a vehicle connector 78, a data bus 79, and/or an electrical circuit 80. The data bus 79 can operatively connect two or more of the processor 71, the transceiver 72, the memory 73, the user interface 74, the test device 75, the power supply 77, or the vehicle connector 78 to one another. In other words, the data bus 79 can provide an operative connection between two or more of the processor 71, the transceiver 72, the memory 73, the user interface 74, the test device 75, the power supply 77, and/or the vehicle connector 78. An operative connection allows for the operatively connected devices to communicate with one another.

### 1. Processor

A processor, such as the processor 71, 121, 171 or any other processor discussed in this description, can include one or more processors. Any processor discussed in this description can thus be referred to as “at least one processor” and/or “one or more processors.” Furthermore, any processor discussed in this description can include a general purpose processor (e.g., an INTEL® single core microprocessor or an INTEL® multicore microprocessor), and/or a special purpose processor (e.g., a digital signal processor, a graphics processor, an embedded processor, or an application specific integrated circuit (ASIC) processor). Furthermore still, any processor discussed in this description can include or be operatively connected to a memory controller that controls a flow of data going to and from a memory, such as the memory 73.

Any processor discussed in this description can be operable to execute computer-readable program instructions (CRPI). Any CRPI discussed in this description can, for example, include assembler instructions, machine instructions, machine dependent instructions, microcode, firmware instructions, state-setting data, and/or either source code or object code written in one or any combination of two or more programming languages. As an example, a programming language can include an object oriented programming language such as Java, Python, or C++, or a procedural programming language, such as the “C” programming language. Any processor discussed in this description can be operable to execute hard-coded functionality in addition to or as an alternative to software-coded functionality (e.g., via CRPI). In at least some implementations of the VST 70, the processor 71 is a specific processor that is programmed to perform any function(s) described in this description as being performed by the VST 13, 70 and/or with respect to a module.

An embedded processor refers to a processor with a dedicated function or functions within a larger electronic, mechanical, pneumatic, and/or hydraulic device, and is contrasted with a general purpose computer. The embedded processor can include a central processing unit chip used in a system that is not a general-purpose workstation, laptop, or desktop computer. In some implementations, the embedded processor can execute an operating system, such as a real-time operating system (RTOS). As an example, the RTOS can include the SMX® RTOS developed by Micro Digital, Inc., such that the embedded processor can include (a) an advanced RISC (reduced instruction set computer) machine (ARM) processor (e.g., an AT91SAM4E ARM processor provided by the Atmel Corporation, San Jose, California), or (b) a COLDFIRE® processor (e.g., a 52259 processor) provided by NXP Semiconductors N.V., Eindhoven, Netherlands. A general purpose processor, a special purpose processor, and/or an embedded processor can perform analog signal processing and/or digital signal processing.

### 2. Memory

A memory, such as the memory 73, 123, 173 or any other memory discussed in this description, can include one or more memories. Any memory discussed in this description can thus be referred to as “at least one memory” and/or “one or more memories.” A memory can include a non-transitory memory, a transitory memory, or both a non-transitory memory and a transitory memory. A non-transitory memory, or a portion thereof, can be located within or as part of a processor (e.g., within a single integrated circuit chip). A non-transitory memory, or a portion thereof, can be separate and distinct from a processor.

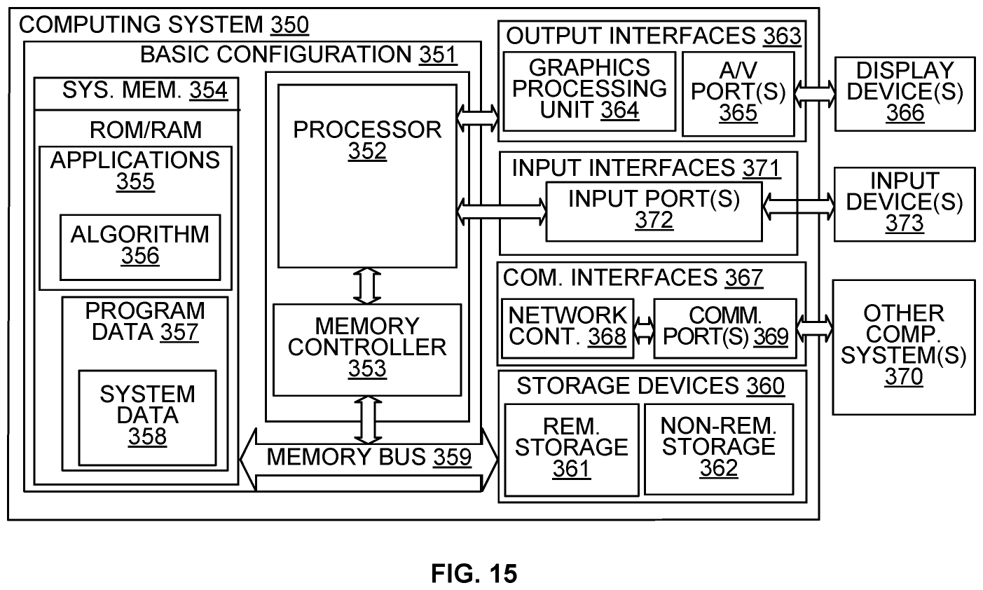

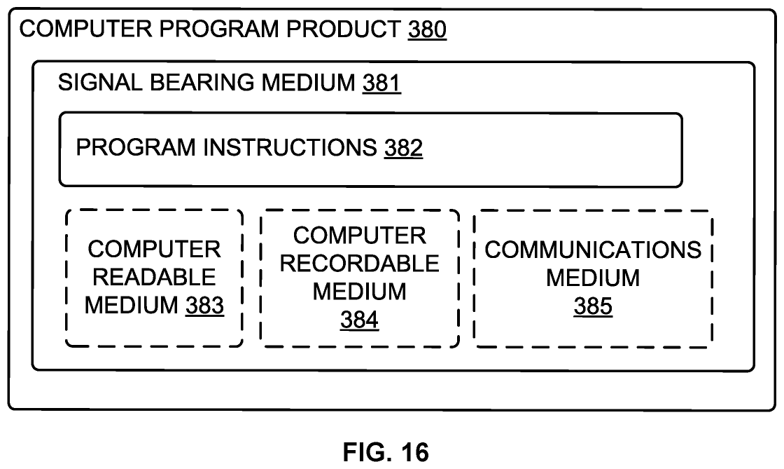

The memory 73 can include content described as being contained in the memory 123, the memory 173, the system memory 354 shown in FIG. 15, and/or the computer program product 380 shown in FIG. 16. The memory 123 can include content described as being contained in the memory 73, the memory 173, the system memory 354, and/or the computer program product 380. The memory 173 can include content described as being contained in the memory 73, the memory 123, the system memory 354, and/or the computer program product 380. The system memory 354 can include content described as being contained in the memory 73, the memory 123, the memory 173, and/or the computer program product 380. The computer program product 380 can include content described as being contained in the memory 73, the memory 123, the memory 173, and/or the system memory 354.

A non-transitory memory can include a tangible, volatile or non-volatile, storage component, such as an optical, magnetic, organic or other memory or disc storage component. Additionally or alternatively, a non-transitory memory can include or be operable as a random-access memory (RAM), a read-only memory (ROM), a programmable read-only memory (PROM), an erasable programmable read-only memory (EPROM), a flash memory, an electrically erasable programmable read-only memory (EEPROM), or a compact disk read-only memory (CD-ROM). The RAM can include static RAM or dynamic RAM. A non-transitory memory can be operable as a removable storage device, a non-removable storage device, or a combination thereof. A removable storage and/or a non-removable storage device can include a magnetic disk device such as a flexible disk drive or a hard-disk drive (HDD), an optical disk drive such as a compact disc (CD) drive and/or a digital versatile disk (DVD) drive, a solid state drive (SSD), or a tape drive.

A transitory memory can include, for example, CRPI provided over a communication network (e.g., the communication network 11), a communication link (e.g., the communication link 16, 45, the wired communication link 26 or the wireless communication link 27, 28), or a data bus (e.g., the data bus 79).

A “memory” can be referred to by other terms such as a “computer-readable memory,” a “computer-readable medium,” a “computer-readable storage medium,” a “data storage device,” a “memory device,” “computer-readable media,” a “computer-readable database,” “at least one computer-readable medium,” or “one or more computer-readable mediums.” Any of those alternative terms can be preceded by the prefix “transitory” if the memory is transitory or “non-transitory” if the memory is non-transitory. For a memory including multiple memories, two or more of the multiple memories can be the same type of memory or different types of memories.

### 3. Transceiver

A transceiver, such as the transceiver 72, 122, 172 or any other transceiver discussed in this description, can include one or more transceivers. Each transceiver includes one or more transmitters operable to transmit data onto a data bus within the computing system (e.g., the VST 70, the server 120, or the companion computing system 170) including the transceiver. Each transceiver includes one or more receivers operable to receive data or a communication carried over a data bus within computing system (e.g., the VST 70, the server 120, or the companion computing system 170) including the transceiver. Unless stated differently, any data described as being transmitted to a device or system is considered to be received by that device or system. Similarly, unless stated differently, any data described as being received from a device or system is considered to be transmitted by that device or system directly or indirectly to the receiving device or system. For some implementations, a transceiver can include a transmitter and a receiver in a single semiconductor chip. In at least some of those implementations, the semiconductor chip can include a processor.

For purposes of this description and with respect to a particular vehicle (e.g., the vehicle 14, 32, 50), a network can be operable as a vehicle network, a non-vehicle network, or a multi-purpose network. The vehicle network is at least partly on-board the particular vehicle and has an OBDC and one or more electronic controls units interconnected to the OBDC and/or to each other. In at least some implementations, the VST 13, 70 includes a harness that operatively connects to the OBDC in the particular vehicle and allows the VST 13, 70 to be disposed outside of the particular vehicle. In those or in other implementations, the VST 13, 70 is operable to communicate with the OBDC and can be disposed within or outside of the particular vehicle. The non-vehicle network is off-board of the particular vehicle and includes one or more network nodes outside of the particular vehicle. The multi-purpose network is contained at least partly within the particular vehicle and at least partly off-board the particular vehicle. The multi-purpose network can include a vehicle network and a non-vehicle network.

In at least some of the example implementations, a transmitter, such as a transmitter within any transceiver described in this description, transmits radio signals carrying data, and a receiver, such as a receiver within any transceiver described in this description, receives radio signals carrying data. A transceiver with a radio transmitter and radio receiver can include one or more antennas and can be referred to as a “radio transceiver,” an “RF transceiver,” or a “wireless transceiver.” “RF” represents “radio frequency.”

A radio signal transmitted or received by a radio transceiver can be arranged in accordance with one or more wireless communication standards or protocols such as an Institute of Electrical and Electronics Engineers (IEE®) standard, such as (i) an IEE® 802.11 standard for wireless local area networks (wireless LAN) (which is sometimes referred to as a WI-FI® standard) (e.g., 802.11a, 802.11b, 802.11g, or 802.11n), (ii) an IEEE® 802.15 standard (e.g., 802.15.1, 802.15.3, 802.15.4 (ZIGBEE®), or 802.15.5) for wireless personal area networks (PANs), (iii) a BLUETOOTH® version 4.1 or 4.2 standard developed by the Bluetooth Special Interest Group (SIG) of Kirkland, Washington, (iv) a cellular wireless communication standard such as a long term evolution (LTE) standard, (v) a code division multiple access (CDMA) standard, (vi) an integrated digital enhanced network (IDEN) standard, (vii) a global system for mobile communications (GSM) standard, (viii) a general packet radio service (GPRS) standard, (ix) a universal mobile telecommunications system (UMTS) standard, (x) an enhanced data rates for GSM evolution (EDGE) standard, (xi) a multichannel multipoint distribution service (MMDS) standard, (xii) an International Telecommunication Union (ITU) standard, such as the ITU-T G.9959 standard referred to as the Z-Wave standard, (xiii) a 6LoWPAN standard, (xiv) a Thread networking protocol, (xv) an International Organization for Standardization (ISO/International Electrotechnical Commission (IEC) standard such as the ISO/IEC 18000-3 standard for Near Field Communication (NFC), (xvi) the Sigfox communication standard, (xvii) the Neul communication standard, (xviii) the LoRaWAN communication standard, or (xix) a 5G new radio (5G NR) communication standard by the 3^{rd} Generation Partnership Project (3GPP) standards organization, such as the 5G NR, phase one or 5G NR, phase two communication standard. Other examples of the wireless communication standards or protocols are possible.

In at least some of the implementations, a transmitter, such as a transmitter within any transceiver described in this description, can be operable to transmit a signal (e.g., one or more signals or one or more electrical waves) carrying or representing data onto an electrical circuit (e.g., one or more electrical circuits). Similarly, a receiver, such as a receiver within any transceiver described in this description, can be operable to receive via an electrical circuit a signal carrying or representing data over the electrical circuit. The electrical circuit can be part of a non-vehicle network, a vehicle network, or a multi-purpose network. The signal carried over an electrical circuit can be arranged in accordance with a wired communication standard such as a Transmission Control Protocol/Internet Protocol (TCP/IP), an IEEE® 802.3 Ethernet communication standard for a LAN, a data over cable service interface specification (DOCSIS standard), such as DOCSIS 3.1, a universal serial bus (USB) specification, a vehicle data message (VDM) protocol, or some other wired communication standard or protocol. Examples of a VDM protocol are listed in elsewhere in this description. An electrical circuit can include a wire, a printed circuit on a circuit board, and/or a network cable (e.g., a single wire, a twisted pair of wires, a fiber optic cable, a coaxial cable, a wiring harness, a power line, a printed circuit, a CAT5 cable, and/or CAT6 cable). The wire can be referred to as a “conductor”. Transmission of data over the conductor can occur electrically and/or optically.

In accordance with at least some implementations, the transceiver 72, 122, 172 includes a network transceiver and/or a vehicle communications transceiver. As shown in FIG. 5, the transceiver 72 includes a network transceiver 90 and/or a vehicle communications transceiver 91. The network transceiver is operable to communicate over a non-vehicle network and/or a multi-purpose network. The vehicle communications transceiver is operable to communicate over a vehicle network and/or a multi-purpose network. The transceiver 72, 122, 172 can be operable as a gateway to communicate over a multi-purpose network. The transceiver 72, 122, 172 is also operable to communicate over the data bus 79, 125, 175, respectively.

In at least some implementations, the network transceiver includes a modem, a network interface card, a local area network (LAN) on motherboard (LOM), and/or a chip mountable on a circuit board. As an example, the chip can include a CC3100 Wi-Fi® network processor available from Texas Instruments, Dallas, Texas, a CC256MODx Bluetooth® Host Controller Interface (HCI) module available from Texas instruments, or a different chip for communicating via Wi-Fi®, Bluetooth® or another communication protocol.

A network node that is within and/or connected to a non-vehicle network and/or that communicates via a non-vehicle network or a multi-purpose network using a packet-switched technology can be locally configured for a next ‘hop’ in the network (e.g., a device or address where to send data to, and where to expect data from). As an example, a device (e.g., a transceiver) operable for communicating using an IEEE® 802.11 standard can be configured with a network name, a network security type, and a password. Some devices auto-negotiate this information through a discovery mechanism (e.g., a cellular phone technology).

The network transceiver 90 can be arranged to transmit a request and/or receive a response using a transfer protocol, such a hypertext transfer protocol (i.e., HTTP), an HTTP over a secure socket link (SSL) or transport layer security (TLS) (i.e., HTTPS), a file transfer protocol (i.e., FTP), or a simple mail transfer protocol (SMTP). The network transceiver 90 can be arranged to transmit an SMS message using a short message peer-to-peer protocol or using some other protocol.

The data transmitted by the transceiver 72 can include a destination identifier or address of a computing system to which the data is to be transmitted. The data or communication transmitted by the transceiver 72 can include a source identifier or address of the VST 70. The source identifier or address can be used to send a response to the VST 70. As an example, this data or communication can include a user identifier corresponding to a user of the VST 70, credential data corresponding to a user of the VST 70, a VDM, a graphical user interface (GUI), or other data instead or as well.

### 4. User Interface

In at least some implementations, the user interface 74 includes a display, an input device 82, and/or an output device 83.

The display 81 can include one or more displays. As an example, each display of the one or more displays includes a capacitive touch screen display, a resistive touch screen display, a plasma display, a light emitting diode (LED) display, a cathode ray tube display, an organic light-emitting diode (OLED) display (such as an active-matrix OLED or a passive-matrix OLED), a liquid crystal display (LCD) device (such as include a backlit, color LCD device), a touch screen display with the LCD device, a capacitive touch screen display, or a resistive touch screen display. The display 81 can include a different type of display as well or instead. Each display can include one or more display screens.

In at least some implementations, the display 81 is affixed (e.g., removably affixed) to a substrate of the housing 76 and/or to the housing 76. In those or in other implementations, the display 81 is worn and/or within a wearable device, such as a pair of glasses or goggles, a head-mountable display, or a wrist display, such as a wristwatch (e.g., a smartwatch).

The display 81 is operable to display displayable content. Examples of displayable content are provided throughout this application by describing objects displayed by the display 81. As an example, the display 81 is operable to display a GUI, a USC of a GUI and/or the user interface 74, a message, a notification, an indicator of a PID condition, a sub-container, a container, a PID, a parameter value, a PID condition, service information, or some other type of information or data.

The display 81 can also be operable to display a still image (such as a visible light image, a thermal image, and/or a blended image based on a visible light image and a thermal image), a video, a text file (such as a text file with a PDF file extension or an XML file extension), a hypertext markup language file, a web page (such as a web page including a search bar and/or a cursor), and/or a GUI. In at least some implementations, the display 81 is operable to display a horizontal scroll bar and/or a vertical scroll bar. The horizontal scroll bar and the vertical scroll bar can be used to cause the display 81 to display content not currently displayed on the display 81. A web page displayable on the display 81 can include any content shown in or described with respect to any one or more of the GUIs shown in the drawings and/or described in this description. Other examples of content displayable on the display 81 are also possible.

The input device 82 is operable to receive user inputs from a user of the VST 70. As an example, the input device 82 includes a keyboard or keypad including one or more keys operable to be pressed or otherwise manipulated by the user. As another example, the input device 82 includes a microphone operable to receive sound waves, such as sound waves produced by the user speaking words in a vocabulary of the VST 70. In the implementations in which the display 81 is operable as a touch screen display, the display 81 can receive user inputs from a user of the VST 70. Accordingly, the input device 82 can include the display 81 when operable as a touch screen display. As another example, the input device 82 can include a camera to capture images (e.g., an image of a user fingerprint, a user face, a vehicle, a vehicle component, a bar code, or a matrix code). As another example, the camera can capture image(s) regarding performance of a certified user function (e.g., a pre-performance image showing a camera installed on a vehicle and a post-performance image showing the camera on the vehicle after the camera has been calibrated via the certified user function). As another example, images(s) regarding performance of the certified user function can include image(s) showing calibrations targets set up in proximity to the vehicle to calibrate one or more ADAS components on the vehicle.

In the implementations that include the output device 83, the output device 83 can include one or more speakers operable to convert electrical signals to audible sounds. In those or in other implementations, the output device 83 can include wired headphones and/or wireless headphones. The wired headphones can connect to an audio plug operatively connectable to an audio jack. The wireless headphones can include in-ear headphones, such as the AIRPODS PRO® in-ear headphones by Apple Inc. In the implementations that include the output device 83, the output device 83 can include the display 81 to display content (e.g., GUIs and service information) output by the processor 71.

### 5. Test Device

The test device 75 can include one or more test devices, such as one or more test devices to test the vehicle 14, 32, 50. As an example, the test device 75 can include a meter 87 and/or an oscilloscope 88. The meter 87 includes a port 92 (e.g., one or more ports). The oscilloscope 88 includes a port 93 (e.g., one or more ports). The meter 87 can include a digital volt-ohm meter (DVOM). Additionally or alternatively, the meter 87 can include a current meter. The meter 87 includes and/or is operatively connect to the port 92. The port 92 includes one or more ports for receiving an end of a meter lead. An opposite end of the meter lead is connectable to a component on a vehicle. The oscilloscope 88 can include one or more channels. The port 93 includes a port for each channel of the oscilloscope 88. Each port of the port 93 is operable to receive an end of an oscilloscope test lead. An opposite end of the oscilloscope test lead is connectable to a component on a vehicle.

Additionally, the test device 75 can include one or more of the following: an analog-to-digital converter (ADC) 84, a probe 85, and a signal generator 86. The signal generator 86 can output a signal onto a meter lead connected to the port 92 and/or onto an oscilloscope test lead connected to the port 93. The output signal can be used to measure a signal. For instance, the signal generator 86 can output a voltage differential across two meter leads connected to the port 92 (e.g., a red meter lead and a black meter lead) and onto a circuit for use in measuring a resistance of the circuit. The ADC 84 can be operable to convert an analog signal received via a meter lead or an oscilloscope test lead into a digital signal. A digital signal representing a signal detected by the signal detector can be output onto the data bus 79 for transmission to the processor 71.

### 6. Additional Components

A power supply, such as the power supply 77, 128, 177 or any other power supply discussed in this description, can be arranged in any of a variety of configurations. As an example, the power supply can be operable to include circuitry to receive AC current from an AC electrical supply (e.g., electrical circuits operatively connected to an electrical wall outlet) and convert the AC current to a DC current for supplying to one or more from among the components connected to the power supply 77. As another example, the power supply can be operable to include a battery or be battery operated. As yet another example, the power supply can be operable to include a solar cell or be solar operated. Moreover, a power supply can be operable to include and/or connect to a power distribution circuit to distribute electrical current throughout the device or system including that power supply. In at least some implementations of the VST 70, the power distribution circuit includes the electrical circuit 80 (i.e., one or more electrical circuits) that connects to the processor 71, the memory 73, the transceiver 72, the user interface 74 the test device 75, and/or the vehicle connector 78. Other examples of a power supply, such as the power supply 77, are also possible.

In at least some implementations, the VST 70 includes a housing 76. The housing 76 surrounds at least a portion of the following: the processor 71, the transceiver 72, the memory 73, the user interface 74, the test device 75, the data bus 79, the power supply 77 and/or the vehicle connector 78. The housing 76 can support a substrate, such as a printed circuit board. In at least some example implementations, at least a portion of the following: the processor 71, the memory 73, the transceiver 72, the user interface 74, the data bus 79, the power supply 77 and/or the vehicle connector 78 is/are mounted on and/or connected to a substrate of the housing 76. The housing 76 can be made from various materials. For example, the housing 76 can be made from a plastic material (e.g., acrylonitrile butadiene styrene (ABS)) and a thermoplastic elastomer used to form a grip on the housing 76.

The vehicle connector 78 includes one or more vehicle connectors connectable to a vehicle, such as the vehicle 14, 32, 50. The vehicle connector 78 can include a vehicle connector configured to connect to an OBDC. The vehicle connector 78 can include a dongle, such as the dongle 30.

### 7. Memory Content

The example implementations can determine, generate, store (e.g., write into a memory), transmit, read, receive, and/or otherwise use a variety of computer-readable data. At least some of the computer-readable data can be stored in a memory, such as the memory 73, 123, 173.

As an example, the memory 73 contains computer-readable programming instructions (CRPI) 95, a module 96, a GUI 97, a component test 98, vehicle selection data 99, a vehicle data message 100, a password 105, a two-factor authentication code 106, a profile access code 107, a biometric input 108, mapping data 109, service information 150, and/or performance data 152. Additionally, the memory 73 can contain any of the content within the system memory 354 shown in FIG. 15 and/or within the computer program product 380 shown in FIG. 16.

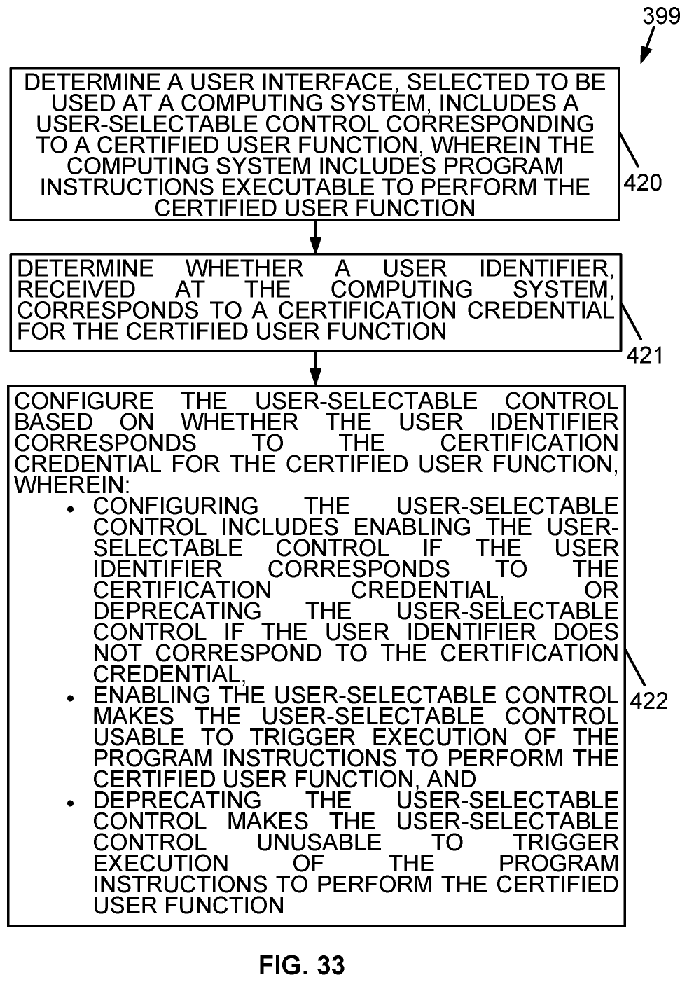

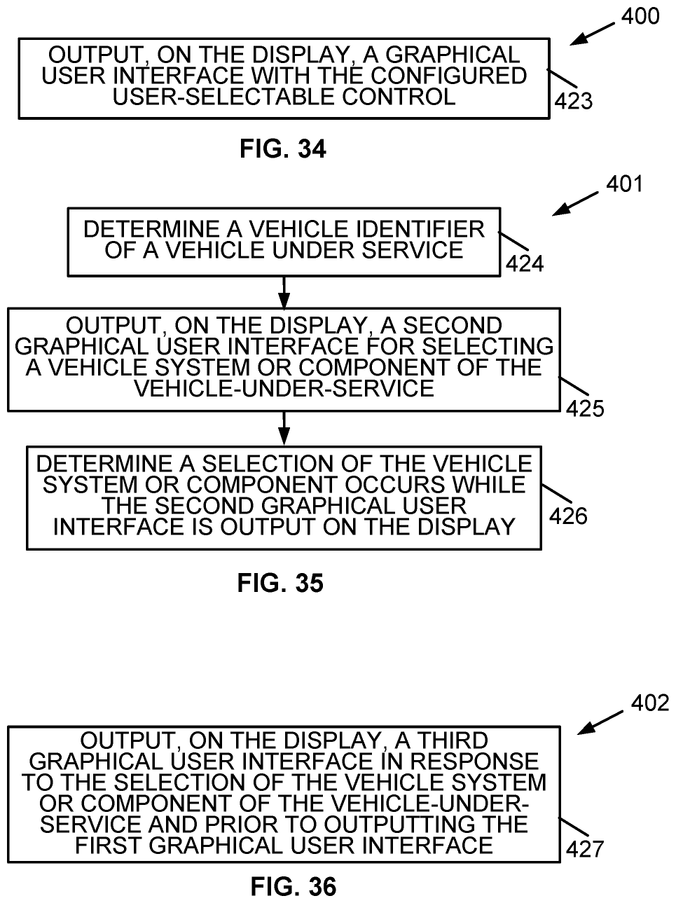

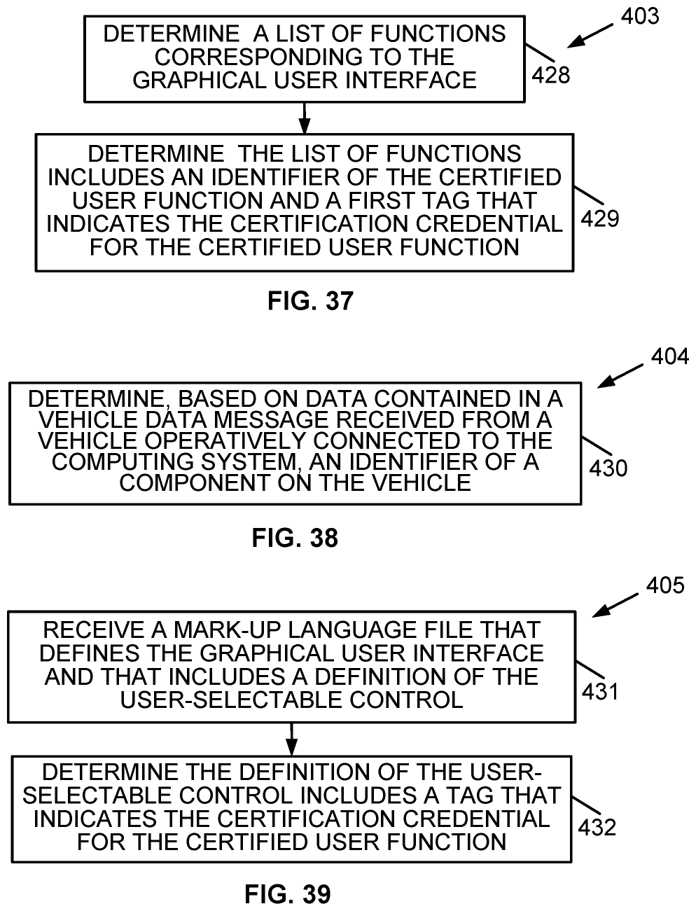

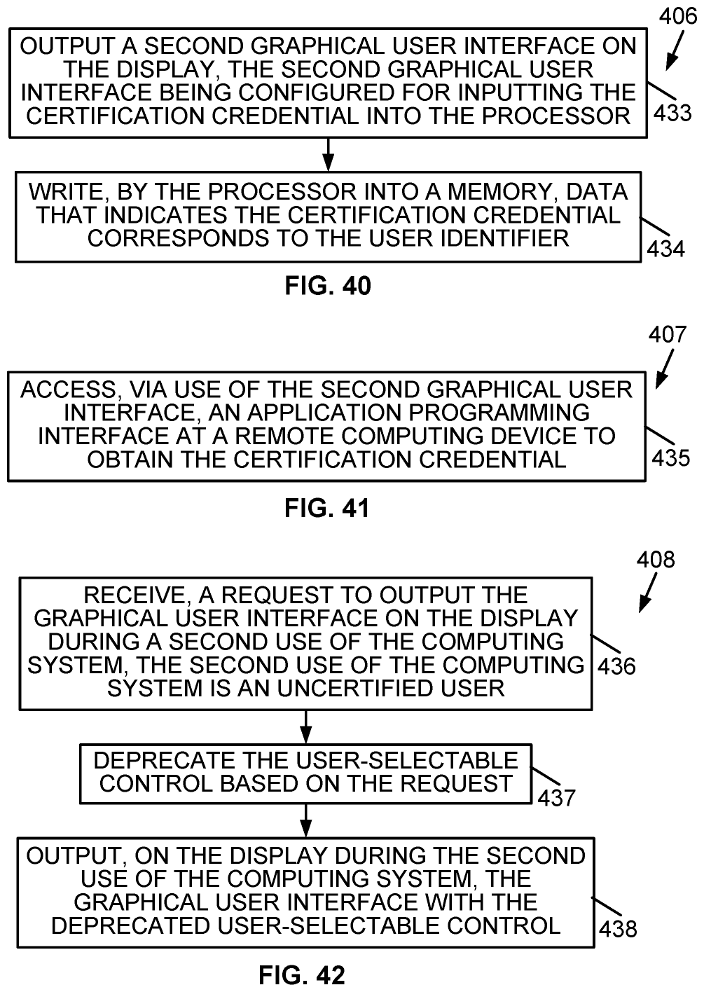

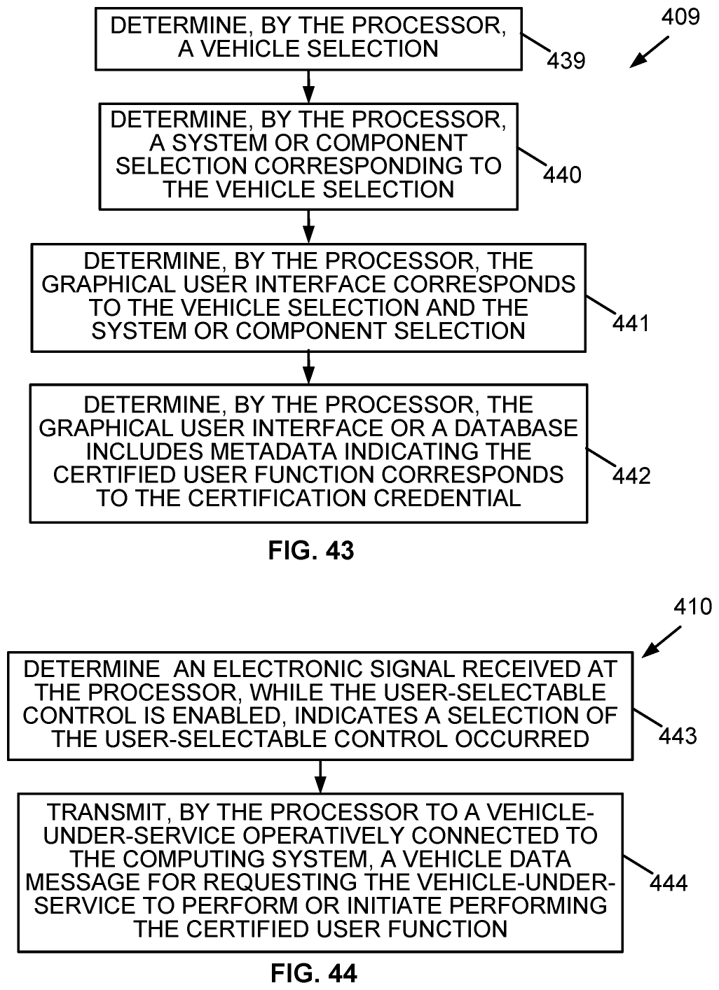

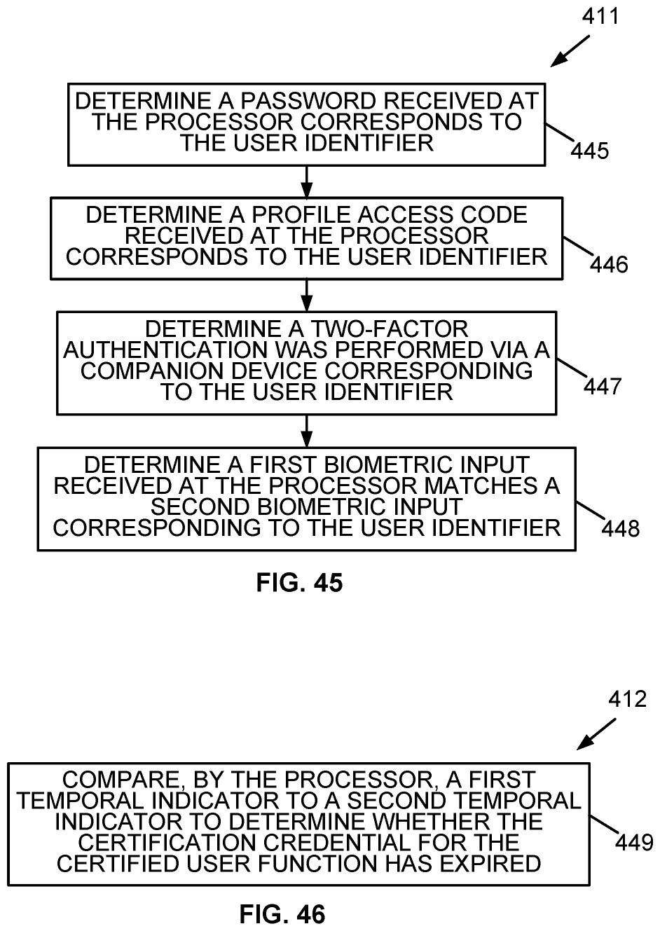

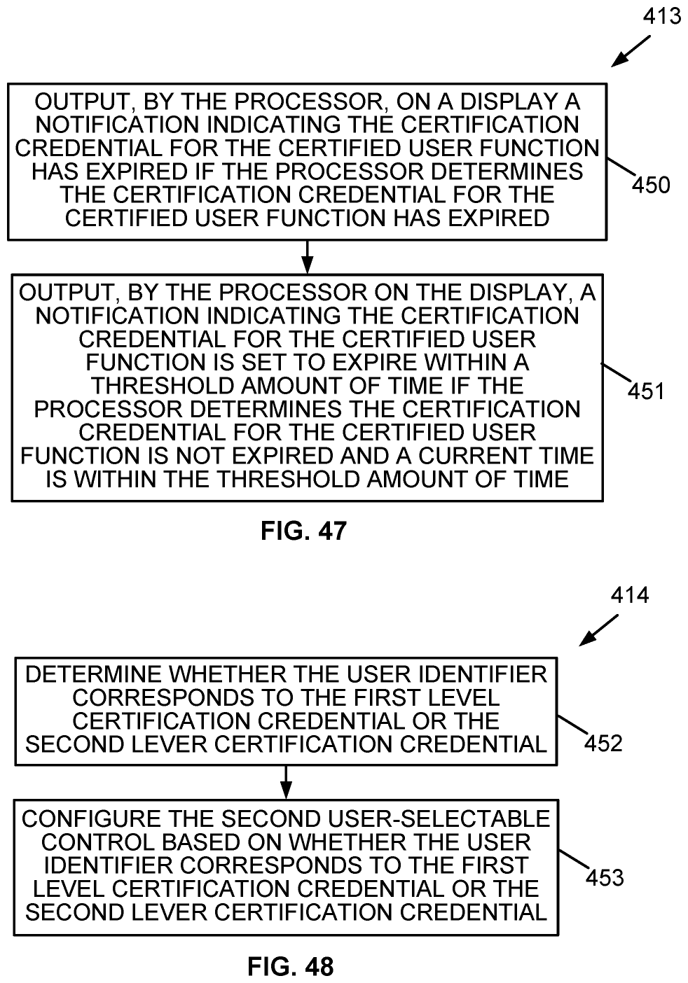

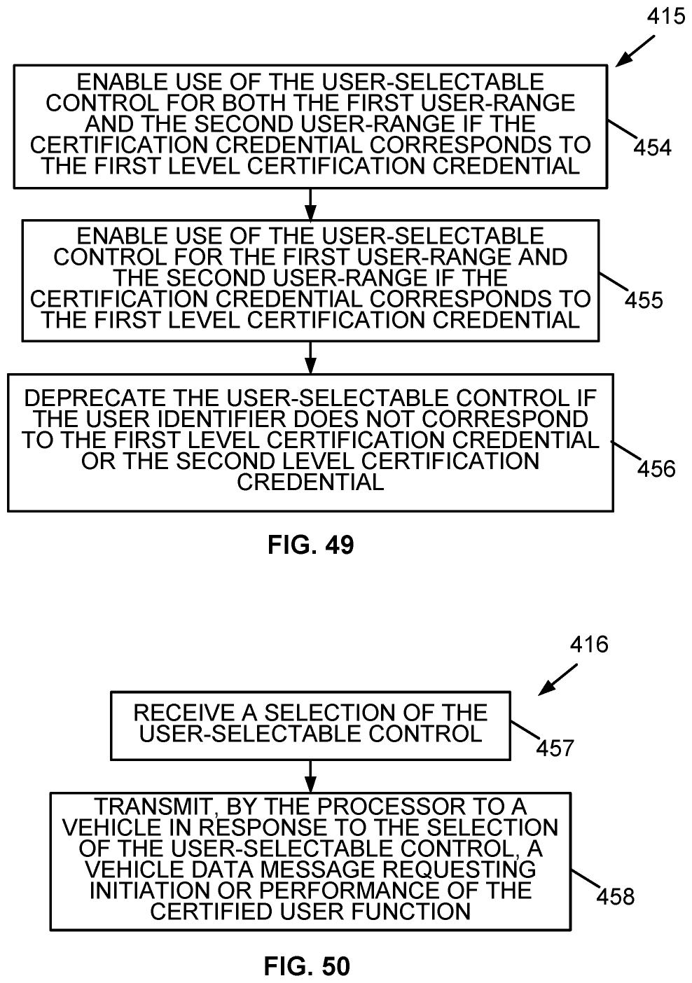

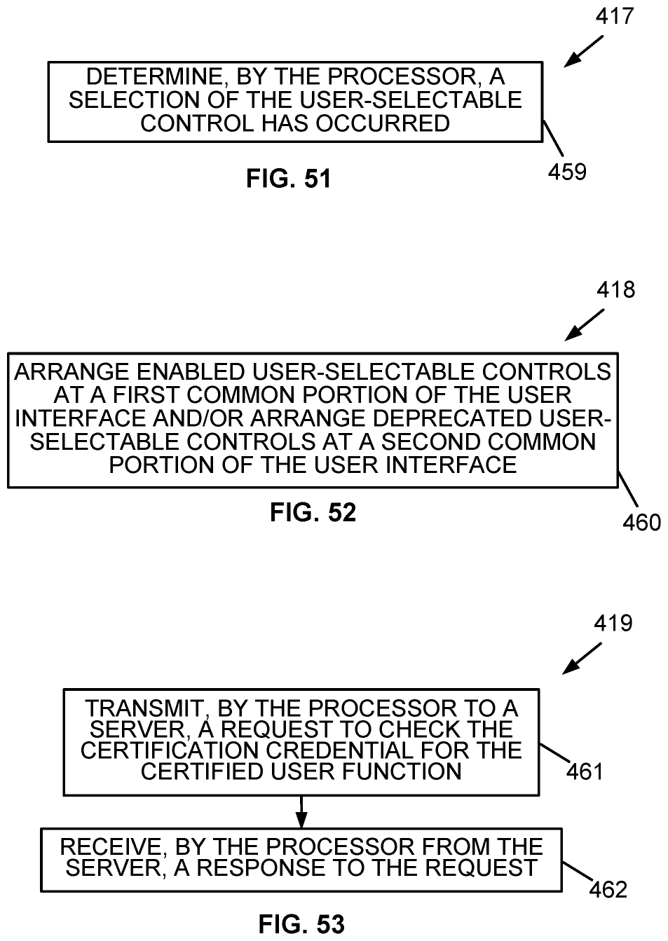

The CRPI 95 can include program instructions executable by a processor, such as the processor 71. As an example, the CRPI 95 can include program instructions that are executable to cause the VST 70 to perform any function (e.g., task) described as being performed by the VST 70, by the processor 71, and/or by some other component of the VST 70. As an example, the CRPI 95 can include program instructions executable by the processor to perform one or more functions of any one or more the function set 399 to the function set 417 shown in FIG. 33 to FIG. 53. In at least some embodiments, the CRPI 95 can include the module 96. In at least some embodiments, the module 96 includes at least a portion of the CRPI 95.

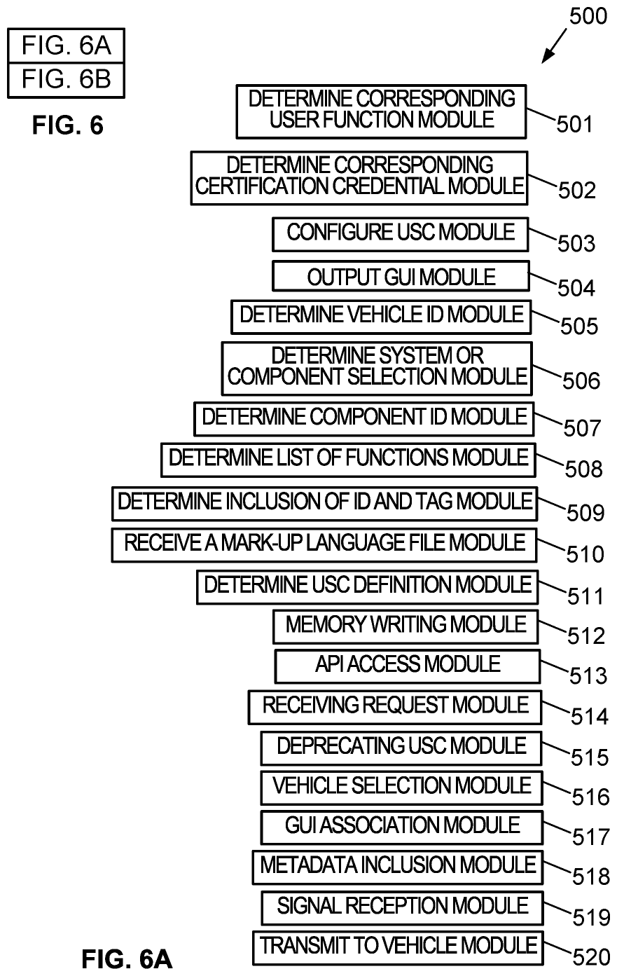

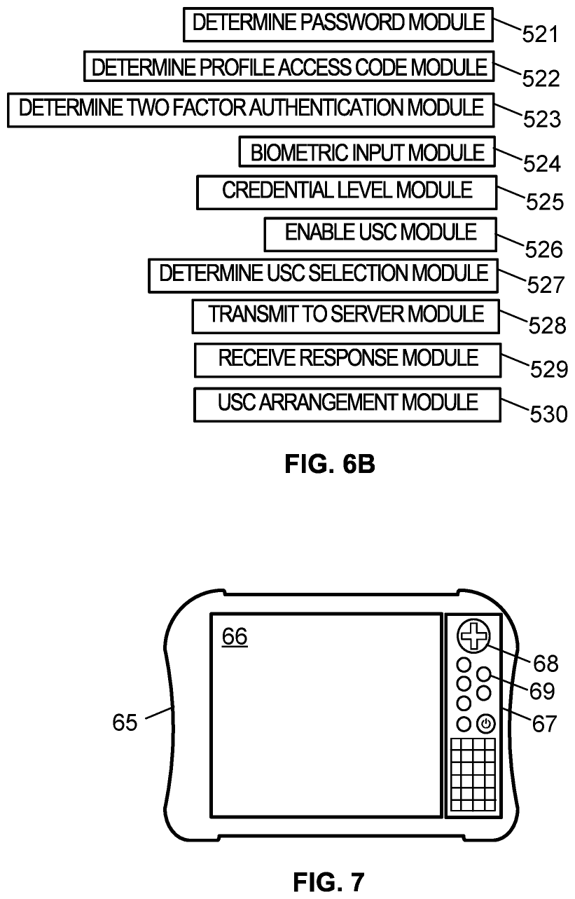

The module 96 can include one or more modules. Examples of modules within the module 96 are shown in FIG. 6. In at least some embodiments, multiple modules are arranged as an application 151. As an example, an application can comprises a browser application.

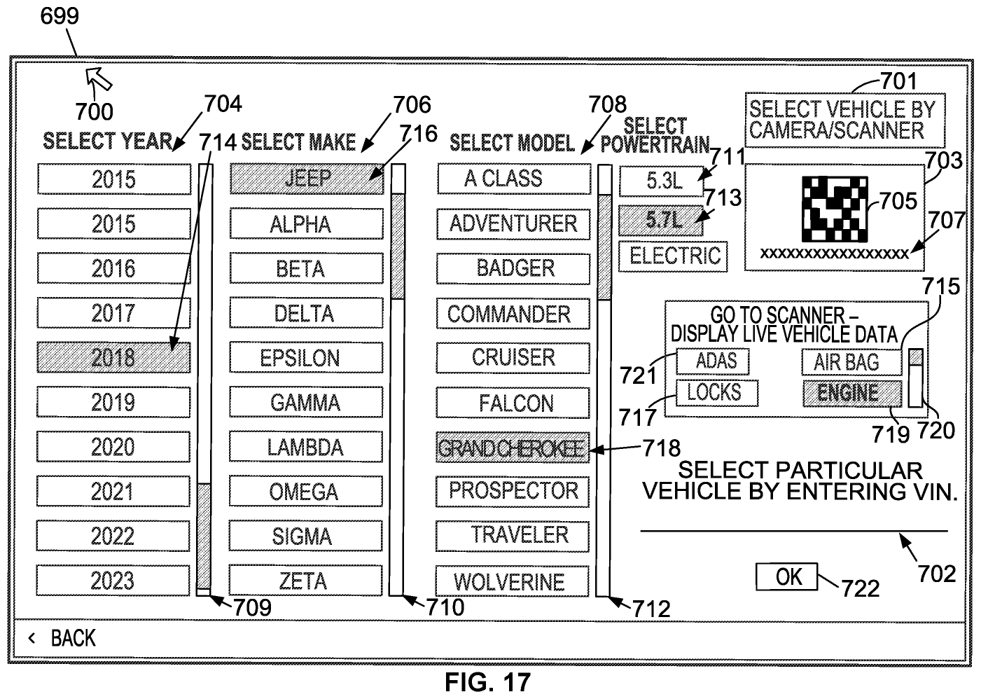

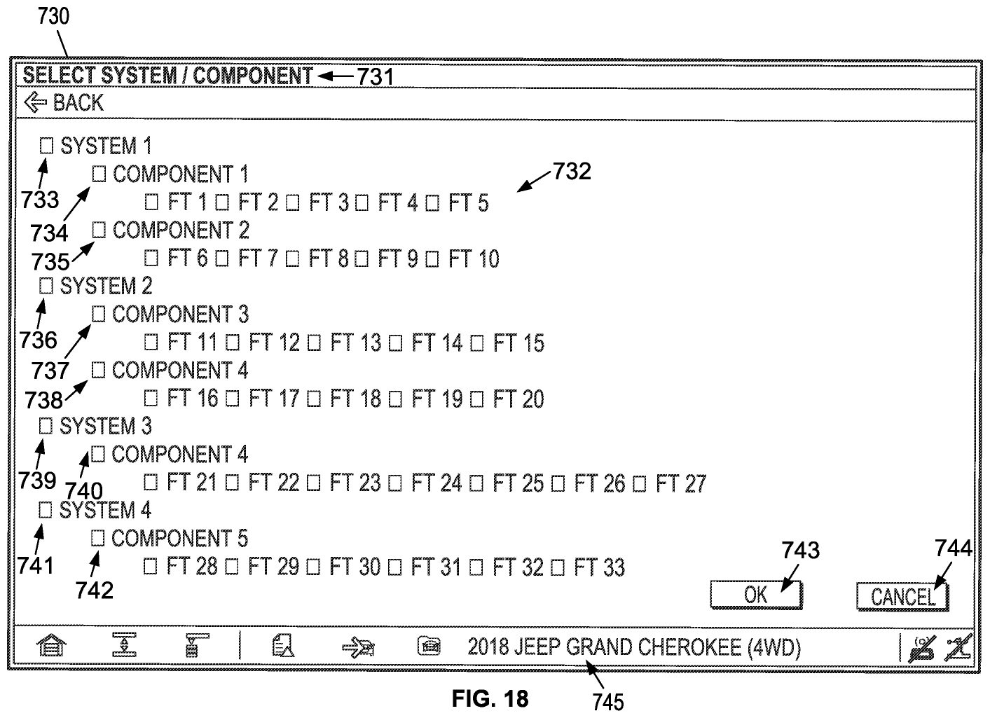

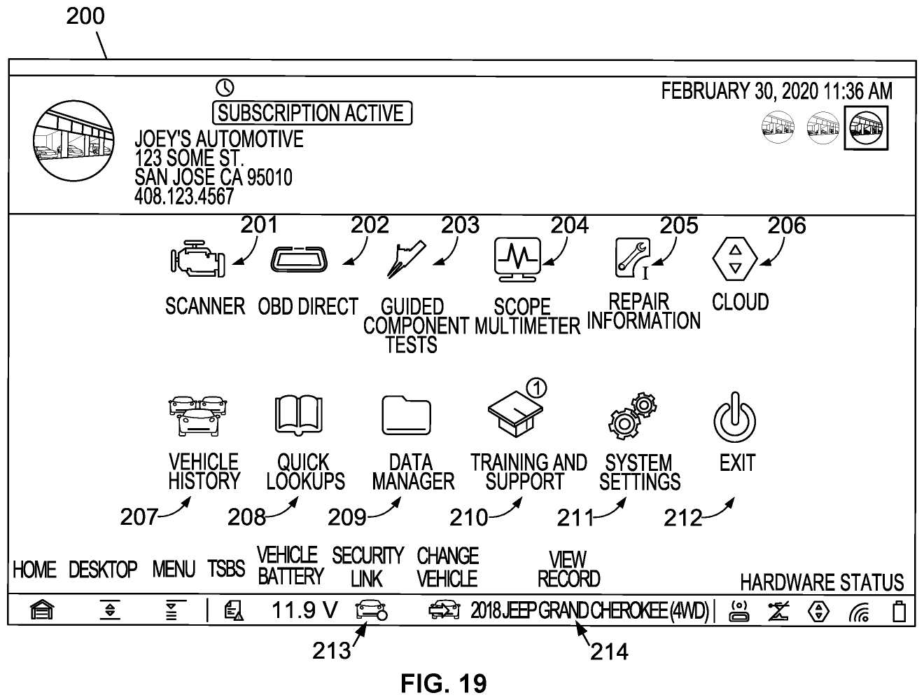

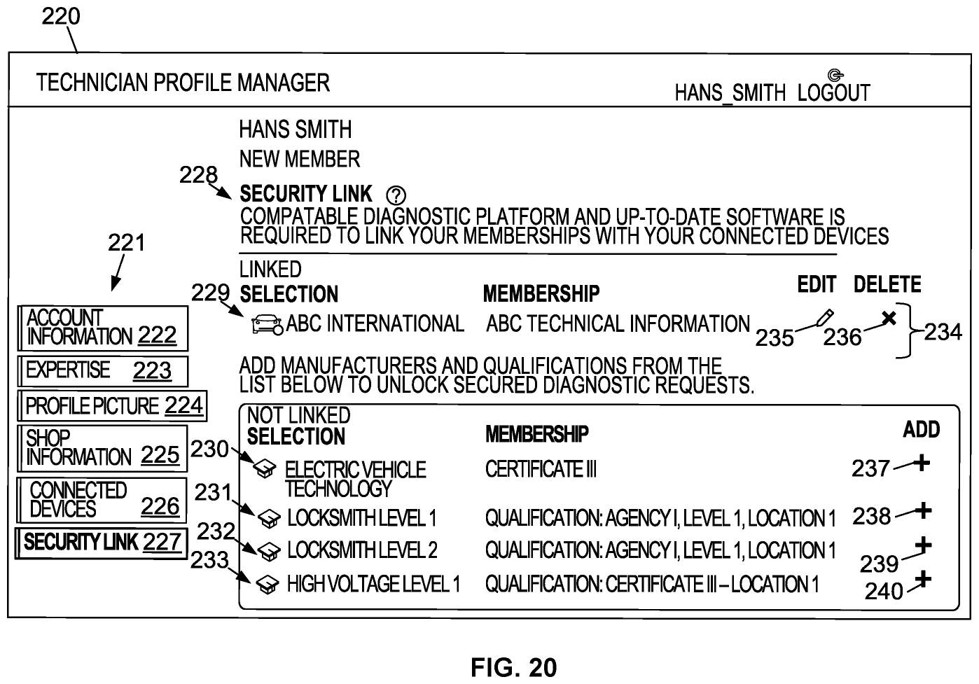

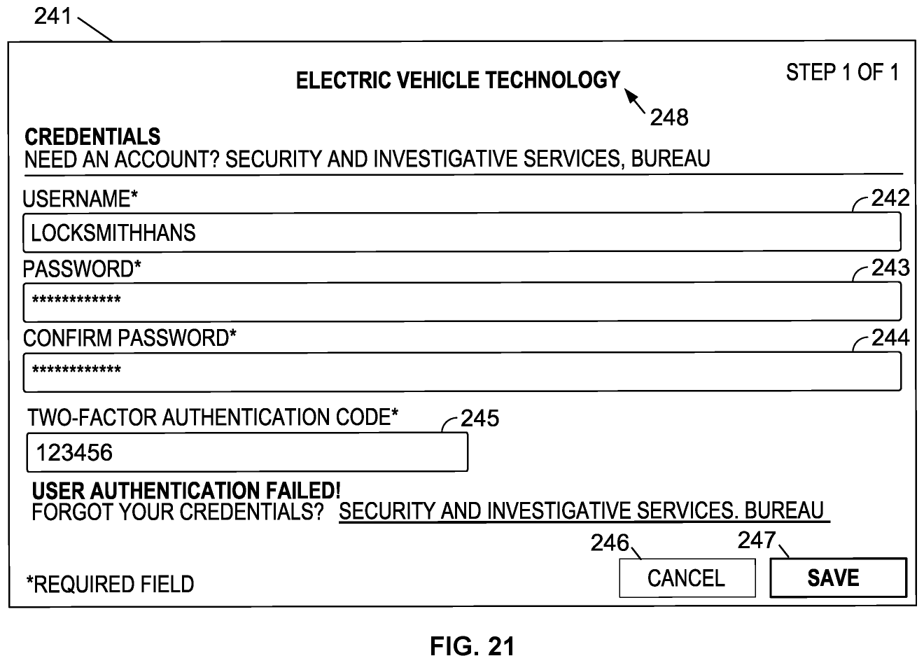

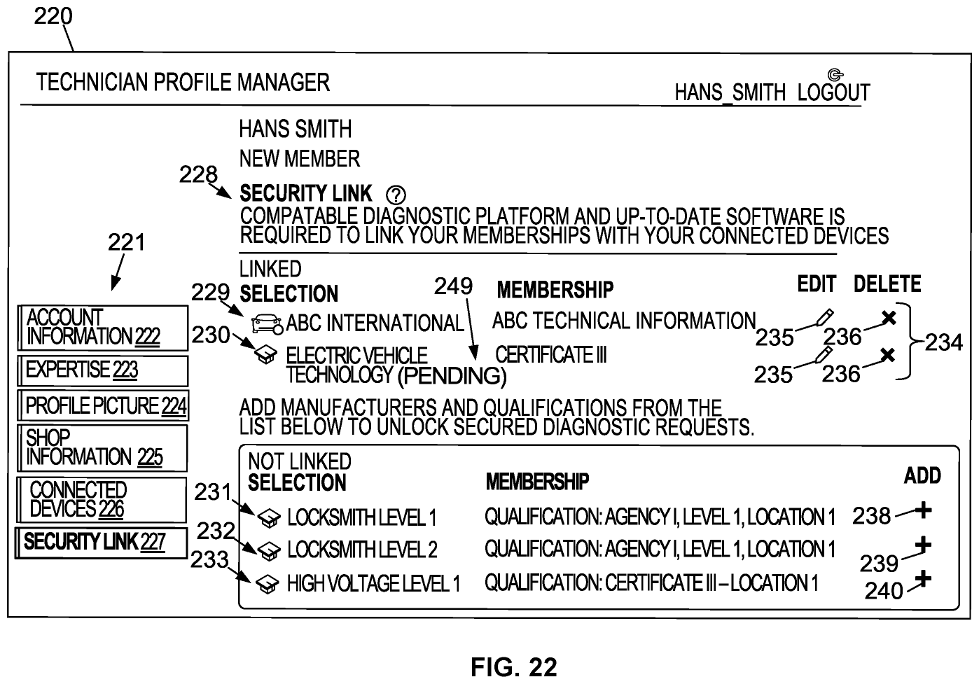

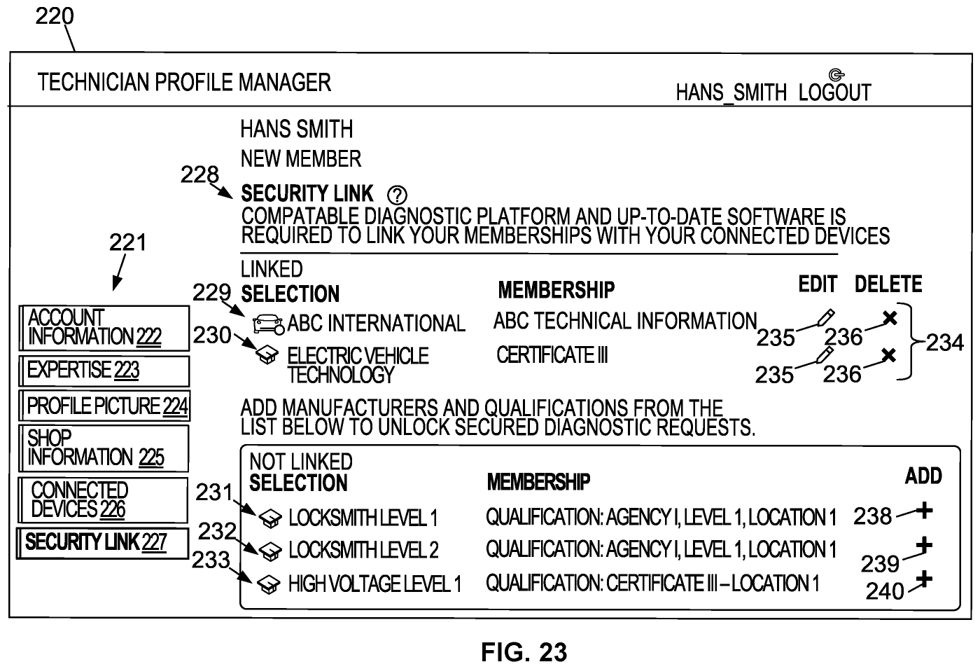

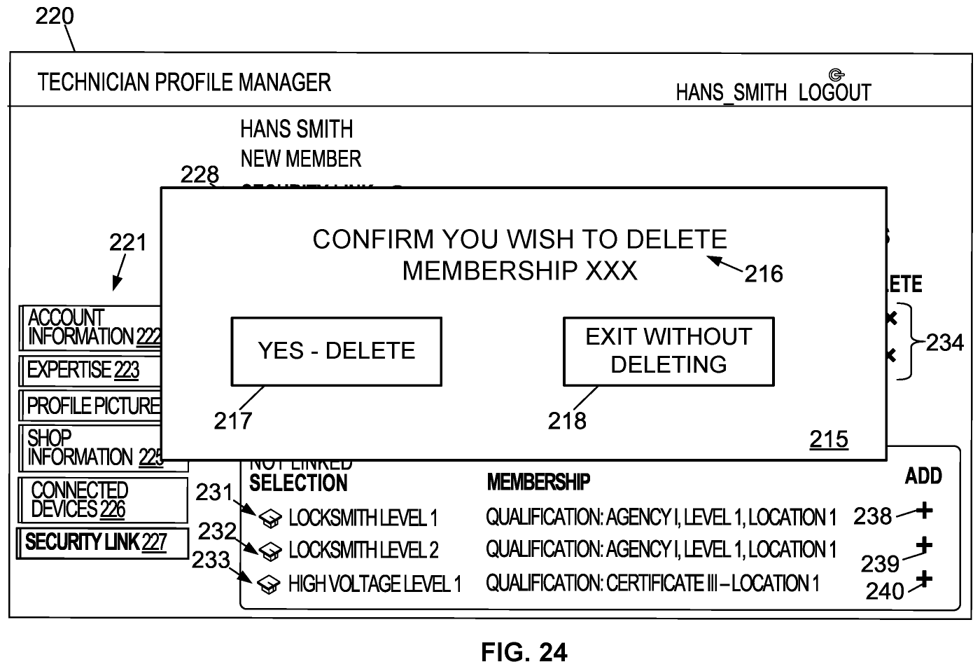

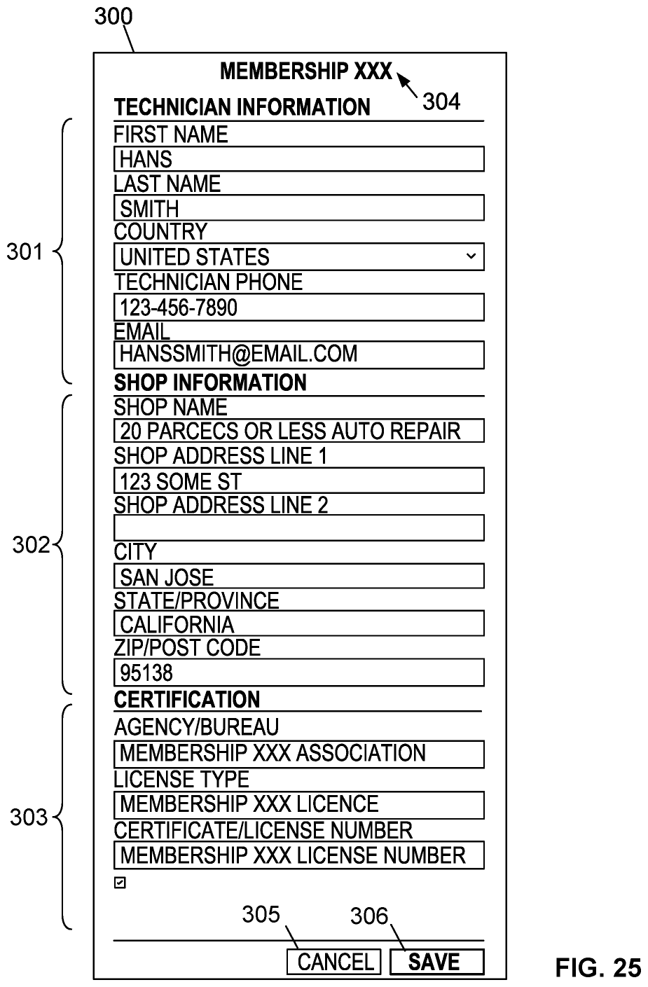

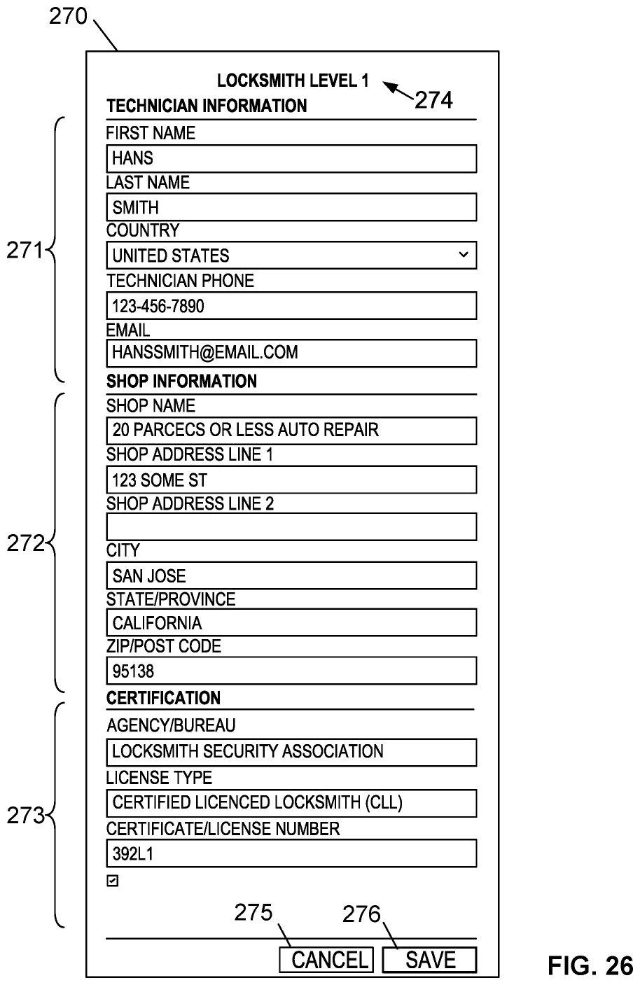

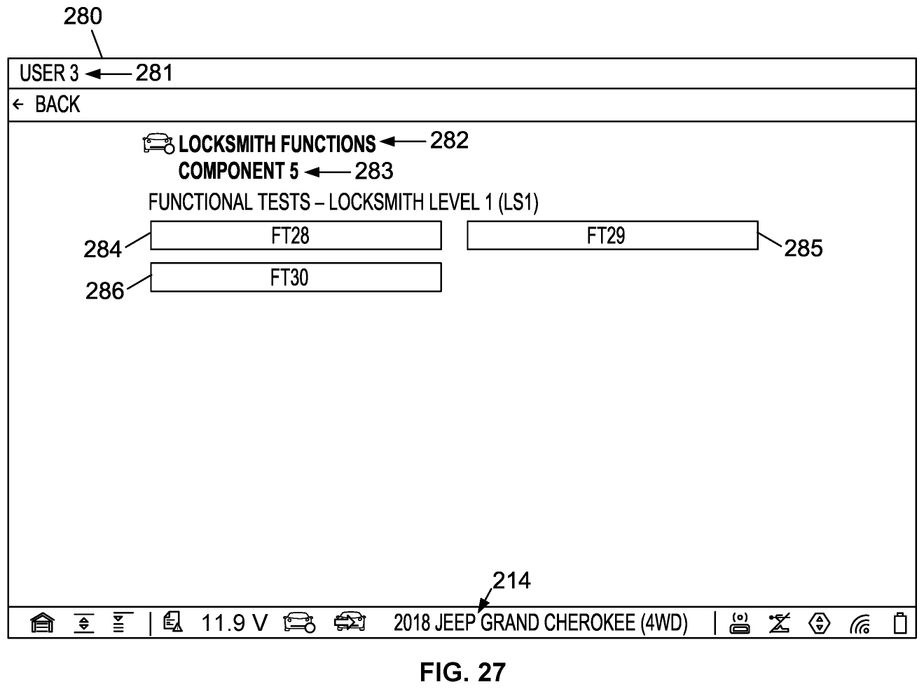

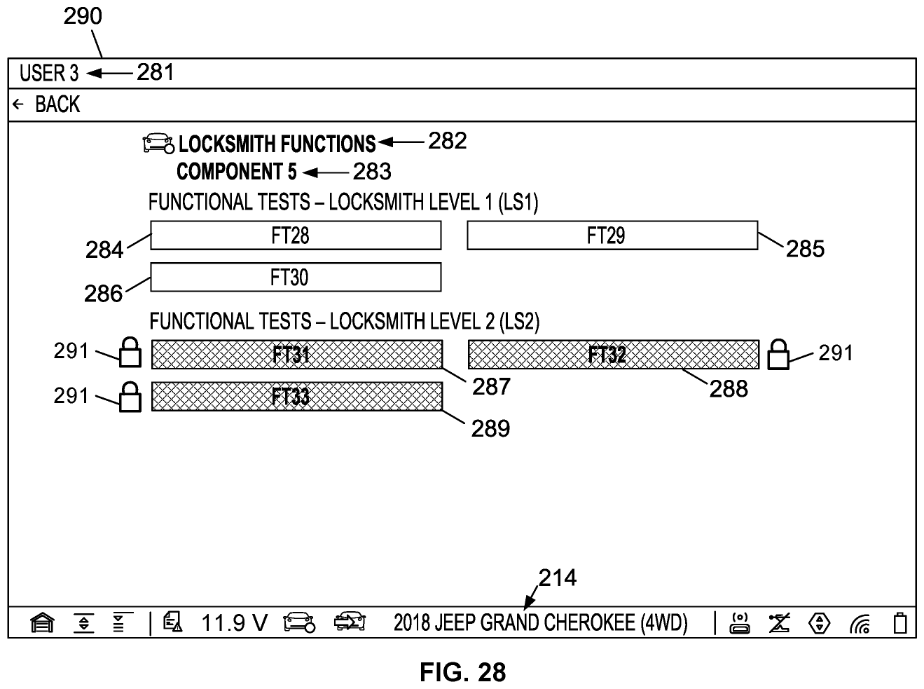

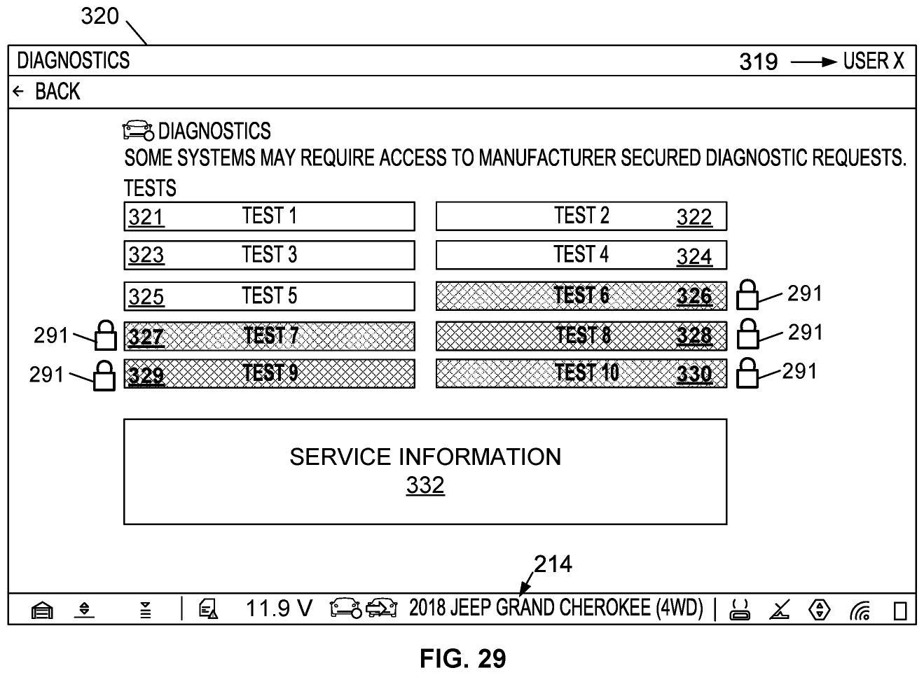

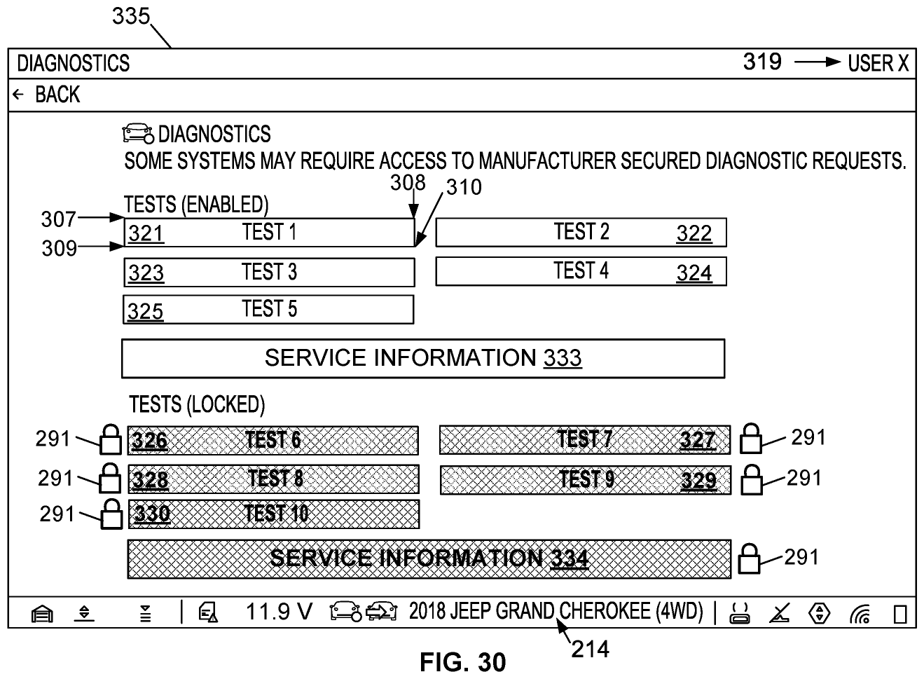

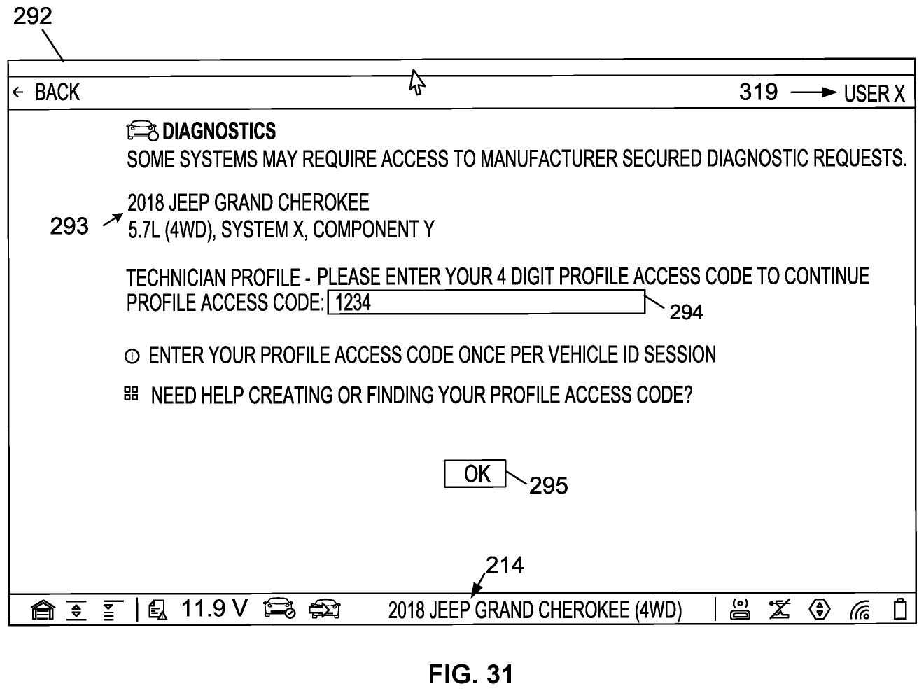

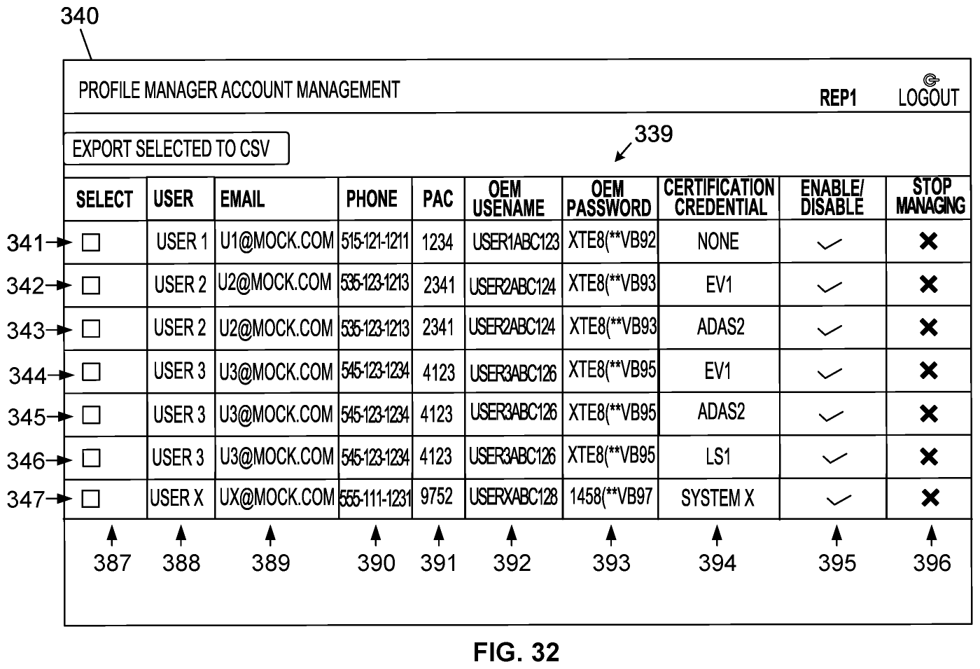

The GUI 97 can include one or more GUIs and/or data for generating one or more GUIs. In at least some implementations, the GUI 97 includes a GUI transmitted to the VST 70 from the server 120. Examples of a GUI contained within and/or generated based on data contained within the GUI 97 are shown in FIG. 17 to FIG. 32. In at least some embodiments, each GUI corresponds to one or more types of vehicles, one or more systems, and/or one or more vehicle components. In at least some embodiments, a GUI is populated with vehicle identifying information regarding one or more types of vehicles and/or USCs corresponding to one or more systems of vehicle components. The GUI 97 can include a data map that indicates which type(s) of vehicle(s), vehicle system(s), and/or vehicle component(s) corresponds to a GUI. The processor can determine the GUI based on the mapping data and data indicative of the type(s) of vehicle(s) or the vehicle component(s).

The component test 98 can include one or more component tests. Each component test can include computer-readable program instructions (e.g., a component test module) executable to perform the component test. Execution of a component test module can include configuring a test device for performing the component test for the component and/or vehicle to be tested. As an example, a component test can include a voltage test, an amperage test, a frequency test, a resistance test, a duty cycle test, or a pressure test. As another example, a component test can be specified for a particular component, such as a fuel pump voltage test or a fuel pump pressure test. As yet another example, a component test can be specified for a particular vehicle on a particular vehicle, such as a fuel pump voltage test on a 2018 Jeep Cherokee (4WD) with 5.7 L engine, or a fuel pump pressure test on a 2018 Jeep Cherokee (4WD) with a 5.7 L engine.

In at least some implementations, the component test 98 includes multiple sets of test device configuration parameters and each set of test device configuration parameters is associated with an index value. A server (e.g., the server 15, 120) can determine which set of device configuration parameters is to be used to set up the test device 75 during a vehicle ID session. The server can transmit the determined set of test device configuration parameters to the VST 13, 70. Alternatively, the server can transmit the index value associated with the determined set of test device configuration parameters to the VST 13, 70. In this alternative arrangement, the computing system can determine the appropriate test device configuration parameters for the vehicle ID session based on the index value received at the VST 13, 70.

Table A includes data that can be stored in the component test 98. For instance, the component test 98 can include an index value corresponding to test device configuration parameters. Additionally, the component test 98 can include data indicating which test device is to be used to perform the test (e.g., make a measurement) and a test name. Furthermore, the component test can include one or more parameters (where N=1 and M≥0). Transmission of an index value can take less bandwidth than transmitting a set of test device configuration parameters.

TABLE A

| Index | Test | | Parameter | Parameter | Credential |
|---|---|---|---|---|---|
| Value | Device | Test | N | N + M | Level (tag) |
| 01 | Meter | Battery Pack | 100 volts/div. | 100 ms/div. | EV1 |
| | | Voltage | | | |
| 02 | Scope | Battery Pack | 100 volts/div. | 100 ms/div. | EV2 |
| | | Voltage | | | |
| 03 | Meter | Fuel Pump | 5 volts/div. | 100 ms/div. | 0 |
| | | Voltage | | | |
| 04 | Meter | Injector | Hertz | Null | 0 |
| | | Frequency | | | |
| 05 | Scope | Injector | 5 volts/div. | 10 ms/div. | 0 |
| | | Frequency | | | |
| 06 | Meter | MAP sensor | 1 volt/div. | 100 ms/div. | 0 |
| | | Voltage | | | |
| 07 | Sig. | Immobilizer | 100 KHz | N/A | LS2 |
| | Gen. | reset | | | |

The vehicle selection data 99 can include one or more vehicle selection menus or data for generating the one or more vehicle selection menus that can be output on a GUI of the GUI 97. The processor 71 can output a vehicle selection menu on the display 81 to allow a user to select a type of vehicle or a particular vehicle. The vehicle selection data 99 can also include data that represents relationships between vehicle model years and the types of vehicles that were built for and/or during each model year. For instance, for a given model year, the vehicle selection data 99 can include data that indicates all vehicle makes that include at least one type of vehicle for the given model year, and for each of those vehicle makes, the vehicle selection data 99 can include data that indicates all vehicle models that correspond to one of the vehicle makes that built at least one type of vehicle for the given model year. FIG. 19 shows an vehicle identifier 214 with a GUI 200. In at least some implementations, the vehicle identifier 214 can be output on the GUI 200 based on selections made using one or more vehicle selection menus based on the vehicle selection data 99. The vehicle selection data can be output on a GUI, such as the GUI 699 shown in FIG. 17.

The vehicle data message 100 includes one or more vehicle data messages (VDMs) and/or data to generate the one or more VDMs to be transmitted by the VCT 91. A VDM within the vehicle data message 100 can include a VDM received by the vehicle communications transceiver 91. A VDM within the vehicle data message 100 can include a VDM that is to be or has been transmitted by the VCT 91. The VDM can include a message map for decoding a VDM received by the VCT 91 and/or for encoding a VDM that is to be transmitted by the VCT 91. The message map can include a formula for converting one or more fields of a VDM to a value represented by the one or more fields. As an example, the fields can represent an engine RPM, a battery voltage, or an engine coolant temperature.

The vehicle data message 100 can include commands 101 can include a PID command 102 (i.e., one or more PID commands), a functional test command 103 (i.e., one or more functional test commands), and a reset procedure command 104 (i.e., one or more reset procedure commands). A PID command can include a PID. A functional test command can include an identifier of a functional test. A reset procedure command can include an identifier of a reset procedure. An identifier of a PID, functional test command, reset procedure, similar to an identifier of a component test or a test set, can be included within mapping data or an index described in this description.

The PID command 102 includes data that indicates how a VDM should be arranged to request a PID parameter value from the vehicle 14 for a particular PID. As an example, the PID command 102 can indicate a particular VDM protocol that is to be used to generate the VDM. As another example, the PID command 102 can include an ECU identifier of the ECU from which the PID parameter value is to be requested. As yet another example, the PID command 102 can include the PID. The processor 71 can determine the PID command 102 based on an index value corresponding to a PID.

As an example, a VDM can be arranged as $07 $DF $02 $01 $31 $00 $00 $00 $00 $00. In that example VDM, the fifth byte is the PID. In at least some implementations, the PID command 102 includes formulas for converting a PID parameter value to a value represented by the PID parameter value.

The functional test command 103 includes data that indicates how a VDM should be arranged for requesting the vehicle 14 to perform a particular functional test. As an example, the functional test command 103 can indicate a particular VDM protocol that is to be used to generate the VDM. As another example, the functional test command 103 can include an ECU identifier of the ECU that is configured to perform the functional test. As yet another example, the functional test command 103 can include the functional test identifier. The processor 71 can determine the functional test command 103 based on an index value corresponding to a functional test identifier.

Additionally or alternatively, the processor 71 can determine the functional test command 103 based on a menu selection and program code or data that corresponds to the menu selection. The processor 71 can use data indicating a VDM protocol to determine which VCT of multiple VCTs is to be used to transmit a functional test command and/or the format for generating a VDM including the functional test command.

The reset procedure command 104 includes data that indicates how a VDM should be arranged for requesting the vehicle 14 to perform a particular reset procedure. As an example, the reset procedure command 104 can indicate a particular VDM protocol that is to be used to generate the VDM. As another example, the reset procedure command 104 can include an ECU identifier of the ECU that is configured to perform the reset procedure. As yet another example, the reset procedure command 104 can include the reset procedure identifier. The processor 71 can determine the reset procedure command 104 based on an index value corresponding to a reset procedure identifier.

The password 105 can include a password entered via a user interface, such as a password entered via the field 243, 244 within the GUI 241 shown in FIG. 20. In at least some implementations, once the password is stored in the memory 73, the processor 71 can compare a subsequently-entered password to the previously stored password. In at least some implementations, the processor 71 can send the password to the server 15, 120 for authentication of a user using the VST 13, 70.

The two-factor authentication code 106 can include a two-factor authentication code received via the communication network 11 from the server 120. An application (e.g., a messaging application or an authentication code application) can display the two-factor authentication code on a display (e.g., the display 81, 251). FIG. 14 shows a screen display 188 including a two-factor authentication code 190.

The profile access code 107 can include one or more profile access codes. Each profile access code can correspond to a different user of the VST 70. The profile access code 107 can contain a reference profile access code for comparison to a later-entered profile access code to determine whether a user of the VST 70 wishing to view and/or change a user profile has been authenticated.

The biometric input 108 can include one or more biometric inputs. A biometric input can include a reference biometric input for comparison to a later-entered biometric input to confirm that the user entering the later-entered biometric input corresponds to the user that entered the reference biometric input. As an example, the reference biometric input can include an image of at least a portion of a user fingerprint or an image of at least a portion of a user face.

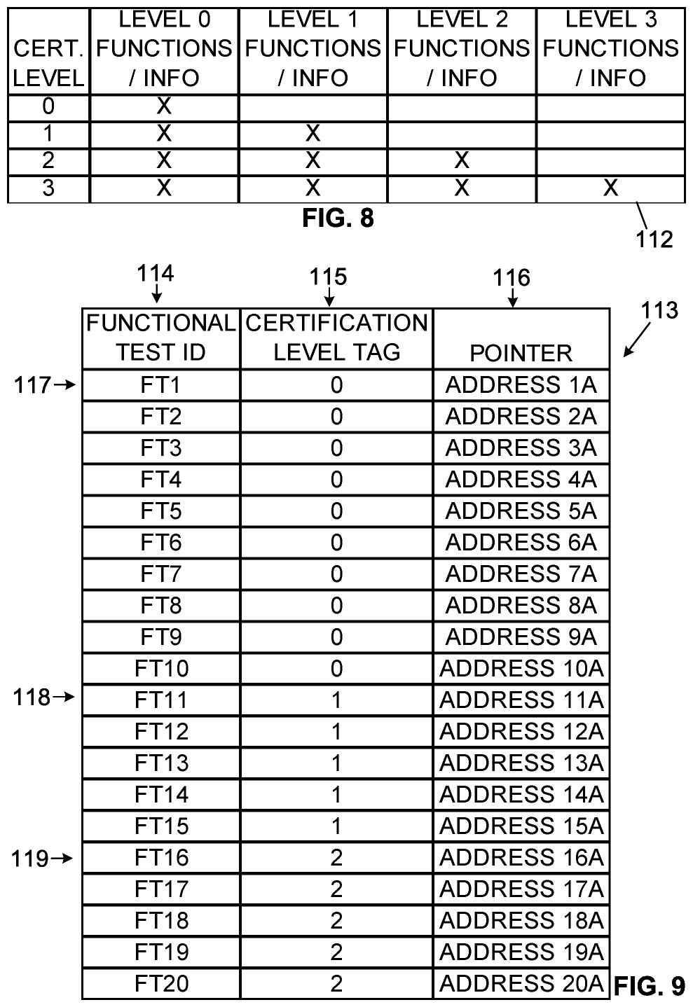

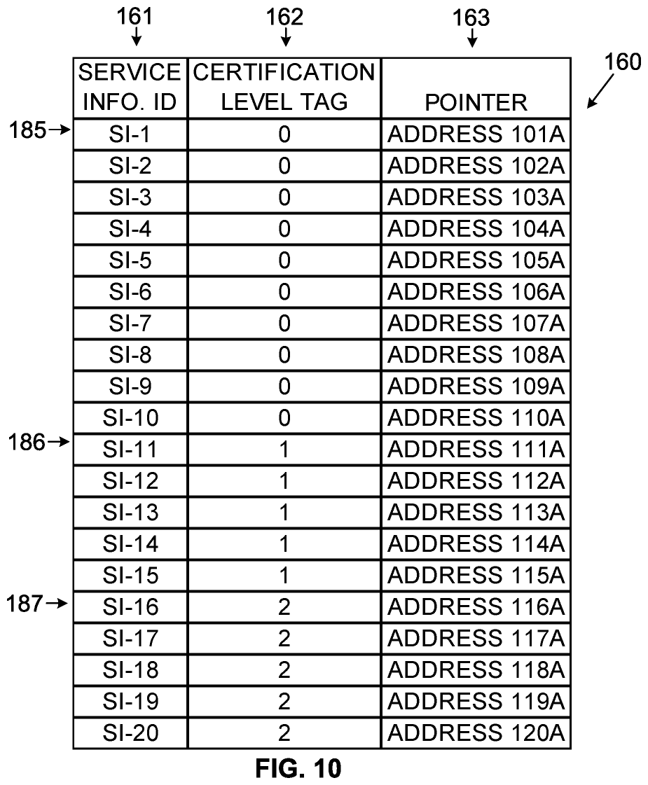

The mapping data 109 can include mapping data that maps a variety of data to each other. As an example, the mapping data 109 can include mapping data 112, 113, 160, 164 shown in FIG. 8, 9, 10, 11, respectively.

The mapping data 112 shown in FIG. 8 includes data to indicate which function levels or information correspond to different certification levels. The levels are identified as level 0, level 1, level 2, and level 3. In at least some embodiments, the level 1, 2, and 3 functions/information can include certified user functions/information, and the level 0 functions can include uncertified user functions/information. The VST 70 can be configured so that a certification credential is not required for a user to access the level 0 functions or information. The Xs in FIG. 8 are used to indicate whether the particular level functions or information is included with the different certification levels. Accordingly, the certification level 1 includes and/or provides access to both the level 0 and level 1 functions/information. The certification level 2 includes and/or provides access to the level 0, level 1, and level 2 functions/information. The certification level 3 includes and/or provides access to the level 0, level 1, level 2, and level 3 functions/information.

The mapping data 113 shown in FIG. 9 includes functional test identifiers 114, certification level tags 115 corresponding to the functional test identifiers 114, and pointers 116 corresponding to the functional test identifiers 114. The certification level tags of 0, 1, and 2 in FIG. 9 can be the same as certification levels 0, 1, and 2 in FIG. 8. The mapping data 113 can include functional test identifiers and pointers that correspond to a certification level tag 3, which can corresponding to the certification level 3 in FIG. 8. The pointers 116 can include addresses, such as memory addresses. As an example, the memory addresses can point to commands in the functional test command 103. For example, a row 117 shows that a function test FT1, a certification level tag 0, and a pointer of address 1A are mapped together. As another example, a row 118 shows that a function test FT11, a certification level tag 1, and a pointer of address 11A are mapped together. As another example, a row 119 shows that a function test FT16, a certification level tag 2, and a pointer of address 16A are mapped together.

In at least some embodiments, at least a portion of the mapping data 113 is contained within a GUI file (e.g., a GUI file contained in the GUI 97). As an example, the GUI file can include data to show a USC when the GUI is output on the display 81, a functional test identifier corresponding to the USC, a certification level tag corresponding to the USC, and a pointer to a functional test command 103. In at least some embodiments, a GUI file includes data for outputting the USC on the display 81 and the processor 71 refers to the mapping data 113 to determine a certification level tag and/or pointer corresponding to the USC and its associated functional test.

The mapping data 160 shown in FIG. 10 includes service information identifiers 161, certification level tags 162 corresponding to the service information identifiers 161, and pointers 163 corresponding to the service information identifiers 161. The certification level tags of 0, 1, and 2 in FIG. 10 can be the same as certification levels 0, 1, and 2 in FIG. 8 and FIG. 9. The mapping data 160 can include service information identifiers and pointers that correspond to a certification level tag 3, which can corresponding to the certification level 3 in FIG. 8 and FIG. 9. The pointers 163 can include addresses, such as memory addresses. As an example, the memory addresses can point to service information in the service information 150. For example, a row 185 shows that service information SI-1, a certification level tag 0, and a pointer of address 101A are mapped together. As another example, a row 186 shows that service information SI-11, a certification level tag 1, and a pointer of address 111A are mapped together. As another example, a row 187 shows that service information SI-16, a certification level tag 2, and a pointer of address 116A are mapped together.

In at least some embodiments, at least a portion of the mapping data 160 is contained within a GUI file (e.g., a GUI file contained in the GUI 97). As an example, the GUI file can include data to show a USC when the GUI is output on the display 81, a service information identifier corresponding to the USC, a certification level tag corresponding to the USC, and a pointer to service information within the service information 150. In at least some embodiments, a GUI file includes data for outputting the USC on the display 81 and the processor 71 refers to the mapping data 160 to determine a certification level tag and/or pointer corresponding to the USC and its associated service information.

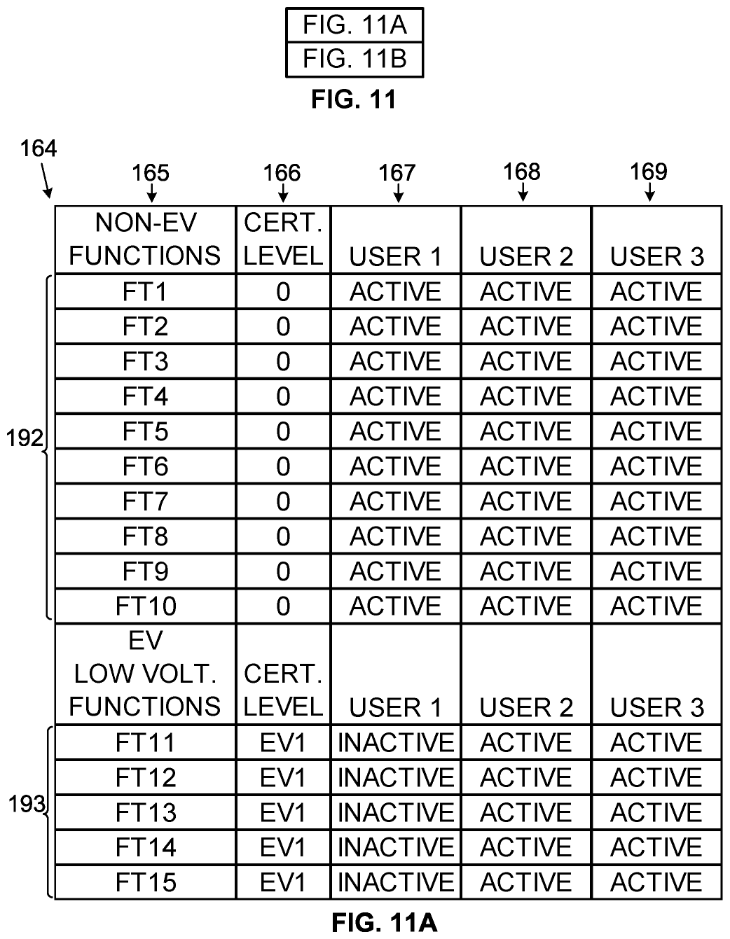

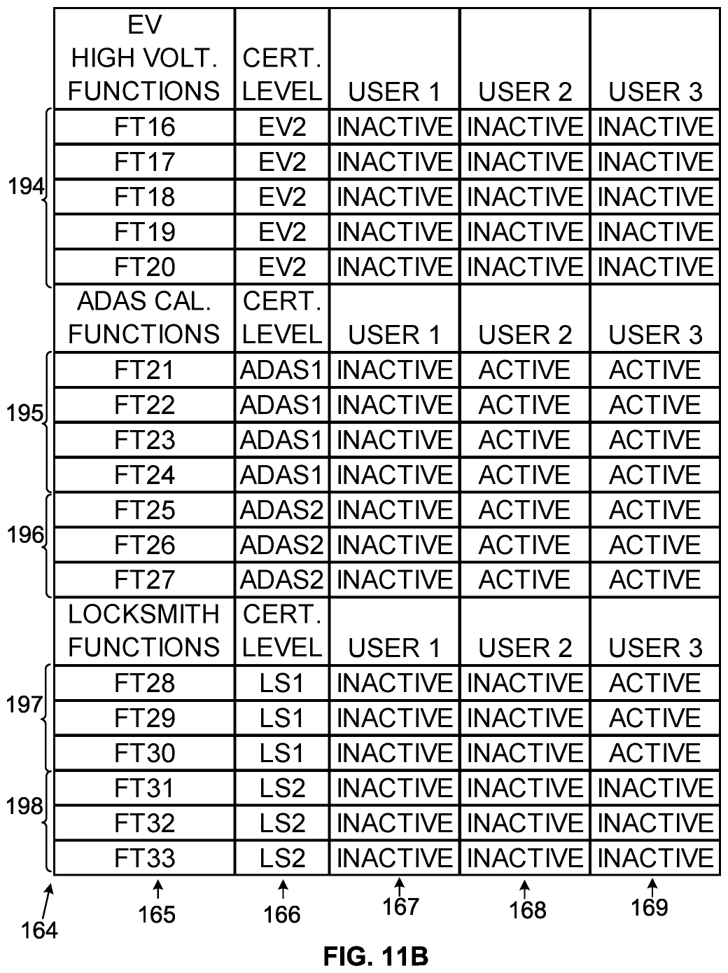

The mapping data 164 shown in FIG. 11, which includes FIG. 11A and FIG. 11Bn, includes functional test identifiers 165, certification levels 166 corresponding to the functional test identifiers 165, and status information 167, 168, 169 for three different users. The status information 167, 168, 169 also corresponds to the functional test identifier 165 and the certification levels 166. The status information 167, 168, 169 indicates “active” if the corresponding user has access to the corresponding functional test or “inactive” if the corresponding user does not have access to the corresponding functional test. The “active” indicator could include and/or referred to as a “linked” indicator. Likewise, the “inactive” indicator could include and/or referred to as a “not linked” indicator. The certification levels 166 include numbers. In at least some embodiments, the certification levels increase in access to functional tests as the number in the certification level 166 increases relative to other certification levels. The certification levels 166 can include and/or be referred to as certification level tags. “EV” within the certification level tags stands for “electric vehicle.” “ADAS” within the certification level tags stands for “advanced driver assistance system.” “LS” within the certification level tags stands for “locksmith.”

The mapping data 164 includes mapping data 192 for a set of functional tests corresponding to a certification level and/or certification level tag “0.” The mapping data 164 includes mapping data 193 for a set of functional tests corresponding to a certification level and/or certification level tag “EV1.” The mapping data 164 includes mapping data 194 for a set of functional tests corresponding to a certification level and/or certification level tag “EV2.” The mapping data 164 includes mapping data 195 for a set of functional tests corresponding to a certification level and/or certification level tag “ADAS1.” The mapping data 164 includes mapping data 196 for a set of functional tests corresponding to a certification level and/or certification level tag “ADAS2.” As an example, the ADAS1 certification level tag can be associated with an ADAS system/component that can be calibrated dynamically by technicians and the ADAS2 certification level tag can be associated with an ADAS system/component that can be calibrated statically by technicians. As an example, the dynamic calibration can occur by driving the vehicle with the ADAS system/component, and the static calibration can occur while the vehicle is parked in a repair shop and via the use of one or more calibration targets. The mapping data 164 includes mapping data 197 for a set of functional tests corresponding to a certification level and/or certification level tag “LS1.” The mapping data 164 includes mapping data 198 for a set of functional tests corresponding to a certification level and/or certification level tag “LS2.”

Although the mapping data 164 refers to two certification levels for electric vehicle functions, two certification levels for ADAS calibration functions, and two certification levels for locksmith functions, one or more those examples can include only a single certification level or more than two certification levels. In at least some implementations, the locksmith functions can include a certification credential for performing certified user functions for access components of an immobilizer system or component configured to prevent a vehicle from starting unless another access component is installed in or is located in proximity to another access component. In at least some implementations, the locksmith functions can include a certification credential for performing certified user functions for access components that permit or prevent entry into a vehicle. For example, the ADAS calibration functions may include a single certification level. As another example, the ADAS calibration functions may include two or more certification levels.

Turning back to FIG. 5, the service information 150 can include service information for populating into a GUI. The service information can correspond to particular vehicles and particular vehicle components and systems. The service information can correspond to particular tests or reset procedures. As an example, the service information 150 can include instructions, specifications, images, videos, component location information, schematic diagrams, or some other type of service information listed in this description or otherwise.

The performance data 152 can include data regarding a performance of a certified user function (i.e., one or more performances of one or more certified user functions) at the VST 70. Table B shows example performance data that can be stored in the performance data 152. As shown in Table B, the performance data 152 can include vehicle identifiers, system or component identifiers, user identifiers, certified user function identifiers, time stamps, VDM identifiers, and status identifiers. The vehicle identifiers V1 to V6 represent a vehicle identifier, such as a VIN, or a group of vehicle characteristic identifier such as a YMM or a YMME. The system or component identifiers C1 to C5 represent a system or component in the vehicle 14, 32, 50. The user identifiers U1 and U2 represent identifiers of technicians that use the VST 70. As an example, a user identifier can include a profile access code and/or a technician's name (e.g., Hans Smith as shown in FIG. 20). The certified user function identifiers F1 to F7 represent certified user functions, such as certified user functions corresponding to USCs (e.g., FT28 to FT33 shown within USC 284 to USC 289 in FIG. 28) or tests corresponding to USCs (e.g., Test 1 to Test 10 shown within USC 321 to 330 in FIG. 29). The time stamps TS1 to TS10 can include data regarding a date and time of day corresponding to performance of a certified user function. As an example, the times stamps T1 to T2 can indicate a time range corresponding to performance of a certified user function. The VDM identifiers VDM1 to VDM7 can include identifiers of one or more VDM sent to a vehicle during performance of a certified user function and/or one or more VDM received from the vehicle during performance of the certified user function. As an example, a VDM stored in the performance data 152 can include a VDM that indicates a calibration value programmed into an ECU in the vehicle. The status identifiers corresponding to performance of a certified user function. As an example, a status identifier can indicate whether performance of the certified user function was successful (e.g., passed) or unsuccessful (e.g., failed) or no status identifier (e.g., null).

TABLE B

| Vehicle | Sys/ | User | Cert. | Time | VDM | Status |
|---|---|---|---|---|---|---|
| ID | Comp. ID | ID | Fun. ID | Stamp | ID | ID |
| V1 | C1 | U1 | F1 | TS1-TS2 | VDM1 | Passed |
| V1 | C1 | U1 | F2 | TS3 | VDM2 | Passed |
| V2 | C2 | U1 | F3 | TS4 | VDM3 | Failed |
| V2 | C2 | U1 | F3 | TS5 | VDM3 | Passed |
| V3 | C3 | U1 | F4 | TS6-TS7 | VDM4 | Null |
| V4 | C4 | U1 | F5 | TS8 | VDM5 | Passed |
| V5 | C4 | U2 | F6 | TS9 | VDM6 | Null |
| V5 | C5 | U2 | F7 | TS10 | VDM7 | Failed |
| V6 | C5 | U2 | F7 | TS10 | VDM7 | Passed |

In at least some implementations, the performance data 152 can include one or more images captured during performance of the certified user function.

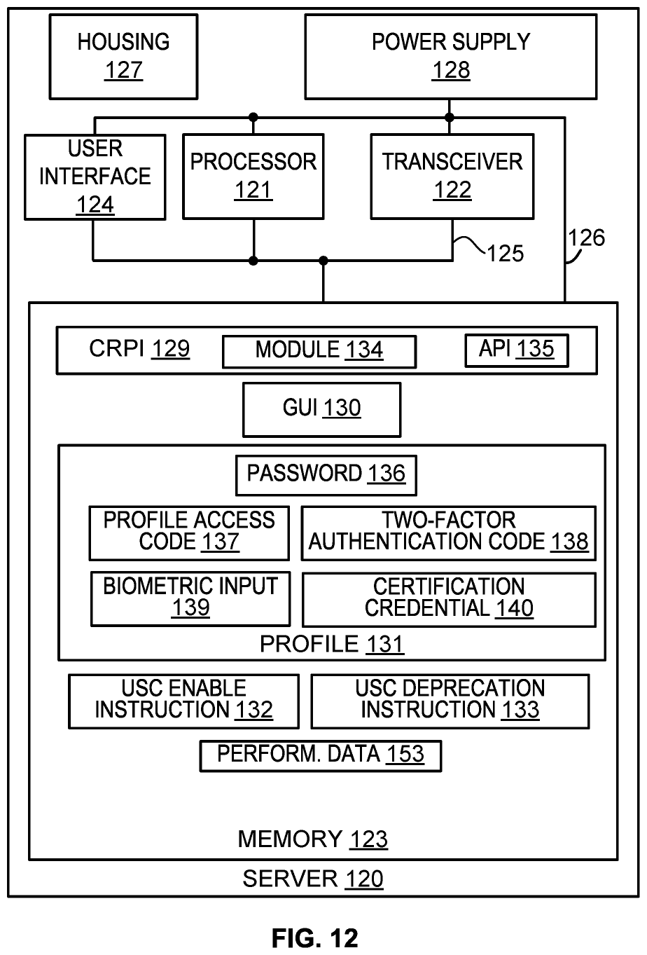

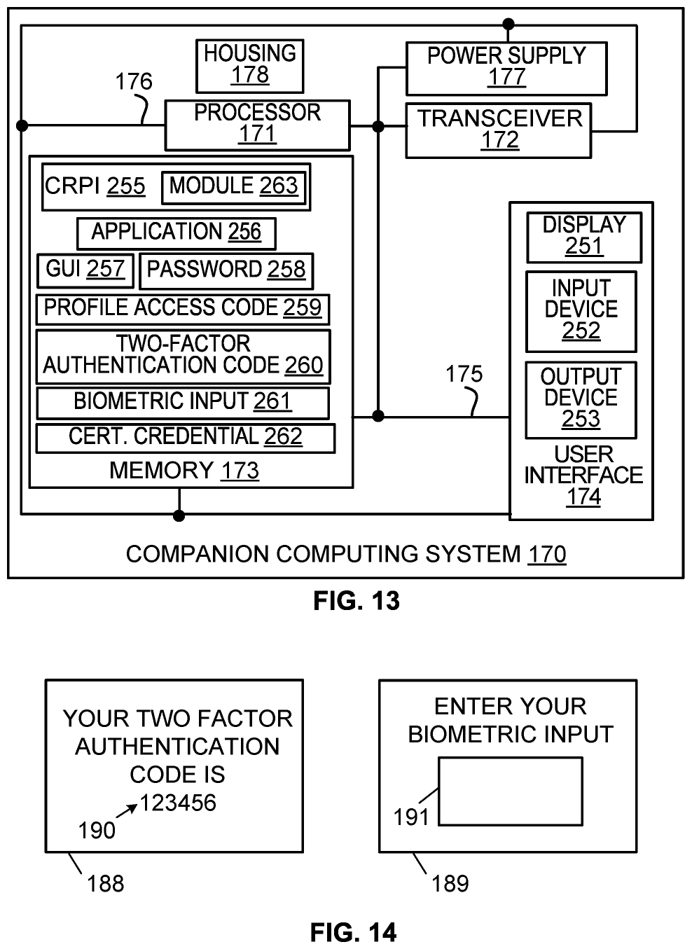

Next FIG. 6, which includes FIG. 6A and FIG. 6B, shows a set 500 of modules. The module 96 in FIG. 5, the module 134 shown in FIG. 12, and/or the module 263 shown in FIG. 13 can include one or more modules of the set 500 of modules.

a. Determine Corresponding User Function Module

The determine corresponding user function module 501 can be configured to determine a user interface selected to be used at a computing system includes a USC corresponding to a certified user function. The computing system includes program instructions executable to perform the certified user function. In at least some embodiments, the user interface includes a hardware user interface, such as a hardware button 68, 69 shown in FIG. 7.

In at least some embodiments, determining the user interface selected to be used at the computing system includes the USC corresponding to the certified user function comprises determining a list of functions corresponding to the GUI (which can be carried out via execution of the determine list of functions module 508 discussed below), and determining the list of functions includes an identifier of the certified user function and a first tag that indicates the certification credential for the certified user function (which can be carried out via execution of the determine inclusion of ID and tag module 509 discussed below).

In at least some embodiments, determining the user interface selected to be used at the computing system includes the USC corresponding to the certified user function comprises the processor reading the GUI file used to generate the GUI and/or metadata corresponding to the GUI file to determine whether the GUI file includes any tag that indicates a test or function corresponding to a USC within the GUI has a certification credential requirement. As an example, the GUI file can include the tag within or in proximity to particular characters that indicate the content within or adjacent the particular characters is a tag.

In at least some implementations, the particular characters includes a set of brackets, such as square brackets (i.e., [ ]). For example, a tag for an ADAS system/component that can be calibrated dynamically by technicians with a particular credential certificate can be represented as [AD], and a tag for an ADAS system/component that can be calibrated statically by technicians with the particular credential certificate can be represented as [AS]. In at least some embodiments, dynamic calibration of an ADAS system can be performed, in part, by driving the vehicle including the ADAS system. The VST can include a USC corresponding to the dynamic calibration, such as a USC selectable to reveal driving instructions for the dynamic calibration. In accordance with at least some of those embodiments, a low-level credential certificate (e.g., level 0) can be associated with the USC corresponding to the dynamic calibration. Alternatively, no credential certificate may be associated with the USC corresponding to the dynamic calibration. In that regard, the VST provides “open access” to the USC corresponding to the dynamic calibration.

Additionally, in at least some embodiments, static calibration of an ADAS system is performed using the VST and/or one or more calibration targets that require setup for the particular vehicle and calibration location (e.g., in a particular stall in a repair shop). In accordance with at least some of these embodiments, a credential certificate corresponding to a certified user function to perform the static calibration and/or USC corresponding to that function can be associated with a level greater than the level corresponding to the functions and/or information corresponding to the dynamic calibration.

As another example, a tag for an immobilizer system/component that can be serviced by technicians with a particular credential certificate can be represented as [LS1] or [LS2], and a tag for an immobilizer system/component that can be serviced by technicians without the particular credential certificate can be represented as [LS0]. In at least some embodiments, the GUI file including an identifier of a USC and a corresponding tag can include a mark-up language file, such as an HTML or extensible mark-up language (XML) file, or a JavaScript Object Notation (JSON) file.

In accordance with at least some embodiments, the certified user function includes one or more of the following functions: performing a test of a high voltage system or component in a vehicle-under-service, performing a test of an advance driver assistance system or component in the vehicle-under-service, programming an electronic control unit in the vehicle-under-service, calibrating an electronic control unit in the vehicle-under-service, programming a key or key fob for locking and unlocking a lock in the vehicle-under-service or for starting the vehicle-under-service, programming or servicing an immobilizer system or component, or performing a subscription-based user function.

In accordance with at least some embodiments, the certified user function includes a function to perform a functional or component test of a component in a vehicle under service. The component is configured to control connecting an electrical circuit to a high voltage component, disconnecting an electrical circuit from the high voltage component, sending an electrical signal to the high voltage component, or receiving an electrical signal from the high voltage component. As an example, the vehicle-under-service can include an electric vehicle, an internal combustion engine vehicle, or a hybrid vehicle. As another example, performing the certified user function can include the processor and/or VCT 91 transmitting a VDM to the vehicle to control the component.

In accordance with at least some embodiments, the certified user function includes a function to perform a functional or component test of one or more of the following: a battery pack and battery management system, an electric motor, a motor control unit, a power distribution unit, an electrical power converter, an on-board charger, an electric air conditioning compressor, a high voltage heater, or a high voltage cable.

In accordance with at least some embodiments, the certified user function includes performing a guided component test using the test device 75. In those embodiments, the computing system can include a test device having a meter or an oscilloscope. The user interface can include a GUI configured to display guidance for performing the guided component test. In accordance with at least some of these embodiments, the USC includes a first USC, and determining that the user interface includes the USC corresponding to the certified user function includes determining the first USC or a second USC is used to select a parameter setting above a threshold parameter setting. As an example, the parameter setting includes an electrical parameter setting and the threshold parameter setting includes a threshold electrical parameter setting, the parameter setting includes a temperature parameter setting and the threshold parameter setting includes a threshold temperature parameter setting, or the parameter setting includes a pressure parameter setting and the threshold parameter setting includes a threshold pressure parameter setting.

In at least some embodiments, determining that the user interface is selected to be used at the computing system includes the USC corresponding to the certified user function comprises the processor executing a state machine having a particular state based on the vehicle selection and the system or component selection and determining the state includes a conditional node corresponding to a USC and/or a certified user function. In at least some embodiments, the state machine enters the particular state in response to determining the GUI including the USC has been selected for display. In at least some embodiments, the state machine enters the particular state in response to determining the USC has been selected from the GUI.

In at least some embodiments, the computing system includes a test device including a meter or an oscilloscope and the test device includes an electrical connector. In those embodiments, determining the user interface selected to be used at the computing system includes the USC corresponding to the certified user function can comprise determining an electrical probe configured for measuring an electrical parameter above a threshold electrical parameter setting is connected to the electrical connector. As an example, the electrical probe can comprise a high-voltage probe or a high-current probe.

In at least some embodiments, determining that the user interface is selected to be used at the computing system includes the USC corresponding to the certified user function is based on a particular instance of selecting the GUI. In that regard, a GUI configured for inputting the certification credential into the processor (e.g., the GUI 241 shown in FIG. 21) is displayed before the particular instance of selecting the GUI.

b. Determine Corresponding Certification Credential Module

The determine corresponding certification credential module 502 can be configured to determine whether a user identifier, received at the computing system, corresponds to a certification credential for the certified user function. The user identifier can correspond to zero or one or more certification credentials. A certification credential can be associated with one or more certified user functions. In at least some embodiments, the certified user functions associated with the certification credential can include certified user functions corresponding to a single vehicle system or component (e.g., an immobilizer system or component). In at least some embodiments, the certified user functions associated with the certification credential can include certified user functions corresponding to multiple vehicle systems or components (e.g., an A/C motor and an D/C to A/C inverter). In at least some embodiments, the certified user functions associated with the certification credential can include certified user functions corresponding to a particular vehicle OEM.

In accordance with at least some embodiments, determining whether the user identifier corresponds to the certification credential for the certified user function includes the processor checking a database contained in a memory operatively connected to the processor for data that indicates whether the user identifier corresponds to the certification credential for the certified user function. As an example, the database can comprise at least a portion of the mapping data 109 shown in FIG. 5 and/or the profile 131 shown in FIG. 12.

In accordance with at least some embodiments, determining whether the user identifier corresponds to the certification credential for the certified user function includes transmitting a request to check the certification credential for the certified user function. The request can include the user identifier, a password, a profile access code, a two-factor authentication code, a system identifier, a component identifier, a vehicle identifier, and/or a certification credential tag. Additionally, for these embodiment determining whether the user identifier corresponds to the certification credential for the certified user function includes receiving a response to the request. The response includes data indicating whether the user identifier corresponds to the certification credential for the certified user function. The response can indicate a certification level, such as level 0, 1, 2, or 3.

In accordance with at least some embodiments, the determine corresponding certification credential module 502 can be configured to compare a first temporal indicator to a second temporal indicator to determine whether the certification credential for the certified user function has expired. As an example, the first temporal indicator can be a date (or a date and time) associated with a certification credential for a particular user, and second temporal indicator can be a date, such as a current calendar date (or the current calendar date and a current time).

c. Configure USC Module

The configure USC module 503 can be configured to configure the USC based on whether the user identifier corresponds to the certification credential for the certified user function. Configuring the USC can include enabling the USC if the user identifier corresponds to the certification credential, or deprecating the USC if the user identifier does not correspond to the certification credential. Enabling the USC configures the USC to be usable to trigger execution of the program instructions to perform the certified user function. Deprecating the USC configures the USC to be unusable to trigger execution of the program instructions to perform the certified user function. As an example, the deprecated USC can include the USC 326, 327, 328, 329, 330 shown in FIG. 29.

In at least some embodiments, configuring the USC occurs after determining the user interface is selected to be used at the computing system, but before a selection of the USC occurs after determining the user interface is selected to be used at the computing system. For example, the USC can be configured before the user interface is displayed on the display screen. In at least some embodiments, configuring the USC occurs after determining the user interface is selected to be used at the computing system, and after a selection of the USC occurs after determining the user interface is selected to be used at the computing system. For example, the USC can be configured while the user interface is displayed on the display screen.

In at least some embodiments, the user interface includes multiple USCs corresponding to multiple certified user functions, and the computing system (e.g., the VST 13, 70) includes program instructions executable to perform the multiple certified user functions. Accordingly, configuring the USC based on whether the user identifier corresponds to the certification credential for the certified user function can include configuring the multiple USCs. As an example, the configure USC module 503 can be configured to enable the multiple USCs if the user identifier corresponds to the certification credential, or deprecate the multiple USCs if the user identifier does not correspond to the certification credential. In those regards, enabling the USCs configures the multiple USCs to be usable to trigger execution of the program instructions to perform the multiple certified user functions, and deprecating the multiple USCs configures the multiple USCs to be unusable to trigger execution of the program instructions to perform the multiple certified user functions. In at least some embodiments, the user interface with multiple USCs can include one or more USCs that are not associated with a certified user function. Moreover, in at least some embodiments, configuring the multiple USCs can include enabling some of the USCs and deprecating some of the USCs, such as shown in FIG. 28 to FIG. 30.

In at least some embodiments, the configure USC module 503 is configured to configure a USC based on a certification credential level, such as a certification credential level determined by the credential level module 525 discussed below. As an example, the configure USC module 503 can configure a USC based on whether the user identifier corresponds to a first level certification credential or a second level certification credential. Configuring the second USC can include enabling the USC if the user identifier corresponds to the first level certification credential or the second level certification credential, or deprecating the USC if the user identifier does not correspond to the first level certification credential or the second level certification credential.

In at least some embodiments, the configure USC module 503 is configured to determine whether a certification credential for a certified user function corresponding to a USC is expired. As an example, the certification credential can expire on a particular date (e.g., a date two years after the certification credential was obtained/earned. The processor can compare that particular date to the date the processor is using the configure USC module 503 to configure the USC. In response to determining the certification credential is expired, the processor can output on a display a notification indicating the certification credential for the certified user function has expired. In response to determining the certification credential is not expired, the processor can output on a display a notification indicating the certification credential for the certified user function is not expired and/or that the certification credential is set to expire within a threshold amount of time.

d. Output GUI Module

The output GUI module 504 can be configured to output, on the display, the GUI with the configured USC. At the VST 70, the processor 71 can output the GUI to the display 81. At the server 120, the processor 121 can output the GUI to a display at the user interface 124. At the companion computing system 170, the processor 171 can output the GUI to the display 251. The GUI selected to be output on a display of the computing system (e.g., the VST 70, the server 120, or the companion computing system 170) can be included within the user interface selected to be used at a computing system. In at least some embodiments, the GUI with the configured USC is output during a first use of a computing system and the GUI with the deprecated USC is output during a second use of the computing system. As an example, the first use of the computing system can include a use when the user's certification credential is not expired, and the second use of the computing system can include a use when the user's certification credential is expired.

In at least some embodiments, the GUI includes an additional USC. The additional USC can correspond to a non-certified user function. Performance of the non-certified user function via use of the additional USC is not conditioned on an existence of any certification credential. In at least some embodiments, the GUI includes a web-based GUI.

In at least some embodiments, the GUI with the configured USC is a first GUI. The output GUI module 504 can be configured to output an alternative GUI on the display. As an example, the alternative GUI can be configured for inputting a certification credential into the processor. In that regard, the alternative GUI can be displayed before the particular instance of selecting the first user interface. As another example, the alternative GUI can include a GUI for accessing an application programming interface at a remote computing device to obtain the certification credential. As yet another example, the alternative GUI can include a GUI for selecting a vehicle system or component of the vehicle-under-service. As still yet another example, the alternative GUI can include a field for entering or a second USC to request data that the processor uses to determine the certification credential for the certified user function. In that regard, the output GUI module 504 can be configured to output the alternative GUI in response to the selection of the vehicle system or component of the vehicle-under-service and prior to outputting the first GUI. In at least some embodiments, the alternative GUI is displayed before the first GUI. In at least some other embodiments, the first GUI is displayed before the alternative GUI.

In at least some embodiments, a GUI output by the output GUI module 504 can include a notification regarding a certification credential. For example, the processor can output, on a display, a notification indicating the certification credential for the certified user function has expired if the processor determines the certification credential for the certified user function has expired. As another example, the processor can output, on the display, a notification indicating the certification credential for the certified user function is set to expire within a threshold amount of time if the processor determines the certification credential for the certified user function is not expired and a current time is within the threshold amount of time.

In at least some embodiments, a GUI output via the output GUI module 504 includes a USC to authorize or decline storing performance data regarding performance of a certified user function. That GUI can include a message prompting a user to use the USC to authorize or decline storing performance. Selection of the USC in that GUI can cause the processor to receive data indicative of a user selecting an approval for storing data regarding the performance of the certified user function. In at least some embodiments, receiving the data indicative of the user selecting the approval occurs while generating or modifying a user profile for a user of the computing system. In at least some embodiments, receiving the data indicative of the user selecting the approval occurs after the performance of the certified user function. Selection of the USC in that GUI can trigger to configure the VST 70 or the server 120 for storing the performance data.

e. Determine Vehicle ID Module

The determine vehicle ID module 505 can be configured to determine a vehicle identifier of a vehicle-under-service, such as the vehicle 14, 32, 50 or some other vehicle. As an example, execution of the determine vehicle ID module 505 can include transmitting a VDM to the vehicle-under-service to request vehicle identification information (e.g., a vehicle identifier number), receiving a VDM including the vehicle identification information, and determining the vehicle identifier from the vehicle identification information. As another example, execution of the determine vehicle ID module 505 can include determining the vehicle identifier based on vehicle characteristics selected via a GUI (e.g., the GUI 699 shown in FIG. 17) on the display 81. The processor can determine the vehicle identifier based on the selected characteristics (e.g., model year, model, and make) and the vehicle selection data 99.

f. Determine System or Component Selection Module

The determine system or component selection module 506 can be configured to determine a system or component selection corresponding to the vehicle selection. As example, the processor 71 executing the determine system or component selection module 506 can determine a system or component based on a selection entered via a GUI, such as the GUI 730 shown in FIG. 18 and/or determine the vehicle selection based on a selection entered via a GUI, such as the GUI 699 shown in FIG. 17. In at least some implementations, determining the selected component or system can include determining a tag associated with the selected component or system. As an example, the mapping data 109 can include mapping data that maps a system identifier to a tag associated with the system identifier and/or a component identifier to a tag associated with the component identifier.

g. Determine Component ID Module

The determine component ID module 507 can be configured to determine an identifier of a component on the vehicle. In at least some implementations, the processor determines the component identifier based on data contained in a VDM received from a vehicle operatively connected to the VST 13, 70. In at least some implementations, the processor 71 extracts a numeric identifier from the VDM and compares the numeric identifier to the vehicle data message 100 to determine that the number identifier corresponds to a particular component identifier. In at least some implementations, the processor determines the component identifier based on a selection from a GUI, such as a selection of a component selector in a GUI, such as the component selector 734 shown in FIG. 18. As an example, the component ID can include a hexadecimal number assigned by an OEM.

h. Determine List of Functions Module

The determine list of functions module 508 can be configured to determine a list of functions corresponding to the GUI. In accordance with at least some embodiments, determining the list of functions includes determining each function in the list of functions corresponds to a particular vehicle identifier and to a second tag indicative of a particular system or component on a vehicle associated with the particular vehicle identifier. As an example, determining the list of functions can include reading a GUI file used to generate the GUI and/or metadata corresponding to the GUI file. As another example, the mapping data 109 can include data that maps a list of functions associated with each GUI and the processor can determine the list of functions from the mapping data 109.

In accordance with at least some embodiments, determining the list of functions includes determining the list of functions corresponds to the identifier of the component (e.g., the component identifier) on the vehicle.

i. Determine Inclusion of ID and Tag Module

The determine inclusion of ID and tag module 509 can be configured to determine the list of functions includes an identifier of the certified user function and a first tag that indicates the certification credential for the certified user function. As an example, a processor can read the list of functions and determine whether the list of functions includes a tag within particular characters (e.g., the square brackets (i.e., [ ])).

j. Receive a Mark-Up Language File Module

The receive a mark-up language file module 510 can be configured to receive a mark-up language file that defines the GUI and that includes a definition of the USC. As an example, the processor can receive a mark-up language file (e.g., an HTML or XML file) the server 120 transmits to the VST 70 via the communication network 11. After receiving the file, the processor can store the mark-up language file in the memory 123. After receiving the file, the processor can read the mark-up language file and output aspects of the mark-up language file on a display.

k. Determine USC Definition Module

The determine USC definition module 511 can be configured to determine the definition of the USC includes a tag that indicates the certification credential for the certified user function. Execution of the determine USC definition module 511 can cause the processor to determine the definition of the USC includes the tag by reading the mark-up language file that defines the GUI. As another example, execution of the determine USC definition module 511 can cause the processor to determine the definition of the USC based on the mapping data 109, such as mapping data that maps an identifier of the USC to a tag, or a certification credential for a certified user function.

l. Memory Writing Module

The memory writing module 512 can be configured to write data into a memory (e.g., the processor 71 can write data into the memory 73). For example, the data written into a memory can include data that indicates the certification credential corresponds to the user identifier. As another example, the processor 71 can send the data to the memory 73 over the data bus 79. In at least some implementations, the processor 71 executes the memory writing module 512 in response to the certification credential being input via a GUI, such as the second GUI discussed with respect to the output GUI module 504. Moreover, the processor 71 can transmit the data that indicates the certification credential and the user identifier to the server 120 (e.g., using the transmit to server module 528) so that the server 120 can write the data that indicates the certification credential and the user identifier into the profile 131.

Within the server 120, the memory writing module 512 is executable for the processor 121 to write data into the memory 123. Similarly, within the companion computing system 170, the memory writing module 512 is executable for the processor 171 to write data into the memory 173.

In at least some implementations, execution of the memory writing module 512 includes storing performance data regarding a performance of the certified user function (e.g., writing performance data obtained via execution of the receive response module 529 into a memory).

m. API Access Module

The API access module 513 can be configured to access, via use of a GUI (e.g., a second GUI), an application programming interface at a remote computing device to obtain the certification credential. The certification credential can be input into the processor in response to receiving the certification credential from the remote computing device. As an example, the API can be stored at the server 15, 120 and can be accessed via use of the a GUI, such as the GUI 241 shown in FIG. 20. As an example, the API can include the GUI 300 shown in FIG. 25 or the GUI 270 shown in FIG. 26.

n. Receiving Request Module

The receiving request module 514 can be configured to receive a request to output a GUI on the display during a use of the computing system (e.g., the VST 13, 70 or the companion computing system 170). The request can be received while a certified user or an uncertified user is using the computing system. The certification of the user can be conditioned on what USC is available on the GUI and whether the USC on the GUI is associated with a certified user function.

The receiving request module 514 can be configured to receive a request to output a report regarding performance of a certified user function.

o. Deprecating USC Module

The deprecating USC module 515 can be configured to deprecate a USC. In at least some embodiments, deprecating the USC is based on a request to output a GUI on a display during a use of the computing system. In at least some embodiments, deprecating the USC includes configuring a state machine executed by the processor to be a state machine in which the processor ignores or disables an input corresponding to selection of the USC. In at least some embodiments, deprecating the USC occurs after the USC is selected. In at least some embodiments, deprecating the USC includes displaying a lock icon to indicate that the USC is locked from use. In at least some embodiments, a processor (e.g., the processor 71) is restricted from outputting the service information corresponding to the certified user function while the USC is deprecated. As an example, deprecating the USC can include setting a flag associated with the USC to a value that indicates the USC is deprecated. The processor can refer to the flag when determining whether to disable the input corresponding to a selection of the USC.

p. Vehicle Selection Module

The vehicle selection module 516 can be configured to determine a vehicle selection. In at least some embodiments, the determination of the vehicle selection is based on vehicle identifying information (e.g., a VIN) received from the vehicle 14. In at least some embodiments, the determination of the vehicle selection is based on vehicle characteristics entered via use of a GUI, such as the GUI 699 shown in FIG. 17. In accordance with those or other embodiments, the determination of the vehicle selection can be based on scanning a code encoded with vehicle identifying information.

q. GUI Association Module

The GUI association module 517 can be configured to determine the GUI corresponds to the vehicle selection and the system or component selection. In at least some embodiments, a processor executing the GUI association module 517 can refer to a data map within the GUI 97, 130 to determine whether the GUI corresponds to the vehicle selection and the system or component selection.

r. Metadata Inclusion Module

The metadata inclusion module 518 can be configured to determine the GUI or a database includes metadata indicating whether the certified user function corresponds to the certification credential. Execution of the metadata inclusion module 518 can include the processor reading the GUI and/or searching the database. In at least some embodiments, the metadata can include a tag as described elsewhere in this description. In at least some embodiments, the database can include the mapping data 109.

s. Signal Reception Module

The signal reception module 519 can be configured to determine an electronic signal received at the processor, while the USC is enabled, indicates a selection of the USC occurred. In at least some embodiments, the selection of the USC includes a receiving a selection of a hardware USC and the electronic signal can be received via an electrical circuit connected to the hardware USC. In at least some embodiments, the selection of the USC includes a receiving a selection of a USC output on a touch screen display and the electronic signal can be received via the touch screen display.

t. Transmit to Vehicle Module

The transmit to vehicle module 520 can be configured to transmit a communication to a vehicle (e.g., the vehicle 14, 32, 50). As an example, the VCT 91 can transmit the communication using the arrangement 20, 21, 22 shown in FIG. 2. In at least some implementations, execution of the transmit to vehicle module 520 includes transmitting (to a vehicle in response to the selection of the USC) a vehicle data message requesting initiation or performance of the certified user function. In at least some implementations, execution of the transmit to vehicle module 520 includes transmitting (to a vehicle-under-service communicatively connected to the computing system) a vehicle data message for requesting the vehicle-under-service to perform or initiate performing the certified user function.

u. Determine Password Module

The determine password module 521 can be configured to determine a password received at the processor corresponds to the user identifier. In at least some embodiments, a processor 71, 121 can receive a password and compare the received password to the password 105, 136. As an example, the processor can receive the password via use of the GUI 241 shown in FIG. 21.

v. Determine Profile Access Code Module

The determine profile access code module 522 can be configured to determine a profile access code received at the processor corresponds to the user identifier. In at least some embodiments, a processor 71, 121 can receive a profile access code and compare the received profile access code to the profile access code 107, 137. As an example, the processor can receive the profile access code via use of the GUI 292 shown in FIG. 31.

w. Determine Two Factor Authentication Module

The determine two factor authentication module 523 can be configured to determine a two-factor authentication was performed via a companion device corresponding to the user identifier. In at least some embodiments, a processor 71, 121, 171 can receive a two-factor authentication code and transmit the two-factor authentication code to the server. In at least some embodiments, the processor 71, 121, 171 receives the two-factor authentication code via a short-message system (SMS) message or via an application executing on the VST 70, the server 120, or the companion computing system 170.

FIG. 14 shows a screen display 188 that can be output on a display (e.g., the display 81, 251). The screen display 188 includes a two-factor authentication code 190. In at least some embodiments, the two-factor authentication code 190 can be stored as the two-factor authentication code 106 and then uploaded to a GUI and/or a server requiring a two-factor authentication code to authenticate a user. For example, the two-factor authentication code 106 or the two-factor authentication code 190 can be populated (automatically by the processor 71 or manually) into a field 245 within the GUI 241 shown in FIG. 21.

FIG. 21 shows a GUI 241 including a field 245 corresponding to a two-factor authentication code. As an example, the GUI 241 can be output on the display 81 and a two-factor authentication code received at the companion computing system 170 can be entered into the field 245 using the user interface 74. Afterwards, the processor 71 can transmit the two-factor authentication code to the server 120.

x. Biometric Input Module

The biometric input module 524 (shown in FIG. 6) can be configured to determine a first biometric input (e.g., a later-entered biometric input) received at the processor matches a second biometric input (e.g., a reference biometric input) corresponding to the user identifier. As an example, the processor 71, 121, 171 can receive the first biometric input (e.g., from a camera capturing an image) and compare the first biometric input to the biometric input 108, 139. If the processor determines the first and second biometric inputs match one another, then the processor can authenticate the user that entered the first biometric input. In at least some implementations, execution of the biometric input module 524 includes the processor 71, 171 receiving the first biometric input and transmitting the first biometric input to the processor 121 of the server 120. In at least some implementations, execution of the biometric input module 524 includes the processor 71, 71 transmitting to the processor 121 a communication indicating the user has been authenticated. As an example, the first and second biometric inputs can be images or representations of a user fingerprint or an image of a user face. In at least some implementations, the biometric input module 524 can be configured to compare the first and second biometric inputs to determine whether they match one another. In at least some implementations, the biometric input module 524 can be configured to output a communicating indicating whether the first and second biometric inputs match one another.

FIG. 14 shows a screen display 189 that can be output on a display (e.g., the display 81, 251). The screen display 189 includes a biometric input field 191. In at least some embodiments, a camera of the user interface 74, 174 can be configured to capture an image when a user's finger is contacting the biometric input field 191 or at least a portion of a user's face is within a field of view of the camera.

y. Credential Level Module

The credential level module 525 can be configured to determine which level(s) of multiple levels of a certification credential correspond to a user identifier.

In at least some implementations, the USC includes a first USC. The certified user function includes a first certified user function. The certification credential includes a first level certification credential. The user interface includes a second USC that corresponds to a second certified user function. The second certified user function corresponds to a second level certification credential. The first level certification credential covers certified user functions corresponding to the second level certification credential. In those implementations, the credential level module 525 can be configured to determine whether the user identifier corresponds to the first level certification credential or the second level certification credential.

In at least some implementations, the certified user function includes a function for a particular component or system in a vehicle, and the certification credential corresponds to a first level certification credential defined for the particular component or system. In at least some of those implementations, the first level certification credential defined for the particular component or system is one of multiple certification credentials defined for the particular component or system.

As an example, the multiple certification credentials defined for the particular component or system include first and second certification credentials having a common level certification credential. For instance, the first certification credential can include a credential for a certified user function that includes programming an ECU within the vehicle via a communication stream with an OEM that built the vehicle, and the second certification credential includes a credential for a certified user function that includes receiving service information regarding the vehicle via a subscription with an OEM that built the VST. For another instance, the first certification credential can include a credential for a certified user function that includes programming an ECU within the vehicle via a communication stream with an OEM that built the vehicle, and the second certification credential includes a credential for a certified user function that includes transmitting one or more VDM generated by the VST. For yet another instance, the first certification credential can include a credential for a certified user function that includes receiving service information regarding the vehicle via a subscription with an OEM that built the VST, and the second certification credential includes a credential for a certified user function that includes transmitting one or more VDM generated by the VST.

As another example, the multiple certification credentials defined for the particular component or system are two or more different level certification credentials. For instance, the first certification credential can include a credential for a certified user function that includes communicating with and/or controlling a low-voltage electrical vehicle component (as represented by the mapping data 193 in FIG. 11), and the second certification credential includes a credential for a certified user function that includes communicating with and/or controlling a high-voltage electrical vehicle component (as represented by the mapping data 194 in FIG. 11).

z. Enable USC Module

The enable USC module 526 can be configured to enable a USC. Enabling the USC includes configuring the USC to be usable to trigger execution of the program instructions to perform the certified user function. As an example, enabling the USC can include setting a flag associated with the USC to a value that indicates the USC is enabled. The processor can refer to the flag when determining whether to enable the input corresponding to a selection of the USC.

In at least some embodiments, a certified user function corresponding to a USC includes a first user-range and a second user-range. The certification credential for the certified user function can correspond to a first level certification credential or a second level certification credential. The first level certification credential can include the second level certification credential. If the certification credential corresponds to the first level certification credential, then the enable USC module 526 can enable use of the USC for both the first user-range and the second user-range. If the certification credential corresponds to the second level certification credential, then the enable USC module 526 can enable use of the USC for the first user-range and deprecating use of the USC for the second user-range. If the user identifier does not correspond to the first level certification credential or the second level certification credential, then the enable USC module 526 can deprecate the USC. As an example, the first and second user-ranges can include first and second voltage ranges, respective, (e.g., 0.0 to 100.00 volts and 100.0 to 1,000.0 volts). As another example, the first and second user-ranges can include first and second ranges of subscribed services (e.g., subscribed services 1 to 10 and subscribed services 1 to 25).

In at least some embodiments, a processor (e.g., the processor 71) outputs service information corresponding to the certified user function while the USC is enabled.

aa. Determine USC Selection Module

The determine USC selection module 527 can be configured to determine a selection of the USC has occurred. In some embodiments, configuring the USC occurs after determining the selection of the USC has occurred. In other embodiments, configuring the USC occurs before selection of the USC. Additionally or alternatively, the determine USC selection module 527 can be configured to receive a selection of the USC. In at least some embodiments, receiving the selection of the USC includes a receiving a selection of a hardware USC or a USC output on a touch screen display. For example, the selected USC can be associated with an area on the touch screen display so that when the processor detects that area is touched or pointed at, the processor can determine that the touching or pointing amounts to selection of the USC.

The processor can initiate performing the certified user function on the vehicle-under-service and/or to the vehicle system or component in response to determining the USC (if enabled/not deprecated) has been selected. As an example, initiating performing the certified user function can include generating one or more VDMs for transmitting to the vehicle-under-service. The processor can execute the transmit to vehicle module 520 to transmit the generated VDM(s) to the vehicle.

ab. Transmit to Server Module

The transmit to server module 528 can be configured to transmit a communication to a server (e.g., the server 15, 120). As an example, the transceiver 72, 172 can transmit the communication, and/or the communication network 11 can carry the communication from a computing system (e.g., the companion computing system 12, 170 or the VST 13, 70) to the server. As another example, execution of the transmit to server module 528 can include transmitting a request to check the certification credential for the certified user function, wherein the request includes the user identifier. As yet another example, execution of the transmit to server module 528 can include transmitting performance data from the VST to the server.

ac. Receive Response Module

The receive response module 529 can be configured to receive a communication sent from a server (e.g., the server 15, 120). As an example, the transceiver 72, 122 can receive the communication, and/or the communication network 11 can carry the communication from the server to a computing system (e.g., the companion computing system 12 or the VST 13). As another example, execution of the transmit to server module 528 can include receiving, by the processor from the server, a response to the request, wherein the response includes data indicating whether the user identifier corresponds to the certification credential for the certified user function. As an example, the response from the server 15, 120 can include a GUI configured with a USC enable or deprecated based on a certification credential.

Additionally or alternatively, the receive response module 529 can be configured to receive a communication sent from a vehicle (e.g., the vehicle 14, 32, 50). As an example, the VCT 91 can receive a VDM transmitted by the vehicle as a result of the VCT transmitting a VDM to the vehicle (e.g., a VDM with a request to perform at least a part of a certified user function). As an example, the VDM transmitted by the vehicle can include data regarding a performance of the certified user function (e.g., data indicating whether or not the certified user function was performed successfully). In at least some implementations, the performance data includes data indicating a vehicle identifier of a vehicle-under-service (e.g., the vehicle 14, 32, 50). In at least some implementations, the performance data includes a user identifier corresponding to a user of the VST 70. In at least some implementations, the performance data includes a profile access code corresponding to a user of the VST 70 and/or to the VST 70. In at least some implementations, the performance data includes one or more time stamps corresponding to a performance of the certified user function (e.g., a time stamp indicating when performance of the certified user function started and/or a time stamp indicating when performance of the certified user function ended).

Additionally or alternatively, the receive response module 529 can be configured to receive a request for performance data regarding performance of a certified user function by a particular user and/or by a particular VST. Execution of the receive response module 529 can include outputting a report including at least a portion of the stored performance data regarding the performance of the certified user function. As an example, the report can include data that indicates whether performance of the certified user function was performed by a person with a certified credential to perform the certified user function.

ad. USC Arrangement Module

The USC arrangement module 530 can be configured to arrange enabled USCs at a first common portion of the user interface and/or arrange deprecated USCs at a second common portion of the user interface. As an example, the first common portion can be a first common portion of a GUI and the second common portion can be a second common portion of a GUI. In accordance with that example, the first and second common portion of the GUI can be top and bottom sides of the GUI or left and right sides of the GUI. In accordance with those examples, the top side is above the bottom side, and the left side is to the left of the right side.

Next, FIG. 7 shows a VST 65 in accordance with the example implementations. The VST 13, 70 can include aspects of the VST 65 and/or be arranged like the VST 65. The VST 65 includes a display 66. The display 81 shown in FIG. 5 can be arranged like and/or include aspects of the display 66. The VST 65 includes a user interface 67. The user interface 67 includes hardware buttons, such as the hardware button 68, 69. The hardware buttons can be arranged as USCs. Configuring a USC can include configuring a hardware USC. The user interface 74 shown in FIG. 5 can be arranged like and/or include aspects of the user interface 67.

Next, FIG. 12 is a block diagram of a server 120 in accordance with the example embodiments. The server 15 shown in FIG. 1 can include one or more aspects of the server 120 and/or be arranged like the server 120. The server 120 can operate within the system 10 as the server 15 and/or in addition to the server 15. The server 120 can perform any function(s) described in this description as being performed by the server 15. The server 15 can perform any function(s) described in this description as being performed by the server 120.

The server 120 includes a processor 121, a transceiver 122, a memory 123, a user interface 124, a data bus 125, an electrical circuit 126, a housing, 127, and/or a power supply 128. The data bus 125 can operatively connect the processor 121, the transceiver 122, the memory 123, the user interface 124, and/or the power supply 128 to one another. In other words, the data bus 125 can provide an operative connection between two or more of the processor 121, the transceiver 122, the memory 123, the user interface 124, or the power supply 128. Examples of the processor 121, the transceiver 122, and the memory 123 are described elsewhere in this description. In at least some implementations of the server 120, the processor 121 is a specific processor that is programmed to perform any function(s) described in this description as being performed by the server 15, 120.

The electrical circuit 126 (i.e., one or more electrical circuits) is configured to distribute electrical current throughout the server 120. For example, the electrical circuit 126 can comprise one or more electrical circuits for carrying an electrical current from the power supply 128 to the processor 121, the transceiver 122, the memory 123, and/or the user interface 124, and one or more electrical circuits for carrying an electrical current from the processor 121, the transceiver 122, the memory 123, and/or the user interface 124 to the power supply 128. Examples of the power supply 128 are described elsewhere in this description.

The housing 127 surrounds at least a portion of the following: the processor 121, the transceiver 122, the memory 123, the user interface 124, the data bus 125, the electrical circuit 126 and/or the power supply 128. The housing 127 can support a substrate. In at least some example implementations, at least a portion of the following: the processor 121, the transceiver 122, the memory 123, the user interface 124, the data bus 125, the electrical circuit 126 and/or the power supply 128 is/are mounted on and/or connected to a substrate of the housing 127. The housing 127 can include a server rack.

The user interface 124 can include an input device and an output device. The user interface 124 can include a display, such as a display discussed with respect to the display 81. The display can be configured as an input device and/or an output device. The user interface 124 can display a GUI output by the processor 121. The input device is configured to allow a user to input data into the processor 121.

The memory 123 includes CRPI 129, a GUI 130, a profile 131, a USC enable instruction 132, a USC deprecation instruction 133, and performance data 153.

The CRPI 129 can include program instructions executable by a processor, such as the processor 121. As an example, the CRPI 129 can include program instructions that are executable to cause the server 120 to perform any function described as being performed by the server 120, by the processor 121, and/or by some other component of the server 120. As an example, the CRPI 129 can include program instructions executable by the processor to perform one or more functions of any one or more the function set 399 to the function set 417 shown in FIG. 33 to FIG. 53. In at least some embodiments, the CRPI 129 can include a module 134 and an application programming interface (API) 135.

The module 134 can include one or more modules. Examples of modules within the module 134 are shown in FIG. 6. In at least some embodiments, multiple modules are arranged as an application. As an example, an application can comprises a browser application. As another example, the application can include an application to receive a request for a two-factor authentication code, generate the two-factor authentication code, and authenticate a user of the VST 70 or the companion computing system 170 after receiving the two-factor authentication code from the VST 70 or the companion computing system 170. The processor 121 can transmit the two-factor authentication code to the VST 70 or the companion computing system 170.

The server 120, via the API 135, can provide responses to an application operating on the VST 70 or the companion computing system 170, and/or receive requests from the application operating on the VST 70 or the companion computing system 170. In at least some embodiments, the API 135 can comprise a simple object access protocol (SOAP) API, a remote procedure calls (RPC) API, a websocket API, or a representational state transfer (REST) API. As an example, the API 135 can receive data within the GUI 300 shown in FIG. 25 so that credential information regarding a particular user can be provided to the server 120 and saved within the profile 131 for the particular user.

The GUI 130 includes one or more GUIs. The GUI 130 can include a GUI that the server 120 transmits (as a service) to the VST 70 or the companion computing system 170. As an example, the GUI 130 can include one or more GUI in the GUI 97 shown in FIG. 5 or the GUI 257 shown in FIG. 13. The GUI 130 can also include a GUI that the server 120 outputs on a display of the user interface 124. For example, the GUI 130 can include the GUI 250 shown in FIG. 32 and the processor 121 can populate the data shown within the GUI 250 from the profile 131.

The profile 131 (e.g., one or more profiles) can include a password 136, a profile access code 137, a two-factor authentication code 138, a biometric input 139, and a certification credential 140. As an example, the profile 131 can include profiles for multiple different users of a single VST or multiple VSTs. As another example, the profile 131 can include a respective profile for each of one more VSTs. The password 136 can include a user password and/or a password for the VST 70. The profile access code 137 can include a profile access code for a user corresponding to the profile 131. The two-factor authentication code 138 can include a two-factor authentication code provided to the VST 70 or the companion computing system 170, and can be updated from time-to-time (e.g., each time the server 120 requires authentication and/or every thirty seconds while the server 120 is performing a user authentication for a user corresponding to the profile 131). The biometric input 139 can include one or more biometric inputs corresponding to a user when the profile for that user is established and one or more biometric inputs received during a user authentication occurring after the user profile was established. Example biometric inputs are described elsewhere in this description.

The certification credential 140 can include one or more certification credentials for a user. As an example, the certification credential 140 can include data shown in FIG. 11 for user 1 and user 2. For instance, the certification credential 140 can include data that indicates whether a functional test for user 1 and user 2 is active (e.g., linked) or inactive (e.g., not linked) for user 1 and user 2.

The USC enable instruction 132 includes one or more instructions and/or data the VST 70 can use to enable one or more USCs within a GUI. As an example, the USC enable instruction 132 can include an instruction to enable the USCs for functions corresponding to the certification level tag EV1 shown in FIG. 11. For embodiments in which the USC 321 to the USC 325 as shown in FIG. 30 correspond to the functional tests within the mapping data 193, the USC 321 to the USC 325 can be enabled in response to the VST 70 receiving the USC enable instruction 132. In at least some embodiments, the USC enable instruction 132 includes an instruction and/or data to cause the VST 70 to group enabled USCs together (e.g., as shown in FIG. 31). In at least some embodiments, the USC enable instruction 132 includes a flag associated with the USC having a value that indicates the USC is enabled. In at least some embodiments, the USC enable instruction 132 includes the certification level tag and flag.

The USC deprecation instruction 133 includes one or more instructions and/or data the VST 70 can use to deprecate one or more USCs within a GUI. As an example, the USC deprecation instruction 133 can include an instruction to deprecate the USCs for functions corresponding to the certification level tag EV2 shown in FIG. 11. For embodiments in which the USC 326 to the USC 330 as shown in FIG. 30 correspond to the functional tests within the mapping data 194, the USC 321 to the USC 325 can be deprecated in response to the VST 70 receiving the USC deprecation instruction 133. In at least some embodiments, the USC deprecation instruction 133 includes an instruction and/or data to cause the VST 70 to group deprecated USCs together (e.g., as shown in FIG. 31). In at least some embodiments, the USC deprecation instruction 133 includes a flag associated with the USC having a value that indicates the USC is deprecated. In at least some embodiments, the USC deprecation instruction 133 includes the certification level tag and flag.

The performance data 153 can include performance data stored in one or more VSTs. As an example, the performance data 153 can include the performance data 152 stored within one or more different VSTs. Additionally, the performance data 153 can include VST identifiers associated with the performance data 152 that provided the performance data 152 to the server 120. As an example, the performance data 153 can include performance data described with respect to Table B plus a VST identifier.

Next, FIG. 13 is a block diagram of a companion computing system 170 in accordance with the example embodiments. The companion computing system 12 shown in FIG. 1 can include one or more aspects of the companion computing system 170 and/or be arranged like the companion computing system 170. The companion computing system 170 can operate within the system 10 as and/or in addition to the companion computing system 12. The companion computing system 170 can perform any function(s) described in this description as being performed by the companion computing system 12. The companion computing system 12 can perform any function(s) described in this description as being performed by the companion computing system 170.

The companion computing system 170 includes a processor 171, a transceiver 172, a memory 173, a user interface 174, a data bus 175, an electrical circuit 176, a power supply 177, and a housing 178. The data bus 175 can operatively connect two or more of the processor 171, the transceiver 172, the memory 173, the user interface 174, and/or the power supply 177 to one another. In other words, the data bus 175 can provide an operative connection between two or more of the processor 171, the transceiver 172, the memory 173, the user interface 174, and/or the power supply 177. Examples of the processor 171, the transceiver 172, and the memory 173 are described elsewhere in this description. In at least some implementations of the companion computing system 170, the processor 171 is a specific processor that is programmed to perform any function(s) described in this description as being performed by the companion computing system 12, 170.

The electrical circuit 176 (i.e., one or more electrical circuits) is configured to distribute electrical current throughout the companion computing system 170. For example, the electrical circuit 176 can comprise one or more electrical circuits for carrying an electrical current from the power supply 177 to the processor 171, the transceiver 172, the memory 173, and/or the user interface 174, and one or more electrical circuits for carrying an electrical current from the processor 171, the transceiver 172, the memory 173, and/or the user interface 174 to the power supply 177. Examples of the power supply 177 are described elsewhere in this description.

The housing 178 surrounds at least a portion of the following: the processor 171, the transceiver 172, the memory 173, the user interface 174, the data bus 175, the electrical circuit 176 and/or the power supply 177. The housing 178 can support a substrate. In at least some example implementations, at least a portion of the following: the processor 171, the transceiver 172, the memory 173, the user interface 174, the data bus 175, the electrical circuit 176 and/or the power supply 177 is/are mounted on and/or connected to a substrate of the housing 178. As an example, the housing 178 can be made from a plastic material (e.g., ABS) and a thermoplastic elastomer used to form a grip on the housing 178.

The user interface 174 can include a display 251, an input device 252, and an output device 253. The display 251 can comprise a display, such as a display discussed with respect to the display 81. The display 251 can be configured as an input device and/or an output device. The user interface 174 can display a GUI output by the processor 171. The input device 252 is configured to allow a user to input data into the processor 171.

The memory 173 includes CRPI 255, an application 256, a GUI 257, a password 258, a profile access code 259, a two-factor authentication code 260, a biometric input 261, and a certification credential 262.

The CRPI 255 can include program instructions executable by a processor, such as the processor 171. As an example, the CRPI 255 can include program instructions that are executable to cause the companion computing system 170 to perform any function described as being performed by the companion computing system 170, by the processor 171, and/or by some other component of the companion computing system 170. As an example, the CRPI 255 can include program instructions executable by the processor to perform one or more functions of any one or more the function set 399 to the function set 417 shown in FIG. 33 to FIG. 53. In at least some embodiments, the CRPI 255 can include a module 263.

The module 263 can include one or more modules. Examples of modules within the module 263 are shown in FIG. 6. In at least some embodiments, multiple modules are arranged as an application 256. As an example, the application 256 can comprises a browser application. As another example, the 256 application can include an application to receive a two-factor authentication code, and to display the two-factor authentication code on the display 251.

The GUI 257 includes one or more GUIs. The GUI 257 can include a GUI that the server 120 transmits (as a service) to the companion computing system 170. As an example, the GUI 257 can include a GUI within the GUI 97 or the GUI 130. The GUI 257 can also include a GUI that the companion computing system 170 outputs on the display 251.

The password 258 can include a password entered via the user interface 174 and/or the input device 252. As an example, the password 258 can be input when a user is setting up a profile for that user or entering a certification credential for the user. A user can enter the password into a GUI displayed on the display 81 and the processor 71 can transmit the entered password to the server 120 to authenticate that the user is using the VST 70.

The profile access code 259 can include a profile access code entered via the user interface 174 and/or the input device 252. As an example, the profile access code 259 can be input when a user is setting up a profile for that user or entering a certification credential for the user. A user can enter the profile access code into a GUI displayed on the display 81 and the processor 71 can transmit the entered profile access code to the server 120 to authenticate that the user is using the VST 70.

The two-factor authentication code 260 can include a two-factor authentication code provided to the companion computing system 170. The processor 171 can output the two-factor authentication code 260 on the display 251. A user of the companion computing system 170 can enter the two-factor authentication code 260 onto the display 81 via the input device 82 and/or the user interface 74. The processor 71 can transmit the two-factor authentication code to the server for authentication of the VST 70.

The biometric input 261 can include one or more biometric inputs entered via the user interface 174. The biometric input(s) can be input when a user is setting up a profile for that user. The biometric input(s) can be input during a user authentication occurring after the user profile was established. Example biometric inputs are described elsewhere in this description.

The certification credential 262 can include a certification credential entered via the user interface 174 and/or the input device 252. As an example, the certification credential 262 can include one or more of the types of data shown in FIG. 21 (e.g., a user name, a password, or a two-factor authentication code) for a particular component, system, or GUI. The processor 171 can transmit the certification credential 262 to the server 120 for inclusion within the profile 131 for a particular user using the companion computing system 170.

### III. Example Graphical User Interfaces

As noted, the computing systems (e.g., the companion computing system 12, 170 the VST 13, 70, and/or the server 15, 120) can include a display for displaying a GUI. The drawings show various aspects of GUIs in accordance with the example embodiments. Those aspects include a USC configured to trigger a processor to perform function(s) corresponding to the USC. In at least some embodiments, a USC includes an icon indicative of a function corresponding to the USC. FIG. 17 to FIG. 32 shows screenshots of GUIs in accordance with the example embodiments.

FIG. 17 shows a GUI 699 that includes a vehicle selection menu. The vehicle selection data 99 shown in FIG. 5 can also include data that represents relationships between vehicle model years and the types of vehicles that were built for and/or during each model year. For instance, for a given model year, the vehicle selection data 99 can include data that indicates all vehicle makes that include at least one type of vehicle for the given model year, and for each of those vehicle makes, the vehicle selection data 99 can include data that indicates all vehicle models that correspond to one of the vehicle makes that built at least one type of vehicle for the given model year. In at least some implementations, the vehicle selection data 99 can include data that indicates all engines that are used in each vehicle model. The vehicle selection data 99 can include data that indicates other criteria that can be used to distinguish different groups of common (i.e., like) vehicles. The processor 71 can generate a vehicle selection menu based on the other data within the vehicle selection data 99.

The GUI 699 can include a cursor 700 movable to point to a USC or another item of the GUI 699. The processor 71 can detect the USC or the other item of the GUI 699 is selected when the cursor 700 is disposed on the USC or the other item of the GUI 699. The other GUIs shown in the figures can also include a cursor, similar to the cursor 700, for use in selecting an item of that GUI. For implementations in which the display 81 includes a touch screen display, the GUIs shown in FIG. 17 to FIG. 32 may or may not include a cursor.

As shown in FIG. 17, the GUI 699 includes a year selection menu 704 in which a year selector 714 representing the year 2018 has been selected. The GUI 699 includes a make selection menu 706 in which a make selector 716 representing a make Jeep has been selected. The GUI 699 includes a model selection menu 708 in which a model selector 718 representing the model Grand Cherokee has been selected. The GUI 699 includes a powertrain selection menu 711 in which an engine selector USC 713 representing the 5.7 liter engine has been selected. The year selection menu 704 includes a scroll bar 709 to cause the year selection menu 704 to display year(s) not currently shown in the year selection menu 704. Similarly, the make selection menu 706 includes a scroll bar 710 to cause the make selection menu 706 to display make(s) not currently shown in the make selection menu 706. Likewise, the model selection menu 708 includes a scroll bar 712 to cause the model selection menu 708 to display model(s) not currently shown in the model selection menu 708. Other examples of a selected year, make, model, and engine are also possible.

In at least some implementations, the make selection menu 706 is populated with vehicle makes after a year is selected from the year selection menu 704. Similarly, in at least some implementations, the model selection menu 708 is populated with vehicle models after a year is selected from the year selection menu 704 and after a make is selected from the make selection menu 706. Similarly, in at least some implementations, the powertrain selection menu 711 is populated with powertrain identifiers after a model is selected from the model selection menu 708 is populated with vehicle models after a year is selected from the year selection menu 704 and after a make is selected from the make selection menu 706. In alternative implementations, each of the year selection menu 704, the make selection menu 706, the model selection menu 708, or the powertrain selection menu 711 is in a separate GUI without the other of the year selection menu 704, the make selection menu 706, the model selection menu 708, and the powertrain selection menu 711.

In at least some implementations, the GUI 699 also includes a VIN USC 702 for entering an identifier of a particular vehicle. As an example, the VIN USC 702 can be used to type or key-in a vehicle identification number (VIN) associated with the particular vehicle. As another example, the VIN USC 702 can be used to cause the VCT 91 to request a VIN from an ECU in the vehicle 14, 32, 50. The processor 71 can receive the requested VIN and determine at least a year, make, model, and a serial number of the particular vehicle from the VIN.

The GUI 699 includes a vehicle selector USC 701 for capturing a visual indication of a particular vehicle. As an example, in response to selection of the vehicle selector USC 701, the processor 71 can cause a camera of the input device 82 to capture an image, such as an image of a code 705 representing a VIN, and to cause a GUI, such as the GUI 699 or a different GUI, to display a window 703 showing the image of code 705 and to display a representation of the alpha-numeric representation of the VIN 707 as determined by the processor 71 decoding the code 705. As yet another example, in response to selection of the vehicle selector USC 701, the processor 71 can cause a scanner of the user interface 74 to generate an image, such as an image of the code 705, and to cause a GUI, such as the GUI 699 or a different GUI, to display the window 703 showing the image of the code 705 and to display a representation of the alpha-numeric representation of the VIN 707 as determined by the processor 71 decoding the code 705.

In at least some implementations, the GUI 699 includes USCs to select a particular system or component of interest for displaying live vehicle data or to perform a test or reset procedure with respect to that component. Live vehicle data is vehicle data that a VST, such as the VST 13, 70 received most-recently from the vehicle. The amount of live vehicle data can vary so long as the amount of live vehicle data includes the vehicle data most-recently received, such as the most recent PID parameter value for a PID currently displayed on the display 81. As an example, the GUI 699 includes a system selector USC 715, 717, 719, 721 configured to indicate a selection of an air bag system, a locks system, an engine system, or an ADAS system, respectively. The GUI 699 can include a scroll bar 720 to cause a different system selector USC (for selecting a different component or system) to be displayed within the GUI 699. The GUI 699 includes a USC 722 that is selectable to enter selections made via the GUI 699.

Next, FIG. 18 shows a screen shot of a GUI 730. A GUI description 731 indicates that the GUI 730 pertains to selecting a system/component. As shown in FIG. 18, the GUI 730 includes a system/component selection menu 732. In at least some implementations, the system/component selection menu 732 includes one or more vehicle system selectors, such as the system the system selector 733 can represent a system having two components (selectable via the component selector 734, 735) that do require any certification to perform functional test FT1 to FT10. As another example, the system selector 736 can represent an electrical vehicle system, and the component selector 737 can represent a low voltage component and the component selector 738 can represent a high voltage component. As yet another example, the system selector 739 can represent an ADAS system and the component selector 740 can represent an ADAS component, such as an ADAS camera. As still yet another example, the system selector 741 can represent a vehicle security system and the component selector 742 can represent an immobilizer component configured to prevent an engine from starting when an incorrect ignition key or key fob is used. The GUI 730 also includes functional test selectors for functional test FT1 to FT33, which can be the same functional tests indicated in FIG. 11.

The GUI 730 includes an OK USC 743 to indicate approval of the system/component/DTC or customer complaint. The GUI 730 includes a Cancel USC 744. The Cancel USC 744 can be used to clear out any selections previously made via the GUI 730. The GUI 730 includes a vehicle identifier 745, which can be based on selections made via the GUI 699 shown in FIG. 17.

Next, FIG. 19 shows a screen shot of a GUI 200 that can be output on a display, such as the display 81. The GUI 200 includes a USC 201, 202, 203, 204, 205, 206, 207, 208, 209, 210, 211, 212, 213 and a vehicle identifier 214. In at least some embodiments, the processor 71 can launch an application of the applications 151 and/or to output a GUI of the GUI 97 in response to a selection of the USC 201, 202, 203, 204, 205, 206, 207, 208, 209, 210, 211, 212, 213. In at least some embodiments, the VST 13, 70 determines the vehicle identifier based on a vehicle identifier (e.g., a VIN) received from the vehicle 14, 32, 50. In at least some embodiments, the VST 13, 70 determines the vehicle identifier based on one or more inputs entered via the user interface 74 and/or the 699.

An application launched in response to a selection of the USC 201 allows the VST 13, 70 to communicate with ECUs of the vehicle 14, 32, 50. This allows the user to perform tests, view diagnostic trouble codes (DTCs), and live data parameters from various vehicle systems such as the engine, transmission, antilock brake system (ABS) among other systems.

An application launched in response to a selection of the USC 202 allows the user to access global OBD-II/EOBD vehicle data and tests, without having to identify the vehicle. As an example, the vehicles tests can include an OBD health check, check and clear OBD-II diagnostic trouble codes (DTCs, check malfunction indicator lamp (MIL) status, check readiness monitor status prior to emissions testing, access OBD-II modes (e.g. $01, $02, $06, $09), among other tests.

An application launched in response to a selection of the USC 203 allows the VST 13, 70 to output vehicle specific component tests and reference information for engine, transmission, ABS, charging, transfer case, and suspension systems. The preconfigured meter tests and reference information provided are vehicle specific and designed to help save the user diagnostic time, verify faulty components, and verify the repair. Detailed instructions and reference information are provided to guide the user through the testing process, from locating the component, to selecting the appropriate test, showing test lead connections, and illustrating electrical connector and pin configurations. In addition, test results (including waveform examples), procedures, tips, and specifications are provided for at least some of the tests.

An application launched in response to a selection of the USC 204 provides access to the tool(s) available for performing electrical circuit tests and monitoring signals. The Scope Multimeter function can work interactively with other functions. Selecting “View Meter” from a Guided Component Test or Scanner Test opens the Scope Multimeter function. In at least some embodiments, such as embodiments in which testing connection points are not easily accessible, a hardware scope module separable from the VST 13, 70 (connected via extended length USB cable) allows the user to monitor results remotely.

An application launched in response to a selection of the USC 205 provides the user with a login screen to access online repair information.

An application launched in response to a selection of the USC 206 allows the user to store, organize, and share information via the server 15, 120.

An application launched in response to a selection of the USC 207 allows a user to manage and retrieve vehicle records, for vehicles that have been previously identified. The user can also reactivate a vehicle, eliminating the need identify a vehicle again when performing a retest after repairs have been made.

An application launched in response to a selection of the USC 208 opens a menu providing multiple options, such as oil specifications corresponding to the vehicle indicated by the vehicle identifier 214, resets corresponding to components of the vehicle indicated by the vehicle identifier 214, and technical service bulletins corresponding to the vehicle indicated by the vehicle identifier 214.

An application launched in response to a selection of the USC 209 allows a user to store, sort, and view saved files.

An application launched in response to a selection of the USC 210 opens web browser and navigates to a web page from the user can download a user manual and other related support information.

An application launched in response to a selection of the USC 211 can output a menu of options (Paired Devices, Shop Information, Data Backup, and Code Scan) to assist the user in pairing a dongle (e.g., the dongle 30), create and edit the user's shop contact information, backing up or restoring your saved data, and setting the display option for a Vehicle System Report timestamp.

An application launched in response to a selection of the USC 212 can include a menu to select a different vehicle or a different user of the VST 13, 70.

An application launched in response to a selection of the USC 213 can output a GUI (e.g., the GUI 220 shown in FIG. 20) including a security link section for displaying aspects corresponding to the user's memberships and to memberships the technician has available via the VST 13, 70.

Next, FIG. 20 shows a screen shot of the GUI 220 that can be output on a display, such as the display 81. The GUI 220 includes data corresponding to a technician profile, such as a profile for a technician (e.g., a technician named Hans Smith) using the VST 13, 70. The technician profile (or more simply, “profile”) can be stored in the profile 131 shown in FIG. 12.

The GUI220 includes a set 221 of USC to select different aspects of the technician profile to manage via the GUI 220. In particular, the set 221 includes a USC 222, 223, 224, 225, 226, 227 selectable to manage account information, a technician expertise, a profile picture, shop information, a connected device, or a security link, respectively. FIG. 20 shows the USC 227 highlighted to represent that the USC 227 is currently selected (e.g., directly by a selection of the USC 227 or indirectly by a selection of a different USC, such as the USC 213 shown in FIG. 19).

The GUI 220 includes a security link section 228 for displaying aspects corresponding to the technician's memberships and to memberships the technician has available via the VST 13, 70. As shown in FIG. 20, the security link section 228 includes membership data 229 for memberships associated with the technician and membership data 230, 231, 232, 233 for available memberships.

The GUI 220 and/or the security link section 228 includes a set 234 of USC corresponding to the membership data 229. In particular, the set 234 includes an edit USC 235 selectable to initiate editing the membership data 229 and a delete USC 236 selectable to initiate deleting the membership data 229. The membership data 229 corresponds to a membership corresponding to vehicles manufactured by an particular OEM (e.g., ABC International) and the membership pertains to technical information for those vehicles.

The GUI 220 and/or the security link section 228 includes an add USC 237, 238, 239, 240 corresponding to the membership data 230, 231, 232, 233, respectively. The add USC 237, 238, 239, 240 is selectable to initiate adding a membership corresponding to the membership data 230, 231, 232, 233, respectively as a linked membership for the technician. The membership data 230 corresponds to electric vehicle technology and the membership pertains to a level III certification for that technology. The membership data 231 corresponds to a level 1 membership for locksmith technology. The membership data 232 corresponds to a level 2 membership for locksmith technology. The membership data 233 corresponds to a level 1 membership for high voltage level 1, certificate III for a first location. As an example, a location, such as a country or state can indicate a geographical location that requires a particular certification to be able to access features on the VST 13, 70. Other examples of memberships that can be available for linking to a user of a VST are also possible. The level 1 and 2 membership scan correspond to a certification level 1 and 2, respectively.

Next, FIG. 21 shows a screen shot of a GUI 241 that can be output on a display, such as the display 81. As an example, the GUI 241 can be output on the display in response to a selection of an add USC, such as the add USC 237 shown in FIG. 20. The GUI 241 includes an identifier 248 identifying a membership that can be linked to a user of the VST 13, 70. The GUI 241 includes a field 242, 243, 244, 245 for entry of data regarding a membership selected to be linked to a user of the VST 13, 70. As an example, the field 242 is designated for entry of a user name, the field 243 is designated for entry of a password, the field 244 is designated for confirming the password, and the field 245 for entry of a two-factor authentication code. A GUI for entering data for a different membership can include a field for information besides, in addition to, or as an alternative to the field 242, 243, 244, 245. The GUI 241 includes a cancel USC 246 to cancel entering data to link a membership to the user of the VST 13, 70. The GUI 241 includes a save USC 247 to save data to link the membership to the user of the VST 13, 70. In at least some embodiments, in response to selecting the save USC 247, the processor 71 writes into the memory 73 at least a portion of the data entered into the field 242, 243, 244, 245 and transmits a communication to the server 15, 120 including at least a portion of the data entered into the field 242, 243, 244, 245. Only a portion of the data may be transmitted since the data entered into the field 243, 244 would typically be identical.

Next, FIG. 22 shows a screen shot of the GUI 220 after the membership for electric vehicle technology was selected for linking to the user of the VST 13, 70. In at least some embodiments, the GUI 220 as shown in FIG. 22 can be output on the display 81 in response to the save USC 247 within the GUI 241 shown in FIG. 21 being selected. As shown in FIG. 22, the membership data 230 has been added to the linked membership section of the security link section 228 along with the identifier 249 indicating that linking that membership is pending. Additionally, the set 234 now includes an edit USC 235 selectable to initiate editing the membership data 230 and a delete USC 236 selectable to initiate deleting the membership data 230.

Next, FIG. 23 shows another screenshot of the GUI 220 that can be output on the display 81. In at least some embodiments, the GUI 220 as shown in FIG. 23 can be output on the display 81 after the credential for technician Hans Smith with respect to Electric Vehicle Technology, Certificate III has been approved by the server 15, 120 and/or a user at the server 15, 120. Unlike FIG. 22, the view of the GUI 220 shown in FIG. 23 does not include the identifier 249.

Next, FIG. 24 shows a view of the GUI 220 after the delete USC 236 corresponding to the membership data 229 or the delete USC 236 corresponding to the membership data 230 has been selected. In particular, FIG. 24 shows a container 215 (e.g., a pop-up window) overlaying a portion of the GUI 220. The container 215 includes a USC 217 selectable to confirm that the membership data 229 or the membership data 230 is to be deleted. The container 215 includes a USC 218 selectable to cancel the request to delete the membership data 229 or the membership data 230. The container 215 also includes a message 216 indicating which membership data has been requested to be deleted. Based on the example shown in FIG. 23, the XXX within the message 216 can indicate the membership data 229 or the membership data 230.

Next, FIG. 25 shows a screen shot of a GUI 300 that can be output on a display, such as the display 81. The GUI 300 includes a set 301 of fields for editing technician data of a membership corresponding to a technician, a set 302 of fields for editing shop information of the membership, and a set 303 of fields for editing certification data of the membership. The GUI 300 includes a message 304 indicating which membership data has been requested to be edited. Based on the example shown in FIG. 23, the XXX within the message 304 can indicate the membership data 229 or the membership data 230. The GUI 300 includes a USC 305 selectable to cancel the request to edit the membership data 229 or the membership data 230. The GUI 300 includes a USC 306 selectable to confirm that changes made within the set 301, 302, 303 of fields for the membership data 229 or the membership data 230 is to be saved. In response to a selection of the USC 306, the processor 71 can transmit at least a portion of the data within the set 301, 302, 303 to the server 120 for storage within the profile 131.

Next, FIG. 26 shows a screen shot of a GUI 270 that can be output on a display, such as the display 81. In some respect, the GUI 270 is similar to the GUI 300 shown in FIG. 25. For example, the GUI 270 includes a set 271 of fields for editing technician data of a membership corresponding to a technician, a set 272 of fields for editing shop information of the membership, and a set 273 of fields for editing certification data of the membership, and a message 274 indicating which membership data (i.e., the “Locksmith Level 1”) has been requested to be edited.

Next, FIG. 27 shows a screen shot of a GUI 280 that can be output on a display, such as the display 81. In at least some embodiments, the GUI 280 as shown in FIG. 27 can be output on the display 81 in response to the OK USC 743 within the GUI 730 shown in FIG. 18 being selected with the system selector 741 and the component selector 742 selected.

The GUI 280 includes a user identifier 281 for USER 3 (e.g., the USER 3 user indicated in FIG. 11), a system identifier 282, and a component identifier 283. The GUI 280 also includes a USC 284, 285, 286 for functional test FT28, FT29, FT30. As shown in FIG. 18, functional test FT28, FT29, FT30, FT31, FT32, FT33 correspond to the system selectable via the system selector 741 and the component selectable via the component selector 742. FIG. 27 represents an embodiment in which the USC corresponding to inactive (e.g., not linked) functions are deprecated such that the USC are not included within the GUI. In other words, the GUI 280 does not include USC for the functional test FT31, FT32, FT33 for user 3.

Next, FIG. 28 shows a screen shot of a GUI 290 that can be output on a display, such as the display 81. In at least some embodiments, the GUI 290 as shown in FIG. 28 can be output on the display 81 in response to the OK USC 743 within the GUI 730 shown in FIG. 18 being selected with the system selector 741 and the component selector 742 selected.

The GUI 290 includes the user identifier 281 for USER 3 (e.g., the USER 3 user indicated in FIG. 11), the system identifier 282, and the component identifier 283 (similar to the GUI 280). The GUI 290 also includes the USC 284, 285, 286 for functional test FT28, FT29, FT30, and a USC 287, 288, 289 for functional test FT31, FT32, FT33. As shown in FIG. 18, functional test FT28, FT29, FT30, FT31, FT32, FT33 correspond to the system selectable via the system selector 741 and the component selectable via the component selector 742. FIG. 28 represents an embodiment in which the USC corresponding to inactive (e.g., not linked) functions (i.e., functions FT31, FT32, and FT33) are deprecated such that the USC are included within the GUI, but are locked as indicated by a lock icon 291. In other words, the GUI 290 includes the USC 284, 285, 286 enabled for function test FT28, FT29, FT30 and the USC 287, 288, 289 deprecated for the functional test FT31, FT32, FT33 for user 3.

Next, FIG. 29 shows a screen shot of a GUI 320 that can be output on a display, such as the display 81. In at least some embodiments, the GUI 320 can be output on the display 81 in response to selecting to diagnose a system and/or component of the vehicle indicated by the vehicle identifier 214. For example, the GUI 320 can be output on the display 81 in response to selecting the OK USC 743 within the GUI 730 shown in FIG. 18 being selected with the system selector 733 and/or the component selector 734 and the component selector 735 selected. As another example, the GUI 320 can be output on the display 81 in response to selecting the OK USC 743 within the GUI 730 shown in FIG. 18 being selected with the system selector 736 and/or the component selector 737 and the component selector 738 selected.

The GUI 320 includes a user identifier 319. As an example, the user identifier 319 can correspond to a user shown in FIG. 11 or another user.

The GUI 320 includes a USC 321, 322, 323, 324, 325, 326, 327, 328, 329, 330 corresponding to “TEST 1,” “TEST 2,” “TEST 3,” “TEST 4,” “TEST 5,” “TEST 6,” “TEST 7,” “TEST 8,” “TEST 9,” “TEST 10,” respectively. As an example, those tests can include functional tests, component tests, and/or reset procedures.

In accordance with the embodiment shown in FIG. 29, a GUI can include USC(s) that are enabled for performing a function (e.g., a test) via the VST 13, 70, and USC(s) that are deprecated to prevent performing a function via the VST 13, 70. In FIG. 29, the USC 321, 322, 323, 324, 325 is enabled and the USC 326, 327, 328, 329, 330 is deprecated. The GUI 320 also include the lock icon 291 in proximity to the USC 326, 327, 328, 329, 330 to indicate the USC is deprecated.

The GUI 320 also includes service information 332. In accordance with at least some embodiments, the service information 332 includes service information corresponding to the functions corresponding to the USC that are enabled, but does not include service information corresponding to the functions corresponding to the USC that are deprecated.

Next, FIG. 30 shows a screen shot of a GUI 335 that can be output on a display, such as the display 81. In at least some embodiments, the GUI 335 can be output on the display 81 in response to selecting to diagnose a system and/or component of the vehicle indicated by the vehicle identifier 214. For example, the GUI 335 can be output on the display 81 in response to selecting the OK USC 743 within the GUI 730 shown in FIG. 18 being selected with the system selector 733 and/or the component selector 734 and the component selector 735 selected. As another example, the GUI 335 can be output on the display 81 in response to selecting the OK USC 743 within the GUI 730 shown in FIG. 18 being selected with the system selector 736 and/or the component selector 737 and the component selector 738 selected.

The GUI 335 includes the user identifier 319. As an example, the user identifier 319 can correspond to a user shown in FIG. 11 or another user.

The GUI 335 includes the USC 321, 322, 323, 324, 325, 326, 327, 328, 329, 330 corresponding to “TEST 1,” “TEST 2,” “TEST 3,” “TEST 4,” “TEST 5,” “TEST 6,” “TEST 7,” “TEST 8,” “TEST 9,” “TEST 10,” respectively. As an example, those tests can include functional tests, component tests, and/or reset procedures.

In accordance with the embodiment shown in FIG. 30, a GUI can include USC(s) that are enabled for performing a function (e.g., a test) via the VST 13, 70, and USC(s) that are deprecated to prevent performing a function via the VST 13, 70. In FIG. 30, the USC 321, 322, 323, 324, 325 is enabled and the USC 326, 327, 328, 329, 330 is deprecated. The GUI 335 also include the lock icon 291 in proximity to the USC 326, 327, 328, 329, 330 to indicate the USC is deprecated. In contrast to the GUI 320 shown in FIG. 29, the USC 321, 322, 323, 324, 325 are arranged at a first common portion of the GUI 335 (e.g., an upper portion of the GUI) and the USC 326, 327, 328, 329, 330 are arranged at a second common portion of the GUI 335 (e.g., a lower portion of the GUI). As another example, the first and second common portions can include left and right portions of a GUI.

The GUI 335 also includes service information 333, 334. In accordance with at least some embodiments, the service information 333 includes service information corresponding to the functions corresponding to the USC that are enabled, and the service information 334 includes deprecated service information corresponding to the functions corresponding to the USC that are deprecated. As an example, the deprecated service information can include a portion of the service information 334, such as a title of the service information. The lock icon 291 is shown in proximity to the service information 334. The lock icon 291 can indicate to a user that some function or service information is available via the VST 13, 70, but that the user does not have the credential to access the function or service information.

FIG. 30 shows a display segment 307, 308, 309, 310 that define an area of a display (e.g., the display 81) at which the USC 321 is located within the GUI 335. In at least some implementations, the display segment 307, the display segment 308, the display segment 309, and the display segment 310 define an area on the display at which the USC 321 is located. In at least some implementations, the display segment 307, 308, 309, 310 is a pixel of the display.

Next, FIG. 31 shows a screen shot of a GUI 292 that can be output on a display, such as the display 81. In at least some embodiments, the GUI 292 can be output on the display 81 in response to selecting vehicle characteristics and a system and/or component via the GUI 699 shown in FIG. 17 and then selecting the USC 722. As another example, the GUI 292 can be output on the display 81 in response to selecting a system and/or component via the GUI 730 shown in FIG. 18 and then selecting the OK USC 743. As another example, the GUI 292 can be output on the display 81 in response to selecting a USC within the GUI 200 shown in FIG. 19, such as the USC 201, 202, 203, 204, 205.

The GUI 292 includes an identifier 293 indicative of a vehicle (i.e., 2018 Jeep Grand Cherokee), an engine (i.e., 5.7L), a drive train (i.e., 4WD), a system (i.e., X), and a component (i.e., Y), where “X” is any system on the identified vehicle and “Y” is any component on the identified vehicle.

The GUI 292 includes a field 294 for entry of a profile access code of a user identifier by the user identifier 319. In at least some implementations, as noted on the GUI 292, a profile access code is to be entered once per vehicle ID session. In other words, so long as the VST 13, 70 is being used to service the vehicle identified by the vehicle identifier 214, the user's profile access code does not have to be entered again. In at least some other implementations, a profile access code is to be entered each time a user selects a new system and/or component during the same vehicle ID session. Moreover, in at least some other implementations, a profile access code is to be entered each time a user selects a particular test during the same vehicle ID session for a particular system and/or component, such as a high voltage component of an electric vehicle.

The GUI 292 also includes a USC 295 that is selectable to enter the profile access code typed into the field 294 to the processor 71 and/or to cause the processor 71 to transmit that profile access code to the server 15, 120. In at least some implementations, after the USC 295 is entered and the processor 71 and/or the server 15, 120 confirms the profile access code was entered correctly for the user, the processor 71 can output a GUI, such as the GUI 280, 290, 320, 335 on the display 81.

Next, FIG. 32 shows a screen shot of a GUI 340 that can be output on a display, such as the display of the user interface 124 at the server 120 shown in FIG. 12. In at least some implementations, the GUI 340 can be output to manage user profiles stored in the profile 131. The GUI 340 includes a table 339. The table 339 includes a row 341 including data regarding a User 1, a row 342, 343 including data regarding a User 2, a row 344, 345, 346 including data regarding a User 3, and a row 347 including data regarding a User X. The table 339 also includes a column 387 for selecting a row in the table 339, a column 388 including a user identifier, a column 389 including e-mail addresses, a column 390 including phone numbers, a column 391 including profile access codes, a column 392 including OEM user names, a column 393 including OEM passwords, a column 394 including certification credential identifiers, a column 395 including selectors to enable or disable a certification credential, and a column 396 including user-selectable controls to stop managing a certification credential and/or a user.

As an example, the processor 121 can populate data into the table 339 in response to the server 120 receiving data from the VST 13, 70 after a user has used a GUI to edit and/or delete a membership in security link, such as the GUI 220 shown in FIG. 20. In at least some implementations, a user of the server 120 reviews data within the table 339 and enables or disables a credential for a user of the VST 13, 70.

### IV. Example Operation

Next, FIG. 33 is a flow chart showing a function set 399 (i.e., a set of function(s)) of a method in accordance with the example implementations. The functions of the function set 399 are shown in a block 420, 421, 422 (which are arranged as a flowchart). Two or more functions and/or portions of two or more functions of the function set 399 can be performed at the same time. The functions of the function set 399 can be performed by one or more computing systems, such as one or more computing systems shown in FIG. 2 or configured to operate as a computing system shown in FIG. 2. For example, the functions of the function set 399 can be performed by one or more of the VST 70, the server 120 and/or the companion computing system 170. A computing system configured to perform a function of the function set 399 can perform other function(s) besides those shown in FIG. 33. As an example, those other function(s) can include one or more functions of one or more of the functions sets shown in FIG. 34 to FIG. 53.

Block 420 includes determining a user interface selected to be used at a computing system includes a USC corresponding to a certified user function. The computing system includes program instructions executable to perform the certified user function. The function(s) of block 420 can be performed by a processor (e.g., one or more hardware processors) configured by machine-readable instructions including a module that is the same or similar to the determine corresponding user function module 501, in accordance with the example embodiments. As an example, the processor can determine a user interface selected to be used at a computing system includes a USC corresponding to a certified user function, as discussed with respect to the determine corresponding user function module 501.

As an example, the certified user function can include a function to: (i) perform a test of a high voltage system or component in a vehicle-under-service, (ii) perform a test of an advance driver assistance system or component in the vehicle-under-service, (iii) program an electronic control unit in the vehicle-under-service, (iv) calibrate an electronic control unit in the vehicle-under-service, (v) program a key or key fob for locking and unlocking a lock in the vehicle-under-service or for starting the vehicle-under-service, or (vi) perform a subscription-based user function.

As yet another example, the certified user function can include a function to perform a functional or component test of a component in a vehicle under service. In accordance with that example, the component can be configured to control connecting an electrical circuit to a high voltage component, disconnecting an electrical circuit from the high voltage component, sending an electrical signal to the high voltage component, or receiving an electrical signal from the high voltage component.

As yet another example, the certified user function can include includes function to perform a functional or component test of one or more of the following: (i) a battery pack and battery management system, (ii) an electric motor, (iii) a motor control unit, (iv) a power distribution unit, (v) an electrical power converter, (vi) an on-board charger, (vii) an electric air conditioning compressor, (viii) a high voltage heater, or (ix) a high voltage cable. Other examples of the certified user function are also possible.

Next, block 421 includes determining whether a user identifier, received at the computing system, corresponds to a certification credential for the certified user function. The function(s) of block 421 can be performed by a processor (e.g., one or more hardware processors) configured by machine-readable instructions including a module that is the same or similar to the determine corresponding certification credential module 502, in accordance with the example embodiments. As an example, the processor can determine whether a user identifier, received at the computing system, corresponds to a certification credential for the certified user function, as discussed with respect to the determine corresponding certification credential module 502.

Next, block 422 includes configuring the USC based on whether the user identifier corresponds to the certification credential for the certified user function. Configuring the USC includes enabling the USC if the user identifier corresponds to the certification credential, or deprecating the USC if the user identifier does not correspond to the certification credential. Enabling the USC configures the USC to be usable to trigger execution of the program instructions to perform the certified user function. Deprecating the USC configures the USC to be unusable to trigger execution of the program instructions to perform the certified user function.

The function(s) of block 422 can be performed by a processor (e.g., one or more hardware processors) configured by machine-readable instructions including a module that is the same or similar to the configure USC module 503, in accordance with the example embodiments. As an example, the processor can configure the USC based on whether the user identifier corresponds to the certification credential for the certified user function, as discussed with respect to the configure USC module 503.

In accordance with at least some embodiments (e.g., an embodiment based on a method including one or more functions of the function set 399), deprecating the USC can include configuring a state machine executed by the processor to be a state machine in which the processor ignores or disables an input corresponding to selection of the USC.

In accordance with at least some embodiments (e.g., an embodiment based on a method including one or more functions of the function set 399), the processor outputs service information corresponding to the certified user function while the USC is enabled, and the processor is restricted from outputting the service information corresponding to the certified user function while the USC is deprecated.

Next, FIG. 34 shows a function set 400. In accordance with the example embodiments, a method including the function(s) of the function set 400 can include one or more functions of the function set 399. In that regard, the user interface discussed with respect to the function set 399 can include a GUI selected to be output on a display of the computing system. Accordingly, determining the user interface, selected to be used at the computing system, includes a USC corresponding to a certified user function (as discussed in block 420) can include determining the GUI includes the USC corresponding to the certified user function includes.

Block 423 includes outputting, on the display, the GUI with the configured USC. The function(s) of block 423 can be performed by a processor (e.g., one or more hardware processors) configured by machine-readable instructions including a module that is the same or similar to the output GUI module 504, in accordance with the example embodiments. As an example, the processor can output, on the display, the GUI with the configured USC, as discussed with respect to the output GUI module 504.

In accordance with at least some embodiments, the GUI includes an additional USC, the additional USC can correspond to a non-certified user function, and performance of the non-certified user function via use of the additional USC is not conditioned on an existence of any certification credential. In accordance with at least some embodiments, the GUI includes a web-based GUI. Additionally, in accordance with at least some example embodiments, a method including the function(s) of the function set 400 can include a function discussed with respect to any one or more of FIG. 33 and FIG. 35 to FIG. 53.

Next, FIG. 35 shows a function set 401 arranged as a flowchart. In accordance with the example embodiments, a method including the functions of the function set 401 can include one or more functions of the function set 399 and the function set 400. In that regard, the GUI includes a first GUI. Additionally, in accordance with at least some example embodiments, a method including the function(s) of the function set 401 can include a function discussed with respect to any one or more of FIG. 33, FIG. 34 and FIG. 36 to FIG. 53.

Block 424 includes determining a vehicle identifier of a vehicle-under-service. The function(s) of block 424 can be performed by a processor (e.g., one or more hardware processors) configured by machine-readable instructions including a module that is the same or similar to the determine vehicle ID module 505, in accordance with the example embodiments. As an example, the processor can determine a vehicle identifier of a vehicle-under-service, as discussed with respect to the determine vehicle ID module 505, and/or the GUI 699 shown in FIG. 17.

Block 425 includes outputting, on the display, a second GUI for selecting a vehicle system or component of the vehicle-under-service. The function(s) of block 425 can be performed by a processor (e.g., one or more hardware processors) configured by machine-readable instructions including a module that is the same or similar to the output GUI module 504, in accordance with the example embodiments. As an example, the processor can output, on the display, a second GUI for selecting a vehicle system or component of the vehicle-under-service, as discussed with respect to the output GUI module 504, and/or the GUI 730 shown in FIG. 18.

Block 426 includes determining a selection of the vehicle system or component occurs while the second GUI is output on the display. The function(s) of block 426 can be performed by a processor (e.g., one or more hardware processors) configured by machine-readable instructions including a module that is the same or similar to the determine system or component selection module 506, in accordance with the example embodiments. As an example, the processor can determine a selection of the vehicle system or component occurs while the second GUI is output on the display, as discussed with respect to the determine system or component selection module 506, and/or the GUI 730 shown in FIG. 18.

Additionally, in accordance with the embodiments based on the function set 401, the first GUI is displayed after the selection of the vehicle system or component occurs, and a performance of the certified user function on the vehicle-under-service occurs by and/or to the vehicle system or component.

Next, FIG. 36 shows a function set 402. In accordance with the example embodiments, a method including the function(s) of the function set 402 can include one or more functions of the function set 399, the function set 400, and the function set 401. In that regard, the USC can include a first USC. Additionally, in accordance with at least some example embodiments, a method including the function(s) of the function set 402 can include a function discussed with respect to any one or more of FIG. 33 to FIG. 35 and FIG. 37 to FIG. 53.

Block 427 includes outputting, on the display, a third GUI in response to the selection of the vehicle system or component of the vehicle-under-service and prior to outputting the first GUI. The function(s) of block 427 can be performed by a processor (e.g., one or more hardware processors) configured by machine-readable instructions including a module that is the same or similar to the output GUI module 504, in accordance with the example embodiments. As an example, the processor can output, on the display, a third GUI in response to the selection of the vehicle system or component of the vehicle-under-service and prior to outputting the first GUI, as discussed with respect to the output GUI module 504. The third GUI can include a field for entering or a second USC to request data that the processor uses to determine the certification credential for the certified user function. The third GUI can include aspects of and/or be arranged like the GUI 220 shown in FIG. 20, the GUI 241 shown in FIG. 21, the GUI 300 shown in FIG. 25, or the GUI 270 shown in FIG. 26.

Next, FIG. 37 shows a function set 403 arranged as a flowchart. In accordance with the example embodiments, a method including the function(s) of the function set 403 can include one or more functions of the function set 399 and the function set 400. In that regard, the user interface of block 423 in the function set 400 includes a GUI. Additionally, in accordance with at least some example embodiments, a method including the function(s) of the function set 403 can include function(s) discussed with respect to any one or more of FIG. 33 to FIG. 36 and FIG. 38 to FIG. 53.

Block 428 includes determining a list of functions corresponding to the GUI. The function(s) of block 428 can be performed by a processor (e.g., one or more hardware processors) configured by machine-readable instructions including a module that is the same or similar to the determine list of functions module 508, in accordance with the example embodiments. As an example, the processor can determine a list of functions corresponding to the GUI, as discussed with respect to the determine list of functions module 508. In accordance with at least some embodiments, determining the list of functions includes determining each function in the list of functions corresponds to a particular vehicle identifier and to a second tag indicative of a particular system or component on a vehicle associated with the particular vehicle identifier.

Block 429 includes determining the list of functions includes an identifier of the certified user function and a first tag that indicates the certification credential for the certified user function. The function(s) of block 429 can be performed by a processor (e.g., one or more hardware processors) configured by machine-readable instructions including a module that is the same or similar to the determine inclusion of ID and tag module 509, in accordance with the example embodiments. As an example, the processor can determine the list of functions includes an identifier of the certified user function and a first tag that indicates the certification credential for the certified user function, as discussed with respect to the determine inclusion of ID and tag module 509.

Determining the user interface selected to be used at the computing system includes the USC corresponding to the certified user function as described with respect to block 420 of the function set 399 can include the functions of block 428 and block 429. Additionally, in at least some embodiments based on the function set 403, determining the list of functions can include determining each function in the list of functions corresponds to a particular vehicle identifier and to a second tag indicative of a particular system or component on a vehicle associated with the particular vehicle identifier.

Next, FIG. 38 shows a function set 404. In accordance with the example embodiments, a method including the function(s) of the function set 404 can include one or more functions of the function set 399, the function set 400, and the function set 403. Additionally, in accordance with at least some example embodiments, a method including the function(s) of the function set 404 can include a function discussed with respect to any one or more of FIG. 33 to FIG. 37 and FIG. 39 to FIG. 53.

Block 430 includes determining, based on data contained in a vehicle data message received from a vehicle operatively connected to the computing system, an identifier of a component on the vehicle. Determining the list of functions (described with respect to block 428) can include determining the list of functions corresponds to the identifier of the component on the vehicle. The function(s) of block 430 can be performed by a processor (e.g., one or more hardware processors) configured by machine-readable instructions including a module that is the same or similar to the determine component ID module 507, in accordance with the example embodiments. As an example, the processor can determine, based on data contained in a vehicle data message received from a vehicle operatively connected to the computing system, an identifier of a component on the vehicle, as discussed with respect to the determine component ID module 507. As another example, the processor can determine the component ID based on selections made via a GUI, such as the GUI 730 shown in FIG. 18.

Next, FIG. 39 shows a function set 405 arranged as a flowchart. In accordance with the example embodiments, a method including the functions of the function set 405 can include one or more functions of the function set 399 and the function set 400. In that regard, the user interface of block 423 in the function set 400 includes a GUI. Additionally, in accordance with at least some example embodiments, a method including the functions of the function set 405 can include function(s) discussed with respect to any one or more of FIG. 33 to FIG. 38 and FIG. 40 to FIG. 53. As another example, determining the GUI includes the USC corresponding to the certified user function can include the functions of block 431 and block 432.

Block 431 includes receiving a mark-up language file that defines the GUI and that includes a definition of the USC. The function(s) of block 431 can be performed by a processor (e.g., one or more hardware processors) configured by machine-readable instructions including a module that is the same or similar to the receive a mark-up language file module 510, in accordance with the example embodiments. As an example, the processor can receive a mark-up language file that defines the GUI and that includes a definition of the USC, as discussed with respect to the receive a mark-up language file module 510. In at least some implementations, the mark-up language file includes an HTML or XML file.

Block 432 includes determining the definition of the USC includes a tag that indicates the certification credential for the certified user function. The function(s) of block 432 can be performed by a processor (e.g., one or more hardware processors) configured by machine-readable instructions including a module that is the same or similar to the determine USC definition module 511, in accordance with the example embodiments. As an example, the processor can determine the definition of the USC includes a tag that indicates the certification credential for the certified user function, as discussed with respect to the determine USC definition module 511.

Next, FIG. 40 shows a function set 406 arranged as a flowchart. In accordance with the example embodiments, a method including the function(s) of the function set 406 can include one or more functions of the function set 399 and the function set 400. In that regard, the user interface of block 423 in the function set 400 includes a GUI. Additionally, in accordance with at least some example embodiments, a method including the function(s) of the function set 406 can include function(s) discussed with respect to any one or more of FIG. 33 to FIG. 39 and FIG. 41 to FIG. 53. Moreover, in accordance with the example embodiments, a method including one or more functions of the function set 406, the GUI can include a first GUI.

Block 433 includes outputting a second GUI on the display, the second GUI being configured for inputting the certification credential into the processor. The function(s) of block 433 can be performed by a processor (e.g., one or more hardware processors) configured by machine-readable instructions including a module that is the same or similar to the output GUI module 504, in accordance with the example embodiments. As an example, the processor can output a second GUI on the display, as discussed with respect to the output GUI module 504. The second GUI is configured for inputting the certification credential into the processor. As an example, the second GUI can include aspects of and/or be arranged like the GUI 241 shown in FIG. 21, the GUI 300 shown in FIG. 25, or the GUI 270 shown in FIG. 26.

Block 434 includes writing, by the processor into a memory, data that indicates the certification credential corresponds to the user identifier. The function(s) of block 434 can be performed by a processor (e.g., one or more hardware processors) configured by machine-readable instructions including a module that is the same or similar to the memory writing module 512, in accordance with the example embodiments. As an example, the processor can write, into a memory, data that indicates the certification credential corresponds to the user identifier, as discussed with respect to the memory writing module 512. The second GUI is configured for inputting the certification credential into the processor.

Next, FIG. 41 shows a function set 407. In accordance with the example embodiments, a method including the function(s) of the function set 407 can include one or more functions of the function set 399, the function set 400, and the function set 406. In that regard, the USC can include a first USC. Additionally, in accordance with at least some example embodiments, a method including the function(s) of the function set 407 can include a function discussed with respect to any one or more of FIG. 33 to FIG. 40 and FIG. 41 to FIG. 53.

Block 435 includes accessing, via use of the second GUI, an application programming interface at a remote computing device to obtain the certification credential. The certification credential is input into the processor in response to receiving the certification credential from the remote computing device. The function(s) of block 435 can be performed by a processor (e.g., one or more hardware processors) configured by machine-readable instructions including a module that is the same or similar to the API access module 513, in accordance with the example embodiments. As an example, the processor can access, via use of the second GUI, an application programming interface at a remote computing device to obtain the certification credential, as discussed with respect to the API access module 513.

In accordance with some embodiments, such as embodiments that include performing the function(s) of the function set 406 shown in FIG. 40 and/or the function set 407 shown in FIG. 41, determining that the user interface includes the USC corresponding to the certified user function is based on a particular instance of selecting the user interface. As an example, selecting the user interface includes selecting the USC. Moreover, the second GUI is displayed before the particular instance of selecting the user interface.

Next, FIG. 42 shows a function set 408 arranged as a flowchart. In accordance with the example embodiments, a method including the functions of the function set 408 can include one or more functions of the function set 399 and the function set 400. In that regard, the user interface of block 423 in the function set 400 includes a GUI. Additionally, in accordance with at least some example embodiments, a method including the functions of the function set 408 can include function(s) discussed with respect to any one or more of FIG. 33 to FIG. 41 and FIG. 43 to FIG. 53. In accordance with that example, the user identifier corresponds to the certification credential, and outputting the GUI with the configured USC occurs during a first use of the computing system.

Block 436 includes receiving a request to output the GUI on the display during a second use of the computing system, the second use of the computing system is by an uncertified user. The function(s) of block 437 can be performed by a processor (e.g., one or more hardware processors) configured by machine-readable instructions including a module that is the same or similar to the receiving request module 514, in accordance with the example embodiments. As an example, the processor can receive a request to output the GUI on the display during a second use of the computing system, as discussed with respect to the receiving request module 514.

Block 437 includes deprecating the USC based on the request. The function(s) of block 437 can be performed by a processor (e.g., one or more hardware processors) configured by machine-readable instructions including a module that is the same or similar to the deprecating USC module 515, in accordance with the example embodiments. As an example, the processor can deprecate the USC based on the request, as discussed with respect to the deprecating USC module 515.

Block 438 includes outputting, on the display during the second use of the computing system, the GUI with the deprecated USC. The function(s) of block 438 can be performed by a processor (e.g., one or more hardware processors) configured by machine-readable instructions including a module that is the same or similar to the output GUI module 504, in accordance with the example embodiments. As an example, the processor can output, on the display during the second use of the computing system, the GUI with the deprecated USC, as discussed with respect to the output GUI module 504.

Next, FIG. 43 shows a function set 409 arranged as a flowchart. In accordance with the example embodiments, a method including the function(s) of the function set 409 can include one or more functions of the function set 399 and the function set 400. In that regard, the user interface of block 423 in the function set 400 includes a GUI. Additionally, in accordance with at least some example embodiments, a method including the functions of the function set 409 can include function(s) discussed with respect to any one or more of FIG. 33 to FIG. 42 and FIG. 44 to FIG. 53.

Block 439 includes determining, by the processor, a vehicle selection. The function(s) of block 439 can be performed by a processor (e.g., one or more hardware processors) configured by machine-readable instructions including a module that is the same or similar to the vehicle selection module 516, in accordance with the example embodiments. As an example, the processor can determine a vehicle selection, as discussed with respect to the vehicle selection module 516, and/or the GUI 699 shown in FIG. 17.

Block 440 includes determining, by the processor, a system or component selection corresponding to the vehicle selection. The function(s) of block 440 can be performed by a processor (e.g., one or more hardware processors) configured by machine-readable instructions including a module that is the same or similar to the determine system or component selection module 506, in accordance with the example embodiments. As an example, the processor can determine a system or component selection corresponding to the vehicle selection, as discussed with respect to the determine system or component selection module 506, and/or the GUI 730 shown in FIG. 18.

Block 441 includes determining, by the processor, the GUI corresponds to the vehicle selection and the system or component selection. The function(s) of block 441 can be performed by a processor (e.g., one or more hardware processors) configured by machine-readable instructions including a module that is the same or similar to the GUI association module 517, in accordance with the example embodiments. As an example, the processor can determine the GUI corresponds to the vehicle selection and the system or component selection, as discussed with respect to the GUI association module 517.

Block 442 includes determining, by the processor, the GUI or a database includes metadata indicating the certified user function corresponds to the certification credential. The function(s) of block 442 can be performed by a processor (e.g., one or more hardware processors) configured by machine-readable instructions including a module that is the same or similar to the metadata inclusion module 518, in accordance with the example embodiments. As an example, the processor can determine the GUI or a database includes metadata indicating the certified user function corresponds to the certification credential, as discussed with respect to the metadata inclusion module 518.

In accordance with at least some implementations, a method can include the functions of block 439 and block 440. In accordance those implementations, determining that the GUI includes the USC corresponding to the certified user function includes determining, by the processor executing a state machine within a state based on the vehicle selection and the system or component selection, the state includes a conditional node corresponding to the USC and/or the certified user function.

Next, FIG. 44 shows a function set 410 arranged as a flowchart. In accordance with the example embodiments, a method including the function(s) of the function set 410 can include one or more functions of the function set 399 and the function set 400. In that regard, the user interface of block 423 in the function set 400 includes a GUI. Additionally, in accordance with at least some example embodiments, a method including the functions of the function set 410 can include function(s) discussed with respect to any one or more of FIG. 33 to FIG. 43 and FIG. 45 to FIG. 53. Moreover, for functions corresponding to block 443, 444, the user identifier corresponds to the certification credential.

Block 443 includes determining an electronic signal received at the processor, while the USC is enabled, indicates a selection of the USC occurred. The function(s) of block 443 can be performed by a processor (e.g., one or more hardware processors) configured by machine-readable instructions including a module that is the same or similar to the signal reception module 519, in accordance with the example embodiments. As an example, the processor can determine an electronic signal received at the processor, while the USC is enabled, indicates a selection of the USC occurred, as discussed with respect to the signal reception module 519.

Block 444 includes transmitting, by the processor to a vehicle-under-service operatively connected to the computing system, a vehicle data message for requesting the vehicle-under-service to perform or initiate performing the certified user function. The function(s) of block 444 can be performed by a processor (e.g., one or more hardware processors) configured by machine-readable instructions including a module that is the same or similar to the transmit to vehicle module 520, in accordance with the example embodiments. As an example, the processor can transmit, to a vehicle-under-service operatively connected to the computing system, a vehicle data message for requesting the vehicle-under-service to perform or initiate performing the certified user function as discussed with respect to the transmit to vehicle module 520.

Next, FIG. 45 shows a function set 411 arranged as a flowchart. In accordance with the example embodiments, a method including the functions of the function set 411 can include one or more functions of the function set 399. Additionally, in accordance with at least some example embodiments, a method including the functions of the function set 411 can include function(s) discussed with respect to any one or more of FIG. 33 to FIG. 44 and FIG. 46 to FIG. 53.

Block 445 includes determining a password received at the processor corresponds to the user identifier. The function(s) of block 445 can be performed by a processor (e.g., one or more hardware processors) configured by machine-readable instructions including a module that is the same or similar to the determine password module 521, in accordance with the example embodiments. As an example, the processor can determine a password received at the processor corresponds to the user identifier, as discussed with respect to the determine password module 521.

Block 446 includes determining a profile access code received at the processor corresponds to the user identifier. The function(s) of block 446 can be performed by a processor (e.g., one or more hardware processors) configured by machine-readable instructions including a module that is the same or similar to the determine profile access code module 522, in accordance with the example embodiments. As an example, the processor can determine a profile access code received at the processor corresponds to the user identifier, as discussed with respect to the determine profile access code module 522.

Block 447 includes determining a two-factor authentication was performed via a companion device corresponding to the user identifier. The function(s) of block 447 can be performed by a processor (e.g., one or more hardware processors) configured by machine-readable instructions including a module that is the same or similar to the determine two factor authentication module 523, in accordance with the example embodiments. As an example, the processor can determine a two-factor authentication was performed via a companion device corresponding to the user identifier, as discussed with respect to the determine two factor authentication module 523.

Block 448 includes determining a first biometric input received at the processor matches a second biometric input corresponding to the user identifier. The function(s) of block 448 can be performed by a processor (e.g., one or more hardware processors) configured by machine-readable instructions including a module that is the same or similar to the biometric input module 524, in accordance with the example embodiments. As an example, the processor can determine a first biometric input received at the processor matches a second biometric input corresponding to the user identifier, as discussed with respect to the biometric input module 524.

Next, FIG. 46 shows a function set 412. In accordance with the example embodiments, a method including the function(s) of the function set 412 can include one or more functions of the function set 399. Additionally, in accordance with at least some example embodiments, a method including the function(s) of the function set 412 can include a function discussed with respect to any one or more of FIG. 33 to FIG. 45 and FIG. 47 to FIG. 53.

Block 449 includes comparing, by the processor, a first temporal indicator to a second temporal indicator to determine whether the certification credential for the certified user function has expired. The function(s) of block 449 can be performed by a processor (e.g., one or more hardware processors) configured by machine-readable instructions including a module that is the same or similar to the configure USC module 503, in accordance with the example embodiments. As an example, the processor can compare a first temporal indicator to a second temporal indicator to determine whether the certification credential for the certified user function has expired.

Next, FIG. 47 shows a function set 413 arranged as a flowchart. In accordance with the example embodiments, a method including the functions of the function set 413 can include one or more functions of the function set 399 and the function set 411. Additionally, in accordance with at least some example embodiments, a method including the function(s) of the function set 413 can include function(s) discussed with respect to any one or more of FIG. 33 to FIG. 46 and FIG. 48 to FIG. 53.

Block 450 includes outputting, by the processor, on a display a notification indicating the certification credential for the certified user function has expired if the processor determines the certification credential for the certified user function has expired. The function(s) of block 450 can be performed by a processor (e.g., one or more hardware processors) configured by machine-readable instructions including a module that is the same or similar to the configure USC module 503, in accordance with the example embodiments. As an example, the processor can output on a display a notification indicating the certification credential for the certified user function has expired if the processor determines the certification credential for the certified user function has expired, as discussed with respect to the configure USC module 503.

Block 451 includes outputting, by the processor on the display, a notification indicating the certification credential for the certified user function is set to expire within a threshold amount of time if the processor determines the certification credential for the certified user function is not expired and a current time is within the threshold amount of time. The function(s) of block 451 can be performed by a processor (e.g., one or more hardware processors) configured by machine-readable instructions including a module that is the same or similar to the configure USC module 503, in accordance with the example embodiments. As an example, the processor can output, on a display, a notification indicating the certification credential for the certified user function is set to expire within a threshold amount of time if the processor determines the certification credential for the certified user function is not expired and a current time is within the threshold amount of time, as discussed with respect to the configure USC module 503.

Next, FIG. 48 shows a function set 414 arranged as a flowchart. In accordance with the example embodiments, a method including the functions of the function set 414 can include one or more functions of the function set 399. Additionally, in accordance with at least some example embodiments, a method including the function(s) of the function set 414 can include function(s) discussed with respect to any one or more of FIG. 33 to FIG. 47 and FIG. 49 to FIG. 53.

Moreover, the USC can include a first USC, the certified user function can include a first certified user function, the certification credential can include a first level certification credential, the user interface can include a second USC that corresponds to a second certified user function, the second certified user function can correspond to a second level certification credential, and the first level certification credential can cover certified user functions corresponding to the second level certification credential.

Block 452 includes determining whether the user identifier corresponds to the first level certification credential or the second level certification credential. The function(s) of block 452 can be performed by a processor (e.g., one or more hardware processors) configured by machine-readable instructions including a module that is the same or similar to the credential level module 525, in accordance with the example embodiments. As an example, the processor can determine whether the user identifier corresponds to the first level certification credential or the second level certification credential, as discussed with respect to the credential level module 525.

Block 453 includes configuring the second USC based on whether the user identifier corresponds to the first level certification credential or the second level certification credential, wherein configuring the second USC includes enabling the second USC if the user identifier corresponds to the first level certification credential or the second level certification credential, or deprecating the second USC if the user identifier does not correspond to the first level certification credential or the second level certification credential. The function(s) of block 453 can be performed by a processor (e.g., one or more hardware processors) configured by machine-readable instructions including a module that is the same or similar to the configure USC module 503, in accordance with the example embodiments. As an example, the processor can configure the second USC based on whether the user identifier corresponds to the first level certification credential or the second level certification credential, as discussed with respect to the configure USC module 503.

Next, FIG. 49 shows a function set 415 arranged as a flowchart. In accordance with the example embodiments, a method including the functions of the function set 415 can include one or more functions of the function set 399. Additionally, in accordance with at least some example embodiments, a method including the function(s) of the function set 415 can include function(s) discussed with respect to any one or more of FIG. 33 to FIG. 48 and FIG. 50 to FIG. 53. Moreover, in accordance with these example embodiments, the certified user function can include a first user-range and a second user-range, the certification credential corresponds to a first level certification credential or a second level certification credential, and the first level certification credential includes the second level certification credential. Furthermore, configuring the USC includes the functions of one of block 454, block 455, block 456, described below.

Block 454 includes enabling use of the USC for both the first user-range and the second user-range if the certification credential corresponds to the first level certification credential. The function(s) of block 454 can be performed by a processor (e.g., one or more hardware processors) configured by machine-readable instructions including a module that is the same or similar to the enable USC module 526, in accordance with the example embodiments. As an example, the processor can enable use of the USC for both the first user-range and the second user-range if the certification credential corresponds to the first level certification credential, as discussed with respect to the enable USC module 526.

Block 455 includes enabling use of the USC for the first user-range and deprecating use of the USC for the second user-range if the certification credential corresponds to the second level certification credential. The function(s) of block 455 can be performed by a processor (e.g., one or more hardware processors) configured by machine-readable instructions including a module that is the same or similar to the enable USC module 526, in accordance with the example embodiments. As an example, the processor can enable use of the USC for the first user-range and deprecating use of the USC for the second user-range if the certification credential corresponds to the second level certification credential, as discussed with respect to the enable USC module 526.

Block 456 includes deprecating the USC if the user identifier does not correspond to the first level certification credential or the second level certification credential. The function(s) of block 456 can be performed by a processor (e.g., one or more hardware processors) configured by machine-readable instructions including a module that is the same or similar to the deprecating USC module 515, in accordance with the example embodiments. As an example, the processor can deprecate the USC if the user identifier does not correspond to the first level certification credential or the second level certification credential, as discussed with respect to the deprecating USC module 515.

Next, FIG. 50 shows a function set 416 arranged as a flowchart. In accordance with the example embodiments, a method including the functions of the function set 416 can include one or more functions of the function set 399. Additionally, in accordance with at least some example embodiments, a method including the function(s) of the function set 416 can include function(s) discussed with respect to any one or more of FIG. 33 to FIG. 49 and FIG. 51 to FIG. 53. Moreover, in accordance with these example embodiments, the user identifier corresponds to the certification credential.

Block 457 includes receiving a selection of the USC. The function(s) of block 457 can be performed by a processor (e.g., one or more hardware processors) configured by machine-readable instructions including a module that is the same or similar to the determine USC selection module 527, in accordance with the example embodiments. As an example, the processor can receive a selection of the USC, as discussed with respect to the determine USC selection module 527.

Block 458 includes transmitting, by the processor to a vehicle in response to the selection of the USC, a vehicle data message requesting initiation or performance of the certified user function. The function(s) of block 458 can be performed by a processor (e.g., one or more hardware processors) configured by machine-readable instructions including a module that is the same or similar to the transmit to vehicle module 520, in accordance with the example embodiments. As an example, the processor can transmit, to a vehicle in response to the selection of the USC, a vehicle data message requesting initiation or performance of the certified user function, as discussed with respect to the transmit to vehicle module 520.

Next, FIG. 51 shows a function set 417. In accordance with the example embodiments, a method including the function(s) of the function set 417 can include one or more functions of the function set 399. Additionally, in accordance with at least some example embodiments, a method including the function(s) of the function set 417 can include a function discussed with respect to any one or more of FIG. 33 to FIG. 50 and FIG. 52 to FIG. 53.

Block 459 includes determining, by the processor, a selection of the USC has occurred, wherein configuring the USC occurs after determining the selection of the USC has occurred. The function(s) of block 459 can be performed by a processor (e.g., one or more hardware processors) configured by machine-readable instructions including a module that is the same or similar to the determine USC selection module 527, in accordance with the example embodiments. As an example, the processor can determine, by the processor, a selection of the USC has occurred, as discussed with respect to the determine USC selection module 527.

Next, FIG. 52 shows a function set 418. In accordance with the example embodiments, a method including the function(s) of the function set 418 can include one or more functions of the function set 399. Additionally, in accordance with at least some example embodiments, a method including the function(s) of the function set 418 can include a function discussed with respect to any one or more of FIG. 33 to FIG. 51 and FIG. 53. For example, the function set 418 can be performed in connection with a processor configuring USCs to be enabled or deprecated.

Block 460 includes arranging enabled USCs at a first common portion of the user interface and/or arranging deprecated USCs at a second common portion of the user interface. The function(s) of block 460 can be performed by a processor (e.g., one or more hardware processors) configured by machine-readable instructions including a module that is the same or similar to the USC arrangement module 530, in accordance with the example embodiments. As an example, the processor can arrange enabled USCs at a first common portion of the user interface and/or arranging deprecated USCs at a second common portion of the user interface, as discussed with respect to the USC arrangement module 530.

Next, FIG. 53 shows a function set 419 arranged as a flowchart. In accordance with the example embodiments, a method including the functions of the function set 419 can include one or more functions of the function set 399. Additionally, in accordance with at least some example embodiments, a method including the function(s) of the function set 419 can include function(s) discussed with respect to any one or more of FIG. 33 to FIG. 52. As an example, determining whether a user identifier, received at the computing system, corresponds to a certification credential for the certified user function at block 421 shown in FIG. 33 can include the functions of block 461 and 462 discussed below.

Block 461 includes transmitting, by the processor to a server, a request to check the certification credential for the certified user function, wherein the request includes the user identifier. The function(s) of block 461 can be performed by a processor (e.g., one or more hardware processors) configured by machine-readable instructions including a module that is the same or similar to the transmit to server module 528, in accordance with the example embodiments. As an example, the processor can transmit, to a server, a request to check the certification credential for the certified user function, wherein the request includes the user identifier, as discussed with respect to the transmit to server module 528.

Block 462 includes receiving, by the processor from the server, a response to the request, wherein the response includes data indicating whether the user identifier corresponds to the certification credential for the certified user function. The function(s) of block 462 can be performed by a processor (e.g., one or more hardware processors) configured by machine-readable instructions including a module that is the same or similar to the receive response module 529, in accordance with the example embodiments. As an example, the processor can transmit to a server, a request to check the certification credential for the certified user function, wherein the request includes the user identifier, as discussed with respect to the receive response module 529.

### V. Example Vehicle

A vehicle is a mobile machine that can be used to transport a person, people, and/or cargo. Accordingly, a vehicle can be driven and/or otherwise guided along a path (e.g., a paved road or otherwise) on land, in water, in the air, and/or outer space. A vehicle can be wheeled, tracked, railed, and/or skied. A vehicle can include an automobile, a motorcycle (e.g., a two or three wheel motorcycle), an all-terrain vehicle (ATV) defined by ANSI/SVIA-1-2007, a snowmobile, a watercraft (e.g., a JET SKI® personal watercraft), a light-duty truck, a medium-duty truck, a heavy-duty truck, a semi-tractor, a drone, and/or a farm machine. A vehicle can include and/or use any appropriate voltage and/or current source, such as a battery, an alternator, a fuel cell, and the like, providing any appropriate current and/or voltage, such as about 12 volts, about 42 volts, 400 volts, 800 volts, or some other voltage level. A vehicle can include and/or use any system and/or engine to provide its mobility. Those systems and/or engines can include vehicle components that use fossil fuels, such as gasoline, natural gas, propane, and the like, electricity, such as that generated by a battery, magneto, fuel cell, solar cell and the like, wind and hybrids and/or combinations thereof. A vehicle can include an electronic control unit (ECU), an OBDC, and a vehicle network that connects the OBDC to the ECU. A vehicle can be operable to operate as an autonomous vehicle.

Some vehicles and types of vehicles can be identified by characteristics of the vehicle such as characteristics indicative of when the vehicle was built (e.g., a vehicle year), who built the vehicle (e.g., a vehicle make), marketing names associated with vehicle (e.g., a vehicle model name, or more simply “model”), and features of the vehicle (e.g., an engine type). This description uses an abbreviation YMME and/or Y/M/M/E, where each letter in the order shown represents a model year, vehicle make, vehicle model name, and engine type, respectively. This description uses an abbreviation YMM and/or Y/M/M, where each letter in the order shown represents a model year, vehicle make, and vehicle model name, respectively. An example Y/M/M/E is 2020/Toyota/Camry/4Cyl, in which “2020” represents the model year the vehicle was built, “Toyota” represents the name of the vehicle manufacturer Toyota Motor Corporation, Aichi Japan, “Camry” represents a vehicle model built by that manufacturer, and “4Cyl” represents a an engine type (e.g., a four cylinder internal combustion engine) within the vehicle. A person skilled in the art will understand that other features in addition to or as an alternative to “engine type” can be used to identify a vehicle. These other features can be identified in various manners, such as a regular production option (RPO) code, such as the RPO codes defined by the General Motors Company LLC, Detroit Michigan.

Some vehicles, such as automobiles, are associated with a unique vehicle identification number (VIN). Some VINs include seventeen alpha-numeric characters. For at least some seventeen character VINs, the last six characters represent a unique serial number associated with a particular type of vehicle represented by the first eleven alpha-numeric characters of those VINs. The first eleven alpha-numeric characters typically represent at least a YMME or a YMM. In some instances, a vehicle includes a one dimensional bar code indicative of a VIN associated with that vehicle.

A vehicle network (e.g., the vehicle network 25 shown in FIG. 2 or the vehicle network 44 shown in FIG. 3) can include one or more conductors (e.g., copper wire conductors) and/or can be wireless. As an example, a vehicle network can include one or two conductors for carrying vehicle data messages in accordance with a vehicle data message (VDM) protocol, such as a bi-directional VDM protocol. A bi-directional VDM protocol can include a SAE® J1850 (PWM or VPW) VDM protocol, an SAE® J1939 VDM protocol based on the SAE® J1939_201808 serial control and communications heavy duty vehicle network—top level document, and/or any other core J1939 standard, an ISO® 15764-4 controller area network (CAN) VDM protocol, an ISO® 9141-2 K-Line VDM protocol, an ISO® 14230-4 KWP2000 K-Line VDM protocol, an ISO® 17458 (e.g., parts 1-5) FlexRay VDM protocol, an ISO® 17987 local interconnect network (LIN) VDM protocol, a CAN 2.0 VDM protocol, standardized in part using an ISO® 11898-1:2015 road vehicle—CAN—Part I. data link layer and physical signaling protocol, a CAN FD VDM protocol (e.g., CAN with flexible data rate VDM protocol), a MOST® Cooperation VDM protocol (such as the MOST Specification Rev. 3.0 E2, or the MOST® Dynamic Specification, Rev. 3.0.2), an Ethernet VDM protocol (e.g., an Ethernet 802.3 protocol using a BROADR-REACH® physical layer transceiver specification for Automotive Applications by Broadcom Inc., San Jose, California), or some other VDM protocol defined for performing communications with or within the vehicle 14, 32, 50. Each and every VDM discussed in this description is arranged according to a VDM protocol.

Instead of being bidirectional, a VDM protocol can be a unidirectional. For example, a SENT VDM protocol (e.g., a single-edge nibble transmission VDM protocol) is a unidirectional VDM protocol. The SENT VDM protocol has been standardized as the SAE J2716 VDM protocol. A sensor in a vehicle can include a transmitter operable to communicate using the SENT VDM protocol (e.g., a SENT VDM transmitter). A vehicle communication bus can operatively connect the SENT VDM transmitter and an ECU within the vehicle. The transceiver 72 (e.g., the vehicle communications transceiver 91) can include a SENT VDM receiver connectable to the vehicle communication bus operatively connected to the SENT VDM transmitter. The SENT VDM receiver can receive SENT VDM protocol messages representing sensor values output by the sensor with the SENT VDM transmitter.

An OBDC, such as the OBDC 23, 37, 60 can include an on-board diagnostic (OBD) connector, such as an OBD II connector. An OBD II connector can include slots for retaining up to sixteen connector terminals, but can include a different number of slots or no slots at all. As an example, an OBDC can include an OBD II connector that meets the SAE J1962 specification such as a connector 16M, part number 12110252, available from Aptiv LLC of Dublin, Ireland. An OBDC can include conductor terminals that connect to a conductor in a vehicle. For instance, an OBDC can include connector terminals that connect to conductors that respectively connect to positive and negative terminals of a battery or battery pack. An OBDC can include one or more conductor terminals that connect to a conductor of a vehicle communication bus such that the OBDC is operatively connected to one or more ECUs. A computing system, such as the VST 13, 70 can operatively connect to an OBDC in order to receive a VDM from the vehicle including that OBDC. A VDM can carry VDM data. The VDM data can include a PID and parameter values associated with the PID. The VDM data can include a DTC. An operative connection between the OBDC and the VST 13, 70 can occur via the arrangement 20, 21, 22 shown in FIG. 2 or via some other arrangement. A PID can be associated with one or more thresholds. A threshold corresponding to a PID can be dependent upon an operating condition of the vehicle 14.

An ECU can control various aspects of vehicle operation and/or components within a vehicle system. For example, an ECU can include a powertrain (PT) system ECU, an engine control module (ECM) ECU, a supplemental inflatable restraint (SIR) system (e.g., an air bag system) ECU, an entertainment system ECU, or some other ECU. An ECU can receive an electrical or optical input from an ECU-connected input device (e.g., a sensor input), control an ECU-connected output device (e.g., a solenoid) via an electrical or optical signal output by the ECU, generate a vehicle data message (VDM) (such as a VDM based on a received input or a controlled output), and set a diagnostic trouble code (DTC) to a state (such as active or history). An ECU can perform a functional test in response to receiving a VDM requesting performance of the functional test. The functional test can be used to test an ECU-connected output device. In at least some implementations, the ECU is operable to perform the functional test and/or provide the diagnostic trouble code in accordance with an industry standard, such as the SAE J1979_201202 and/or ISO 15031-5 standards for E/E diagnostic test modes.

### VI. Example Computing System Configuration

Next, FIG. 15 is a block diagram of a computing system 350 in accordance with the example implementations. In a basic configuration 351, the computing system 350 can include a processor 352 and a system memory 354. A memory bus 359 can be used for communicating between the processor 352 and the system memory 354. Depending on the desired configuration, the processor 352 can be of any type including but not limited to a microprocessor (P), a microcontroller (μC), a digital signal processor (DSP), or any combination thereof. A memory controller 353 can also be used with the processor 352, or in some implementations, the memory controller 353 can be an internal part of the processor 352.

Depending on the desired configuration, the system memory 354 can be of any type including but not limited to volatile memory (such as RAM), non-volatile memory (such as ROM, flash memory, etc.) or any combination thereof. The system memory 354 can include one or more applications 355, and program data 357. The application 355 can include an algorithm 356 that is arranged to perform the functions described as being performed by the VST 13, 70 or the server 15, 120. The program data 357 can include system data 358 that could be directed to any number of types of data, such as the computer-readable data stored in the memory 73, 123. In some example implementations, the applications 355 can be arranged to operate with the program data 357 on an operating system executable by the processor 352.

The computing system 350 can have additional features or functionality, and additional interfaces to facilitate communications between the basic configuration 351 and any devices and interfaces. For example, storage devices 360 can be provided including removable storage devices 361, non-removable storage devices 362, or a combination thereof. Examples of removable storage and non-removable storage devices include magnetic disk devices such as flexible disk drives and hard-disk drives (HDD), optical disk drives such as compact disc (CD) drives or digital versatile disk (DVD) drives, solid state drives (SSD), and tape drives to name a few. Computer storage media can include volatile and nonvolatile, non-transitory, removable and non-removable media implemented in any method or technology for storage of information, such as computer-readable program instructions, data structures, program modules, or other data such as the data stored in a computer-readable memory, such at the memory 73, 123.

The system memory 354 and the storage devices 360 are examples of computer-readable memory, such as the memory 73, 123. The system memory 354 and the storage devices 360 can include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing system 350.

The computing system 350 can include or be implemented as a portion of a small-form factor portable (e.g., mobile) electronic device such as a smartphone (e.g., an IPHONE® smartphone from Apple Inc. of Cupertino, California, or a GALAXY S® smartphone from Samsung Electronics Co., Ltd. of Maetan-Dong, Yeongtong-Gu Suwon-Si, Gyeonggi-Do, Republic of Korea), a tablet device (e.g., an IPAD® tablet device from Apple Inc., or a SAMSUNG GALAXY TAB tablet device from Samsung Electronics Co., Ltd.), or a wearable computing device (e.g., a wireless web-watch device or a personal headset device). The application 355, or the program data 357 can include an application downloaded to the communication interfaces 367 from the APP STORE® online retail store, from the GOOGLE PLAY® online retail store, or another source of the applications. A component of the VST 13, 70, such as the display 81 and/or the transceiver 72, can be embodied in the small-form factor electronic device.

The computing system 350 can include or be implemented as part of a personal computing system (including both laptop computer and non-laptop computer configurations), or a server. The computing system 350 can be configured as an embedded system in which the processor 352 includes an embedded processor and the system memory 354 includes an embedded memory.

The computing system 350 can also include output interfaces 363 that can include a graphics processing unit 364, which can be configured to communicate to various external devices such as displays 366 or speakers via one or more A/V ports 365 or a communication interface 367. The communication interface 367 can include a network controller 368, which can be arranged to facilitate communications with the other computing systems 370 over a network communication via one or more communication ports 369. The communication connection is one example of a communication media. Communication media can be embodied by computer-readable program instructions, data structures, program modules, GUIs, or other data in a modulated data signal, such as a carrier wave or other transport mechanism, and includes any information delivery media. A modulated data signal can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), infrared (IR) and other wireless media.

For the VST 13, 70, the communication interface 367 can include the network transceiver 90 and/or the vehicle communications transceiver 91, and the communication port 369 can include a communication port connectable to a printer for printing a paper copy of GUI content.

In FIG. 16, a schematic illustrating a conceptual partial view of a computer program product 380 is shown. The computer program product 380 includes a computer program for executing a computer process on a computing system, arranged according to at least some implementations presented herein. That computer program can be encoded on a non-transitory computer-readable storage medium in a machine-readable format, or on another non-transitory medium or article of manufacture.

In at least some implementations, the computer program product 380 is provided using a signal bearing medium 381. The signal bearing medium 381 can include one or more programming instructions 382 that, when executed by a processor can provide functionality or portions of the functionality described above with respect to FIG. 1 to FIG. 53. In some examples, the signal bearing medium 381 can encompass a computer-readable memory 383, such as, but not limited to, a hard disk drive, a Compact Disc (CD), a Digital Video Disk (DVD), a digital tape, or any other memory described herein. In some implementations, the signal bearing medium 381 can encompass a computer recordable medium 384, such as, but not limited to, memory, read/write (R/W) CDs, R/W DVDs, etc. In some implementations, the signal bearing medium 381 can encompass a communications medium 385, such as, but not limited to, a digital and/or an analog communication medium (e.g., a fiber optic cable, a waveguide, a wired communications link, a wireless communication link, etc.). Thus, for example, the signal bearing medium 381 can be conveyed by a wireless form of the communications medium 385 (e.g., a wireless communications medium conforming to the IEEE 802.11 standard or another transmission protocol).

The one or more programming instructions 382 can be, for example, computer executable and/or logic implemented instructions. In some examples, a computing system such as the computer program product 380 of FIG. 16 can be configured to provide various operations, functions, or actions in response to the programming instructions 382 conveyed to the computing system 350 by one or more of the following; the computer-readable memory 383, the computer recordable medium 384, or the communications medium 385.

The VST 13, 70 can include any of the components of the computing system 350. The processor 71 can be configured like the processor 352. The memory 73 can be configured as part of or all of the system memory 354 or the storage devices 360. The transceiver 72 can be configured as part of or all of the communication interfaces 367.

In at least some implementations, the VST 13, 70, the server 15, 120 and/or the computing system 350 includes a power source. The power source can include a connection to an external power source and circuitry to allow current to flow to other elements connected to the power source. As an example, the external power source can include a wall outlet at which a connection to an alternating current can be made. As another example, the external power source can include an energy storage device (e.g., a battery) or an electric generator.

Additionally or alternatively, a power source can include a connection to an internal power source and power transfer circuitry to allow current to flow to other elements connected to the power source. As an example, the internal power source can include an energy storage device, such as a battery. Furthermore, any power source (e.g., a power supply) described herein can include various circuit protectors and signal conditioners. The power sources described herein can provide a way to transfer electrical currents to other elements that operate electrically.

### VII. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether. Furthermore, various functions described and/or shown in the drawings as being performed by one or more elements can be carried out by a processor executing computer-readable program instructions or by a combination of hardware, firmware, and/or software. For purposes of this description, execution of CRPI contained in a computer-readable memory to perform some function can include executing all of the program instructions of those CRPI or only a portion of those CRPI.

While various aspects and implementations are described herein, other aspects and implementations will be apparent to those skilled in the art. The various aspects and implementations disclosed herein are for purposes of illustration and are not intended to be limiting, with the true scope being indicated by the claims, along with the full scope of equivalents to which such claims are entitled. It is also to be understood that the terminology used herein for the purpose of describing implementations only, and is not intended to be limiting.

In this description, the articles “a,” “an,” and “the” are used to introduce elements and/or functions of the example implementations. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each implementation including a listed component or function independently and each implementation including a combination of the listed components or functions. For example, an implementation described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible implementations: (i) an implementation including A, but not B and not C, (ii) an implementation including B, but not A and not C, (iii) an implementation including C, but not A and not B, (iv) an implementation including A and B, but not C, (v) an implementation including A and C, but not B, (v) an implementation including B and C, but not A, and/or (vi) an implementation including A, B, and C. For the implementations including component or function A, the implementations can include one A or multiple A. For the implementations including component or function B, the implementations can include one B or multiple B. For the implementations including component or function C, the implementations can include one C or multiple C. In accordance with the aforementioned example and at least some of the example implementations, “A” can represent a component, “B” can represent a system, and “C” can represent a symptom.

The use of ordinal numbers such as “first,” “second,” “third” and so on is to distinguish respective elements rather than to denote an order of those elements unless the context of using those terms explicitly indicates otherwise. The use of the symbol “$” as prefix to a number indicates the number is a hexadecimal number.

Implementations of the present disclosure can thus relate to one of the enumerated example embodiments (EEEs) listed below.

EEE 1 is a method comprising: determining, by a processor, a user interface selected to be used at a computing system includes a user-selectable control corresponding to a certified user function, wherein the computing system includes program instructions executable to perform the certified user function; determining, by the processor, whether a user identifier, received at the computing system, corresponds to a certification credential for the certified user function; and configuring the user-selectable control based on whether the user identifier corresponds to the certification credential for the certified user function, wherein: configuring the user-selectable control includes enabling the user-selectable control if the user identifier corresponds to the certification credential, or deprecating the user-selectable control if the user identifier does not correspond to the certification credential, enabling the user-selectable control configures the user-selectable control to be usable to trigger execution of the program instructions to perform the certified user function, and deprecating the user-selectable control configures the user-selectable control to be unusable to trigger execution of the program instructions to perform the certified user function.

EEE 2 is the method of EEE 1, wherein the user interface includes a graphical user interface selected to be output on a display of the computing system, and the method further comprises outputting, on the display, the graphical user interface with the configured user-selectable control.

EEE 3 is the method of EEE 2, wherein the graphical user interface includes a first graphical user interface, wherein the method further comprises: determining a vehicle identifier of a vehicle-under-service; outputting, on the display, a second graphical user interface for selecting a vehicle system or component of the vehicle-under-service; and determining a selection of the vehicle system or component occurs while the second graphical user interface is output on the display, wherein the first graphical user interface is displayed after the selection of the vehicle system or component occurs, and wherein a performance of the certified user function on the vehicle-under-service occurs by and/or to the vehicle system or component.

EEE 4 is the method of EEE 3, wherein: the user-selectable control includes a first user-selectable control, the method further comprises outputting, on the display, a third graphical user interface in response to the selection of the vehicle system or component of the vehicle-under-service and prior to outputting the first graphical user interface, and the third graphical user interface includes a field for entering or a second user-selectable control to request data that the processor uses to determine the certification credential for the certified user function.

EEE 5 is the method of any one of EEE 2 to 4, wherein determining the user interface selected to be used at the computing system includes the user-selectable control corresponding to the certified user function: determining a list of functions corresponding to the graphical user interface, and determining the list of functions includes an identifier of the certified user function and a first tag that indicates the certification credential for the certified user function.

EEE 6 is the method of EEE 5, wherein determining the list of functions includes determining each function in the list of functions corresponds to a particular vehicle identifier and to a second tag indicative of a particular system or component on a vehicle associated with the particular vehicle identifier.

EEE 7 is the method of EEE 5 or 6, further comprising: determining, by the processor based on data contained in a vehicle data message received from a vehicle operatively connected to the computing system, an identifier of a component on the vehicle, wherein determining the list of functions includes determining the list of functions corresponds to the identifier of the component on the vehicle.

EEE 8 is the method of any one of EEE 2 to 7, wherein determining the user interface selected to be used at the computing system includes the user-selectable control corresponding to the certified user function comprises: receiving a mark-up language file that defines the graphical user interface and that includes a definition of the user-selectable control, and determining the definition of the user-selectable control includes a tag that indicates the certification credential for the certified user function.

EEE 9 is the method of any one of EEE 2 to 8, wherein: the graphical user interface includes a first graphical user interface, the method further comprises: outputting a second graphical user interface on the display, the second graphical user interface being configured for inputting the certification credential into the processor, and writing, by the processor into a memory, data that indicates the certification credential corresponds to the user identifier.

EEE 10 is the method of EEE 9, further comprising: accessing, via use of the second graphical user interface, an application programming interface at a remote computing device to obtain the certification credential, wherein the certification credential is input into the processor in response to receiving the certification credential from the remote computing device.

EEE 11 is the method of EEE 9 or 10, wherein determining the user interface selected to be used at a computing system includes the user-selectable control corresponding to the certified user function is based on a particular instance of selecting the graphical user interface, and wherein the second graphical user interface is displayed before the particular instance of selecting the graphical user interface.

EEE 12 is the method of any one of EEE 2 to 11, wherein: the user identifier corresponds to the certification credential, outputting the graphical user interface with the configured user-selectable control occurs during a first use of the computing system, and the method further comprises: receiving a request to output the graphical user interface on the display during a second use of the computing system, the second use of the computing system is by an uncertified user; deprecating the user-selectable control based on the request; and outputting, on the display during the second use of the computing system, the graphical user interface with the deprecated user-selectable control.

EEE 13 is the method of any one of EEE 2 to 12, wherein: the graphical user interface includes an additional user-selectable control, the additional user-selectable control corresponds to a non-certified user function, and performance of the non-certified user function via use of the additional user-selectable control is not conditioned on an existence of any certification credential.

EEE 14 is the method of any one of EEE 2 to 13, wherein the graphical user interface includes a web-based graphical user interface.

EEE 15 is the method of any one of EEE 2 to 14, further comprising: determining, by the processor, a vehicle selection; and determining, by the processor, a system or component selection corresponding to the vehicle selection; wherein determining the user interface selected to be used at the computing system includes the user-selectable control corresponding to the certified user function comprises determining, by the processor executing a state machine within a state based on the vehicle selection and the system or component selection, the state includes a conditional node corresponding to the user-selectable control and/or the certified user function.

EEE 16 is the method of any one of EEE 2 to 15, further comprising: determining, by the processor, a vehicle selection; determining, by the processor, a system or component selection corresponding to the vehicle selection; determining, by the processor, the graphical user interface corresponds to the vehicle selection and the system or component selection; and determining, by the processor, the graphical user interface or a database includes metadata indicating the certified user function corresponds to the certification credential.

EEE 17 is the method of any one of EEE 1 to 16, wherein deprecating the user-selectable control includes configuring a state machine executed by the processor to be a state machine in which the processor ignores or disables an input corresponding to selection of the user-selectable control.

EEE 18 is the method of any one of EEE 1 to 17, wherein the processor outputs service information corresponding to the certified user function while the user-selectable control is enabled, and wherein the processor is restricted from outputting the service information corresponding to the certified user function while the user-selectable control is deprecated.

EEE 19 is the method of any one of EEE 1 to 18, wherein: the user identifier corresponds to the certification credential, and the method further comprises: determining an electronic signal received at the processor, while the user-selectable control is enabled, indicates a selection of the user-selectable control occurred; and transmitting, by the processor to a vehicle-under-service operatively connected to the computing system, a vehicle data message for requesting the vehicle-under-service to perform or initiate performing the certified user function.

EEE 20 is the method of any one of EEE 1 to 19, wherein the certified user function includes a function to: perform a test of a high voltage system or component in a vehicle-under-service, perform a test of an advance driver assistance system or component in the vehicle-under-service, program an electronic control unit in the vehicle-under-service, calibrate an electronic control unit in the vehicle-under-service, program a key or key fob for locking and unlocking a lock in the vehicle-under-service or for starting the vehicle-under-service, or perform a subscription-based user function.

EEE 21 is the method of any one of EEE 1 to 20, wherein the certified user function includes a function to perform a functional or component test of a component in a vehicle under service, and wherein the component is configured to control connecting an electrical circuit to a high voltage component, disconnecting an electrical circuit from the high voltage component, sending an electrical signal to the high voltage component, or receiving an electrical signal from the high voltage component.

EEE 22 is the method of any one of EEE 1 to 21, wherein the certified user function includes function to perform a functional or component test of one or more of the following: a battery pack and battery management system, an electric motor, a motor control unit, a power distribution unit, an electrical power converter, an on-board charger, an electric air conditioning compressor, a high voltage heater, or a high voltage cable.

EEE 23 is the method of any one of EEE 1 to 22, further comprising one or more of the following: determining a password received at the processor corresponds to the user identifier; determining a profile access code received at the processor corresponds to the user identifier; determining a two-factor authentication was performed via a companion device corresponding to the user identifier, or determining a first biometric input received at the processor matches a second biometric input corresponding to the user identifier.

EEE 24 is the method of any one of EEE 1 to 23, further comprising: comparing, by the processor, a first temporal indicator to a second temporal indicator to determine whether the certification credential for the certified user function has expired.

EEE 25 is the method of EEE 24, further comprising: outputting, by the processor, on a display a notification indicating the certification credential for the certified user function has expired if the processor determines the certification credential for the certified user function has expired, or outputting, by the processor on the display, a notification indicating the certification credential for the certified user function is set to expire within a threshold amount of time if the processor determines the certification credential for the certified user function is not expired and a current time is within the threshold amount of time.

EEE 26 is the method of any one of EEE 1 to 25, wherein: the user-selectable control includes a first user-selectable control, the certified user function includes a first certified user function, the certification credential includes a first level certification credential, the user interface includes a second user-selectable control that corresponds to a second certified user function, the second certified user function corresponds to a second level certification credential, the first level certification credential covers certified user functions corresponding to the second level certification credential, and the method further comprises: determining whether the user identifier corresponds to the first level certification credential or the second level certification credential, and configuring the second user-selectable control based on whether the user identifier corresponds to the first level certification credential or the second level certification credential, wherein configuring the second user-selectable control includes enabling the second user-selectable control if the user identifier corresponds to the first level certification credential or the second level certification credential, or deprecating the second user-selectable control if the user identifier does not correspond to the first level certification credential or the second level certification credential.

EEE 27 is the method of any one of EEE 1 to 26, wherein: the certified user function includes a first user-range and a second user-range, the certification credential corresponds to a first level certification credential or a second level certification credential, the first level certification credential includes the second level certification credential, and configuring the user-selectable control includes one of the following: enabling use of the user-selectable control for both the first user-range and the second user-range if the certification credential corresponds to the first level certification credential, enabling use of the user-selectable control for the first user-range and deprecating use of the user-selectable control for the second user-range if the certification credential corresponds to the second level certification credential, or deprecating the user-selectable control if the user identifier does not correspond to the first level certification credential or the second level certification credential.

EEE 28 is the method of any one of EEE 1 to 25, wherein the certified user function includes a function for a particular component or system in a vehicle, and wherein the certification credential corresponds to a first level certification credential defined for the particular component or system.

EEE 29 is the method of the EEE 28, wherein the first level certification credential defined for the particular component or system is one of multiple certification credentials defined for the particular component or system.

EEE 30 is the method of EEE 29, wherein the multiple certification credentials defined for the particular component or system include first and second certification credentials having a common level certification credential.

EEE 31 is the method of EEE 29, wherein the multiple certification credentials defined for the particular component or system are two or more different level certification credentials.

EEE 32 is the method of any one of EEE 28 to 31, wherein the particular component or system comprises an advanced driver assistance system, a component of the advanced driver assistance system, an immobilizer system, a component of the immobilizer system, a high voltage system, or a component of the high voltage system.

EEE 33 is the method of any one of EEE 1 to 32, wherein: the user identifier corresponds to the certification credential, and the method further comprises: receiving a selection of the user-selectable control, and transmitting, by the processor to a vehicle in response to the selection of the user-selectable control, a vehicle data message requesting initiation or performance of the certified user function.

EEE 34 is the method of any one of EEE 1 to 33, wherein: the computing system includes a test device including a meter or an oscilloscope, the certified user function includes performing a guided component test using the test device, and the user interface includes a graphical user interface configured to display guidance for performing the guided component test.

EEE 35 is the method of EEE 34, wherein: the user-selectable control includes a first user-selectable control, and determining that the user interface includes the user-selectable control corresponding to the certified user function includes determining the first user-selectable control or a second user-selectable control is used to select a parameter setting above a threshold parameter setting.

EEE 36 is the method of EEE 35, wherein: the parameter setting includes an electrical parameter setting and the threshold parameter setting includes a threshold electrical parameter setting, the parameter setting includes a temperature parameter setting and the threshold parameter setting includes a threshold temperature parameter setting, or the parameter setting includes a pressure parameter setting and the threshold parameter setting includes a threshold pressure parameter setting.

EEE 37 is the method of any one of EEE 1 to 36, wherein: the computing system includes a test device including a meter or an oscilloscope, the test device includes an electrical connector, and determining the user interface selected to be used at the computing system includes the user-selectable control corresponding to the certified user function comprises determining an electrical probe configured for measuring an electrical parameter above a threshold electrical parameter setting is connected to the electrical connector.

EEE 38 is the method of any one of EEE 1 to 37, further comprising: determining, by the processor, a selection of the user-selectable control has occurred, wherein configuring the user-selectable control occurs after determining the selection of the user-selectable control has occurred.

EEE 39 is the method of any one of EEE 1 to 38, wherein configuring the user-selectable control occurs after determining the user interface is selected to be used at the computing system, but before a selection of the user-selectable control occurs after determining the user interface is selected to be used at the computing system.

EEE 40 is the method of any one of EEE 1 to 39, wherein the user interface includes multiple user-selectable controls corresponding to multiple certified user functions, wherein the computing system includes program instructions executable to perform the multiple certified user functions; wherein configuring the user-selectable control based on whether the user identifier corresponds to the certification credential for the certified user function includes configuring the multiple user-selectable controls, wherein configuring the multiple user-selectable controls includes: enabling the multiple user-selectable controls if the user identifier corresponds to the certification credential, or deprecating the multiple user-selectable controls if the user identifier does not correspond to the certification credential, enabling the multiple user-selectable controls configures the multiple user-selectable controls to be usable to trigger execution of the program instructions to perform the multiple certified user functions, and deprecating the multiple user-selectable controls configures the multiple user-selectable controls to be unusable to trigger execution of the program instructions to perform the multiple certified user functions.

EEE 41 is the method of EEE 40, further comprising: arranging enabled user-selectable controls at a first common portion of the user interface and/or arranging deprecated user-selectable controls at a second common portion of the user interface.

EEE 42 is the method of any one of EEE 1 to 41, wherein determining whether the user identifier corresponds to the certification credential for the certified user function includes: transmitting, by the processor to a server, a request to check the certification credential for the certified user function, wherein the request includes the user identifier; and receiving, by the processor from the server, a response to the request, wherein the response includes data indicating whether the user identifier corresponds to the certification credential for the certified user function.

EEE 43 is the method of any one of EEE 1 to 42, wherein determining whether the user identifier corresponds to the certification credential for the certified user function includes the processor checking a database contained in a memory operatively connected to the processor for data that indicates whether the user identifier corresponds to the certification credential for the certified user function.

EEE 44 is the method of any one of EEE 1 to 43, wherein, after enabling the user-selectable control, the method further comprises: determining the enabled user-selectable control is selected to perform the certified user function and storing data regarding a performance of the certified user function.

EEE 45 is the method of EEE 44, further comprising: receiving data indicative of a user selecting an approval for storing data regarding the performance of the certified user function.

EEE 46 is the method of EEE 45, wherein receiving the data indicative of the user selecting the approval occurs while generating or modifying a user profile for a user of the computing system.

EEE 47 is the method of EEE 45, wherein receiving the data indicative of the user selecting the approval occurs after the performance of the certified user function.

EEE 48 is the method of any one of EEE 44 to 47, wherein storing the data include storing the data within a non-transitory computer-readable medium at the computing system.

EEE 49 is the method of EEE 48, wherein the computing system includes a server and/or a vehicle service tool.

EEE 50 is the method of EEE 48, wherein the computing system is a vehicle service tool configured to be serviced by a server.

EEE 51 is the method of EEE 48, wherein the computing system is a server configured to service a vehicle service tool.

EEE 52 is the method of any one of EEE 44 to 51, wherein the data regarding the performance of the certified user function includes data indicating whether the certified user function was performed successfully.

EEE 53 is the method of any one of EEE 44 to 52, wherein the data regarding the performance of the certified user function includes data indicating a vehicle identifier of a vehicle-under-service, and wherein the performance of the certified user function was attempted on the vehicle under service.

EEE 54 is the method of any one of EEE 44 to 53, wherein the data regarding the performance of the certified user function includes the user identifier.

EEE 55 is the method of any one of EEE 44 to 54, wherein the data regarding the performance of the certified user function includes the profile access code.

EEE 56 is the method of any one of EEE 44 to 55, wherein the data regarding the performance of the certified user function includes one or more time stamps corresponding to the performance of the certified user function.

EEE 57 is the method of any one of EEE 44 to 56, further comprising: outputting a report including at least a portion of the stored data regarding the performance of the certified user function.

EEE 58 is the method of EEE 57, wherein the report indicates whether performance of the certified user function was performed by a person with a certified credential to perform the certified user function.

EEE 59 is a computing system comprising: a processor; and a non-transitory computer-readable memory storing executable instructions, wherein execution of the executable instructions by the processor causes the computing system to perform tasks comprising: determining, by the processor, that a user interface, selected to be used at a computing system, includes a user-selectable control corresponding to a certified user function, wherein the computing system includes program instructions executable to perform the certified user function; determining, by the processor, whether a user identifier, received at the computing system, corresponds to a certification credential for the certified user function; and configuring the user-selectable control based on whether the user identifier corresponds to the certification credential for the certified user function, wherein: configuring the user-selectable control includes enabling the user-selectable control if the user identifier corresponds to the certification credential, or deprecating the user-selectable control if the user identifier does not correspond to the certification credential, enabling the user-selectable control configures the user-selectable control to be usable to trigger execution of the program instructions to perform the certified user function, and deprecating the user-selectable control configures the user-selectable control to be unusable to trigger execution of the program instructions to perform the certified user function.

EEE 60 is a computing system comprising: a processor and a non-transitory computer-readable memory storing executable instructions, wherein execution of the executable instructions by the processor causes the computing system to perform the method of any one of EEE 1 to 58.

EEE 61 is a non-transitory computer-readable memory having stored therein instructions executable by a processor to cause a computing system to perform tasks comprising: determining, by a processor, that a user interface, selected to be used at a computing system, includes a user-selectable control corresponding to a certified user function, wherein the computing system includes program instructions executable to perform the certified user function; determining, by the processor, whether a user identifier, received at the computing system, corresponds to a certification credential for the certified user function; and configuring the user-selectable control based on whether the user identifier corresponds to the certification credential for the certified user function, wherein: configuring the user-selectable control includes enabling the user-selectable control if the user identifier corresponds to the certification credential, or deprecating the user-selectable control if the user identifier does not correspond to the certification credential, enabling the user-selectable control configures the user-selectable control to be usable to trigger execution of the program instructions to perform the certified user function, and deprecating the user-selectable control configures the user-selectable control to be unusable to trigger execution of the program instructions to perform the certified user function.

EEE 62 is a non-transitory computer-readable memory having stored therein instructions executable by a processor to cause a computing system to perform the method of any one of EEE 1 to 58.

EEE 63 is a computing system having a processing means and a data storage means configured to cause the computing system to perform the method of any one of EEE 1 to 58.

What is claimed is:

1. A method comprising:
determining, by a processor, a user interface selected to be used at a computing system includes a user-selectable control corresponding to a certified user function, wherein the computing system includes program instructions executable to perform the certified user function;
determining, by the processor, whether a user identifier, received at the computing system, corresponds to a certification credential for the certified user function; and
configuring the user-selectable control based on whether the user identifier corresponds to the certification credential for the certified user function, wherein:
configuring the user-selectable control includes enabling the user-selectable control if the user identifier corresponds to the certification credential, or deprecating the user-selectable control if the user identifier does not correspond to the certification credential,
enabling the user-selectable control configures the user-selectable control to be usable to trigger execution of the program instructions to perform the certified user function, and
deprecating the user-selectable control configures the user-selectable control to be unusable to trigger execution of the program instructions to perform the certified user function.

2. The method of claim 1,
wherein the user interface includes a graphical user interface selected to be output on a display of the computing system, and
the method further comprises outputting, on the display, the graphical user interface with the configured user-selectable control.

3. The method of claim 2,
wherein the graphical user interface includes a first graphical user interface,
wherein the method further comprises:
determining a vehicle identifier of a vehicle-under-service;
outputting, on the display, a second graphical user interface for selecting a vehicle system or component of the vehicle-under-service; and
determining a selection of the vehicle system or component occurs while the second graphical user interface is output on the display,
wherein the first graphical user interface is displayed after the selection of the vehicle system or component occurs, and
wherein a performance of the certified user function on the vehicle-under-service occurs by and/or to the vehicle system or component.

4. The method of claim 3, wherein:
the user-selectable control includes a first user-selectable control,
the method further comprises outputting, on the display, a third graphical user interface in response to the selection of the vehicle system or component of the vehicle-under-service and prior to outputting the first graphical user interface, and
the third graphical user interface includes a field for entering or a second user-selectable control to request data that the processor uses to determine the certification credential for the certified user function.

5. The method of claim 2,
wherein determining the user interface selected to be used at the computing system includes the user-selectable control corresponding to the certified user function:
determining a list of functions corresponding to the graphical user interface, and
determining the list of functions includes an identifier of the certified user function and a first tag that indicates the certification credential for the certified user function.

6. The method of claim 5, wherein determining the list of functions includes determining each function in the list of functions corresponds to a particular vehicle identifier and to a second tag indicative of a particular system or component on a vehicle associated with the particular vehicle identifier.

7. The method of claim 5, further comprising:
determining, by the processor based on data contained in a vehicle data message received from a vehicle operatively connected to the computing system, an identifier of a component on the vehicle,
wherein determining the list of functions includes determining the list of functions corresponds to the identifier of the component on the vehicle.

8. The method of claim 2,
wherein determining the user interface selected to be used at the computing system includes the user-selectable control corresponding to the certified user function comprises:
receiving a mark-up language file that defines the graphical user interface and that includes a definition of the user-selectable control, and
determining the definition of the user-selectable control includes a tag that indicates the certification credential for the certified user function.

9. The method of claim 2, wherein:
the graphical user interface includes a first graphical user interface,
the method further comprises:
outputting a second graphical user interface on the display, the second graphical user interface being configured for inputting the certification credential into the processor, and
writing, by the processor into a memory, data that indicates the certification credential corresponds to the user identifier.

10. The method of claim 9, further comprising:
accessing, via use of the second graphical user interface, an application programming interface at a remote computing device to obtain the certification credential,
wherein the certification credential is input into the processor in response to receiving the certification credential from the remote computing device.

11. The method of claim 9,
wherein determining the user interface selected to be used at a computing system includes the user-selectable control corresponding to the certified user function is based on a particular instance of selecting the graphical user interface, and
wherein the second graphical user interface is displayed before the particular instance of selecting the graphical user interface.

12. The method of claim 2, wherein:
the user identifier corresponds to the certification credential,
outputting the graphical user interface with the configured user-selectable control occurs during a first use of the computing system, and
the method further comprises:
receiving a request to output the graphical user interface on the display during a second use of the computing system, the second use of the computing system is by an uncertified user;
deprecating the user-selectable control based on the request; and
outputting, on the display during the second use of the computing system, the graphical user interface with the deprecated user-selectable control.

13. The method of claim 2, wherein:
the graphical user interface includes an additional user-selectable control,
the additional user-selectable control corresponds to a non-certified user function, and
performance of the non-certified user function via use of the additional user-selectable control is not conditioned on an existence of any certification credential.

14. The method of claim 2, wherein the graphical user interface includes a web-based graphical user interface.

15. The method of claim 2, further comprising:
determining, by the processor, a vehicle selection; and
determining, by the processor, a system or component selection corresponding to the vehicle selection;
wherein determining the user interface selected to be used at the computing system includes the user-selectable control corresponding to the certified user function comprises determining, by the processor executing a state machine within a state based on the vehicle selection and the system or component selection, the state includes a conditional node corresponding to the user-selectable control and/or the certified user function.

16. The method of claim 2, further comprising:
determining, by the processor, a vehicle selection;
determining, by the processor, a system or component selection corresponding to the vehicle selection;
determining, by the processor, the graphical user interface corresponds to the vehicle selection and the system or component selection; and
determining, by the processor, the graphical user interface or a database includes metadata indicating the certified user function corresponds to the certification credential.

17. The method of claim 1, wherein deprecating the user-selectable control includes configuring a state machine executed by the processor to be a state machine in which the processor ignores or disables an input corresponding to selection of the user-selectable control.

18. The method of claim 1,
wherein the processor outputs service information corresponding to the certified user function while the user-selectable control is enabled, and
wherein the processor is restricted from outputting the service information corresponding to the certified user function while the user-selectable control is deprecated.

19. The method of claim 1, wherein:
the user identifier corresponds to the certification credential, and
the method further comprises:
determining an electronic signal received at the processor, while the user-selectable control is enabled, indicates a selection of the user-selectable control occurred; and
transmitting, by the processor to a vehicle-under-service operatively connected to the computing system, a vehicle data message for requesting the vehicle-under-service to perform or initiate performing the certified user function.

20. The method of claim 1, wherein the certified user function includes a function to:
perform a test of a high voltage system or component in a vehicle-under-service,
perform a test of an advance driver assistance system or component in the vehicle-under-service,
program an electronic control unit in the vehicle-under-service,
calibrate an electronic control unit in the vehicle-under-service,
program a key or key fob for locking and unlocking a lock in the vehicle-under-service or for starting the vehicle-under-service, or
perform a subscription-based user function.

21. The method of claim 1,
wherein the certified user function includes a function to perform a functional or component test of a component in a vehicle under service, and
wherein the component is configured to control connecting an electrical circuit to a high voltage component, disconnecting an electrical circuit from the high voltage component, sending an electrical signal to the high voltage component, or receiving an electrical signal from the high voltage component.

22. The method of claim 1, wherein the certified user function includes function to perform a functional or component test of one or more of the following:
a battery pack and battery management system,
an electric motor,
a motor control unit,
a power distribution unit,
an electrical power converter,
an on-board charger,
an electric air conditioning compressor,
a high voltage heater, or
a high voltage cable.

23. The method of claim 1, further comprising one or more of the following:
determining a password received at the processor corresponds to the user identifier;
determining a profile access code received at the processor corresponds to the user identifier;
determining a two-factor authentication was performed via a companion device corresponding to the user identifier, or
determining a first biometric input received at the processor matches a second biometric input corresponding to the user identifier.

24. The method of claim 1, further comprising:
comparing, by the processor, a first temporal indicator to a second temporal indicator to determine whether the certification credential for the certified user function has expired.

25. The method of claim 24, further comprising:
outputting, by the processor, on a display a notification indicating the certification credential for the certified user function has expired if the processor determines the certification credential for the certified user function has expired, or
outputting, by the processor on the display, a notification indicating the certification credential for the certified user function is set to expire within a threshold amount of time if the processor determines the certification credential for the certified user function is not expired and a current time is within the threshold amount of time.

26. The method of claim 1, wherein:
the user-selectable control includes a first user-selectable control,
the certified user function includes a first certified user function,
the certification credential includes a first level certification credential,
the user interface includes a second user-selectable control that corresponds to a second certified user function,
the second certified user function corresponds to a second level certification credential,
the first level certification credential covers certified user functions corresponding to the second level certification credential, and
the method further comprises:
determining whether the user identifier corresponds to the first level certification credential or the second level certification credential, and
configuring the second user-selectable control based on whether the user identifier corresponds to the first level certification credential or the second level certification credential, wherein configuring the second user-selectable control includes enabling the second user-selectable control if the user identifier corresponds to the first level certification credential or the second level certification credential, or deprecating the second user-selectable control if the user identifier does not correspond to the first level certification credential or the second level certification credential.

27. The method of claim 1, wherein:
the certified user function includes a first user-range and a second user-range,
the certification credential corresponds to a first level certification credential or a second level certification credential,
the first level certification credential includes the second level certification credential, and
configuring the user-selectable control includes one of the following:
enabling use of the user-selectable control for both the first user-range and the second user-range if the certification credential corresponds to the first level certification credential,
enabling use of the user-selectable control for the first user-range and deprecating use of the user-selectable control for the second user-range if the certification credential corresponds to the second level certification credential, or
deprecating the user-selectable control if the user identifier does not correspond to the first level certification credential or the second level certification credential.

28. The method of claim 1, wherein:
the user identifier corresponds to the certification credential, and
the method further comprises:
receiving a selection of the user-selectable control, and
transmitting, by the processor to a vehicle in response to the selection of the user-selectable control, a vehicle data message requesting initiation or performance of the certified user function.

29. The method of claim 1, wherein:
the computing system includes a test device including a meter or an oscilloscope,
the certified user function includes performing a guided component test using the test device, and
the user interface includes a graphical user interface configured to display guidance for performing the guided component test.

30. The method of claim 29, wherein:
the user-selectable control includes a first user-selectable control, and
determining that the user interface includes the user-selectable control corresponding to the certified user function includes determining the first user-selectable control or a second user-selectable control is used to select a parameter setting above a threshold parameter setting.

31. The method of claim 30, wherein:
the parameter setting includes an electrical parameter setting and the threshold parameter setting includes a threshold electrical parameter setting,
the parameter setting includes a temperature parameter setting and the threshold parameter setting includes a threshold temperature parameter setting, or
the parameter setting includes a pressure parameter setting and the threshold parameter setting includes a threshold pressure parameter setting.

32. The method of claim 1, wherein:
the computing system includes a test device including a meter or an oscilloscope,
the test device includes an electrical connector, and
determining the user interface selected to be used at the computing system includes the user-selectable control corresponding to the certified user function comprises determining an electrical probe configured for measuring an electrical parameter above a threshold electrical parameter setting is connected to the electrical connector.

33. The method of claim 1, further comprising:
determining, by the processor, a selection of the user-selectable control has occurred, wherein configuring the user-selectable control occurs after determining the selection of the user-selectable control has occurred.

34. The method of claim 1, wherein configuring the user-selectable control occurs after determining the user interface is selected to be used at the computing system, but before a selection of the user-selectable control occurs after determining the user interface is selected to be used at the computing system.

35. The method of claim 1,
wherein the user interface includes multiple user-selectable controls corresponding to multiple certified user functions, wherein the computing system includes program instructions executable to perform the multiple certified user functions;
wherein configuring the user-selectable control based on whether the user identifier corresponds to the certification credential for the certified user function includes configuring the multiple user-selectable controls,
wherein configuring the multiple user-selectable controls includes:
enabling the multiple user-selectable controls if the user identifier corresponds to the certification credential, or deprecating the multiple user-selectable controls if the user identifier does not correspond to the certification credential,
enabling the multiple user-selectable controls configures the multiple user-selectable controls to be usable to trigger execution of the program instructions to perform the multiple certified user functions, and
deprecating the multiple user-selectable controls configures the multiple user-selectable controls to be unusable to trigger execution of the program instructions to perform the multiple certified user functions.

36. The method of claim 35, further comprising:
arranging enabled user-selectable controls at a first common portion of the user interface and/or arranging deprecated user-selectable controls at a second common portion of the user interface.

37. The method of claim 1,
wherein determining whether the user identifier corresponds to the certification credential for the certified user function includes:
transmitting, by the processor to a server, a request to check the certification credential for the certified user function, wherein the request includes the user identifier; and
receiving, by the processor from the server, a response to the request, wherein the response includes data indicating whether the user identifier corresponds to the certification credential for the certified user function.

38. The method of claim 1,
wherein determining whether the user identifier corresponds to the certification credential for the certified user function includes the processor checking a database contained in a memory operatively connected to the processor for data that indicates whether the user identifier corresponds to the certification credential for the certified user function.

39. A computing system comprising:
a processor; and
a non-transitory computer-readable memory storing executable instructions, wherein execution of the executable instructions by the processor causes the computing system to perform tasks comprising:
determining, by the processor, that a user interface, selected to be used at a computing system, includes a user-selectable control corresponding to a certified user function, wherein the computing system includes program instructions executable to perform the certified user function;
determining, by the processor, whether a user identifier, received at the computing system, corresponds to a certification credential for the certified user function; and
configuring the user-selectable control based on whether the user identifier corresponds to the certification credential for the certified user function, wherein:
configuring the user-selectable control includes enabling the user-selectable control if the user identifier corresponds to the certification credential, or deprecating the user-selectable control if the user identifier does not correspond to the certification credential,
enabling the user-selectable control configures the user-selectable control to be usable to trigger execution of the program instructions to perform the certified user function, and
deprecating the user-selectable control configures the user-selectable control to be unusable to trigger execution of the program instructions to perform the certified user function.

40. A non-transitory computer-readable memory having stored therein instructions executable by a processor to cause a computing system to perform tasks comprising:
determining, by a processor, that a user interface, selected to be used at a computing system, includes a user-selectable control corresponding to a certified user function, wherein the computing system includes program instructions executable to perform the certified user function;
determining, by the processor, whether a user identifier, received at the computing system, corresponds to a certification credential for the certified user function; and
configuring the user-selectable control based on whether the user identifier corresponds to the certification credential for the certified user function, wherein:
configuring the user-selectable control includes enabling the user-selectable control if the user identifier corresponds to the certification credential, or deprecating the user-selectable control if the user identifier does not correspond to the certification credential,
enabling the user-selectable control configures the user-selectable control to be usable to trigger execution of the program instructions to perform the certified user function, and
deprecating the user-selectable control configures the user-selectable control to be unusable to trigger execution of the program instructions to perform the certified user function.
